(19) United States
(12) Patent Application Publication
(10) Pub. No.: US 2025/0203075 A1
(43) Pub. Date: Jun. 19, 2025

(54) METHODS AND DEVICES FOR ADAPTIVE LOOP FILTERING

(71) Applicant: BEIJING DAJIA INTERNET INFORMATION TECHNOLOGY CO., LTD., Beijing (CN)

(72) Inventors: Changyue MA, San Diego, CA (US); Xiaoyu XIU, San Diego, CA (US); Che-Wei KUO, San Diego, CA (US); Wei CHEN, San Diego, CA (US); Hong-Jheng JHU, San Diego, CA (US); Ning YAN, San Diego, CA (US); Xianglin WANG, San Diego, CA (US); Bing YU, Beijing (CN)

(73) Assignee: BEIJING DAJIA INTERNET INFORMATION TECHNOLOGY CO., LTD., Beijing (CN)

(21) Appl. No.: 19/072,945

(22) Filed: Mar. 6, 2025

Related U.S. Application Data
(63) Continuation of application No. PCT/US2023/032439, filed on Sep. 11, 2023.
(63) Continuation of application No. PCT/US2023/082380, filed on Dec. 4, 2023.
(63) Continuation of application No. PCT/US2024/014525, filed on Feb. 5, 2024.
(60) Provisional application No. 63/405,372, filed on Sep. 9, 2022.
(60) Provisional application No. 63/430,015, filed on Dec. 3, 2022.
(60) Provisional application No. 63/443,446, filed on Feb. 5, 2023.

(51) Int. Cl. H04N 19/117; H04N 19/159; H04N 19/176; H04N 19/196; H04N 19/82; H04N 19/86

(52) U.S. Cl. CPC H04N 19/117; H04N 19/159; H04N 19/176; H04N 19/196; H04N 19/82; H04N 19/86

(57) ABSTRACT

This disclosure is related to video coding and compression. More specifically, this disclosure relates to methods and apparatus for improving the coding efficiency of adaptive loop filter (ALF). In one example, the method includes obtaining, by a decoder, one or more spatial neighboring samples associated with a current sample, wherein the one or more spatial neighboring samples are from at least one of: (i) a prediction sample, (ii) a residual sample, or (iii) a reconstructed sample, wherein the reconstructed sample is sampled prior to a sample adaptive offset (SAO) filtering, and obtaining, by the decoder, a filtered sample, based on the one or more spatial neighboring samples associated with the current sample.

### CROSS-REFERENCE TO RELATED APPLICATION

This application is a continuation application of International Application No. PCT/US2023/032439, International Application No. PCT/US2023/082380, and International Application No. PCT/US2024/014525. International Application No. PCT/US2023/032439 was filed on Sep. 11, 2023 and claimed priority to U.S. Provisional Application No. 63/405,372 which was filed on Sep. 9, 2022. International Application No. PCT/US2023/082380 was filed on Dec. 4, 2023 and claimed priority to U.S. Provisional Application No. 63/430,015 which was filed on Dec. 3, 2022. International Application No. PCT/US2024/014525 was filed on Feb. 5, 2024 and claimed priority to U.S. Provisional Application No. 63/443,446 which was filed on Feb. 5, 2023. The entirety of all the afore-mentioned patent applications are incorporated herein by references for all purposes.

### TECHNICAL FIELD

The application is related to video coding and compression. More specifically, this application relates to methods and apparatus on improving the adaptive loop filtering process and cross-component adaptive loop filtering process.

### BACKGROUND

Digital video is supported by a variety of electronic devices, such as digital televisions, laptop or desktop computers, tablet computers, digital cameras, digital recording devices, digital media players, video gaming consoles, smart phones, video teleconferencing devices, video streaming devices, etc. The electronic devices transmit and receive or otherwise communicate digital video data across a communication network, and/or store the digital video data on a storage device. Due to a limited bandwidth capacity of the communication network and limited memory resources of the storage device, video coding may be used to compress the video data according to one or more video coding standards before it is communicated or stored. For example, video coding standards include Versatile Video Coding (VVC), Joint Exploration test Model (JEM), High-Efficiency Video Coding (HEVC/H.265), Advanced Video Coding (AVC/H.264), Moving Picture Expert Group (MPEG) coding, or the like. Video coding generally utilizes prediction methods (e.g., inter-prediction, intra-prediction, or the like) that take advantage of redundancy inherent in the video data. Video coding aims to compress video data into a form that uses a lower bit rate, while avoiding or minimizing degradations to video quality.

### SUMMARY

Embodiments of the present disclosure provide for techniques relating to adaptive loop filtering.

In a first aspect, the present disclosure provides a method for video decoding comprising obtaining, by a decoder, one or more spatial neighboring samples associated with a current sample; and obtaining, by the decoder, a filtered sample, based on the one or more spatial neighboring samples associated with the current sample.

In a second aspect, the present disclosure provides an apparatus for video decoding, comprising: one or more processors; and a memory coupled to the one or more processors and configured to store instructions executable by the one or more processors, wherein the one or more processors, upon execution of the instructions, are configured to, individually or collectively, perform operations comprising: obtaining, by a decoder, one or more spatial neighboring samples associated with a current sample; and obtaining, by the decoder, a filtered sample, based on the one or more spatial neighboring samples associated with the current sample.

In a third aspect, the present disclosure provides a non-transitory computer-readable storage medium for video decoding storing a bitstream to be decoded by operations comprising: obtaining, by a decoder, one or more spatial neighboring samples associated with a current sample; and obtaining, by the decoder, a filtered sample, based on the one or more spatial neighboring samples associated with the current sample.

It is to be understood that both the foregoing general description and the following detailed description are examples only and are not restrictive of the present disclosure.

### BRIEF DESCRIPTION OF THE DRAWINGS

The accompanying drawings, which are incorporated in and constitute a part of this specification, illustrate examples consistent with the present disclosure and, together with the description, serve to explain the principles of the disclosure.

FIG. 1 is a block diagram illustrating an exemplary system for encoding and decoding video blocks in accordance with some implementations of the present disclosure.

FIG. 2A is a block diagram illustrating an exemplary video encoder in accordance with some implementations of the present disclosure.

FIG. 2B is a block diagram illustrating an exemplary video encoder in accordance with some embodiments of the present disclosure.

FIG. 3A is a block diagram illustrating an exemplary video decoder in accordance with some implementations of the present disclosure.

FIG. 3B is a block diagram illustrating an exemplary video decoder in accordance with some embodiments of the present disclosure.

FIGS. 4A through 4E are block diagrams illustrating how a frame is recursively partitioned into multiple video blocks of different sizes and shapes in accordance with some implementations of the present disclosure.

FIG. 5 is an illustration of ALF filter shapes in accordance with some examples of the present disclosure.

FIG. 6 is a depiction of subsampled sample gradients in accordance with some examples of the present disclosure.

FIG. 7 is an illustration of a geometric transformation of a diamond filter shape in accordance with some examples of the present disclosure.

FIG. 8A is an illustration of an online filter shape used in an ECM in accordance with some examples of the present disclosure.

FIG. 8B is an illustration of a CCALF architecture, according to some examples of the present disclosure.

FIG. 8C is an illustration of a relative location of filtered chroma sample and its support in the luma plane for 4:2:0 chroma format with chroma location type 0.

FIG. 8D is an illustration of a 25-tap long filter according to some examples of the present disclosure.

FIG. 8E is an illustration of various online ALF filter inputs in accordance with some examples of the present disclosure.

FIG. 9 is an illustration of a filter shape for a prediction signal or before a SAO signal in accordance with examples of the present disclosure.

FIG. 10 is an illustration of an adjusted ALF filter shape in accordance with some examples of the present disclosure.

FIG. 11 is a flowchart illustrating a method for video decoding in accordance with some examples of the present disclosure.

FIG. 12 is a flowchart illustrating a method for video encoding in accordance with some examples of the present disclosure.

FIG. 13 is a flowchart illustrating a method for video decoding in accordance with some examples of the present disclosure.

FIG. 14 is a flowchart illustrating a method for video encoding in accordance with some examples of the present disclosure.

FIG. 15 is a flowchart illustrating a method for video decoding in accordance with some examples of the present disclosure.

FIG. 16 is a flowchart illustrating a method for video encoding in accordance with some examples of the present disclosure.

FIG. 17 is a flowchart illustrating a method for video decoding in accordance with some examples of the present disclosure.

FIG. 18 is a flowchart illustrating a method for video encoding in accordance with some examples of the present disclosure.

FIG. 19 is a flowchart illustrating a method for video decoding in accordance with some examples of the present disclosure.

FIG. 20 is a flowchart illustrating a method for video encoding in accordance with some examples of the present disclosure.

FIG. 21 is a flowchart illustrating a method for video decoding in accordance with some examples of the present disclosure.

FIG. 22 is a flowchart illustrating a method for video encoding in accordance with some examples of the present disclosure.

FIG. 23 is a flowchart illustrating a method for video decoding in accordance with some examples of the present disclosure.

FIG. 24 is a flowchart illustrating a method for video encoding in accordance with some examples of the present disclosure.

FIG. 25 is a flowchart illustrating a method for video decoding in accordance with some examples of the present disclosure.

FIG. 26 is a flowchart illustrating a method for video decoding in accordance with some examples of the present disclosure.

FIG. 27 is a flowchart illustrating a method for video encoding in accordance with some examples of the present disclosure.

FIG. 28 is a flowchart illustrating a method for video encoding in accordance with some examples of the present disclosure.

FIG. 29 is a flowchart illustrating a method for video decoding in accordance with some examples of the present disclosure.

FIG. 30 is a flowchart illustrating a method for video encoding in accordance with some examples of the present disclosure.

FIG. 31 is a diagram illustrating a computing environment coupled with a user interface, according to some implementations of the present disclosure.

### DETAILED DESCRIPTION

Reference will now be made in detail to specific implementations, embodiments of which are illustrated in the accompanying drawings. In the following detailed description, numerous non-limiting specific details are set forth in order to assist in understanding the subject matter presented herein. But it will be apparent to one of ordinary skill in the art that various alternatives may be used. For example, it will be apparent to one of ordinary skill in the art that the subject matter presented herein can be implemented on many types of electronic devices with digital video capabilities.

It should be illustrated that the terms “first,” “second,” and the like used in the description, claims of the present disclosure, and the accompanying drawings are used to distinguish objects, and not used to describe any specific order or sequence. It should be understood that the data used in this way may be interchanged under an appropriate condition, such that the embodiments of the present disclosure described herein may be implemented in orders besides those shown in the accompanying drawings or described in the present disclosure.

### ALF in VVC

### Filter Shapes, Linear Filtering and Adaptive Clipping

In VVC, ALF is applied to the output samples of SAO. Two filter shapes, 7×7 diamond shape and 5×5 diamond shape are supported for luma and chroma components, respectively, as shown in FIG. 5. In FIG. 5, each square corresponds to a luma or a chroma sample and the center square corresponds to a current to-be-filtered sample. The filter coefficients use point-symmetry and each integer filter coefficient is represented with 7-bit fractional precision. In addition, the sum of coefficients of one filter is equal to 128, which is the fixed-point representation of 1.0 with 7-bit fractional precision:

$$2 {\sum }_{i = 0}^{N - 2} {c}_{i} + {c}_{N - 1} = 128$$

where the number of coefficients N is equal to 13 and 7 for 7×7 and 5×5 filter shape, respectively. A filtered sample value \tilde{R}(x,y) at coordinates (x,y) is derived by applying coefficient cᵢ to the reconstructed sample values R(x,y) as follows:

$$\tilde{R} ( x , y ) = [ {\sum }_{i = 0}^{N - 2} {c}_{i} ( R ( x + {x}_{i} , y + {y}_{i} ) + R ( x - {x}_{i} , y - {y}_{i} ) ) + {c}_{N - 1} R ( x , y ) + 64 ] ≫ 7$$

where (x+xᵢ,y+yᵢ) and (x−xᵢ,y−yᵢ) are the coordinates of the reconstructed samples corresponding to i-th coefficient cᵢ. Due to the constraint in equation (1), equation (2) can be written as:

$$\tilde{R} ( x , y ) = R ( x , y ) + \{ [ {{\sum }_{i = 0}}^{N - 2} {c}_{i} ( ( R ( x + {x}_{i} , y + {y}_{i} ) - R ( x , y ) ) + ( R ( x - {x}_{i} , y - {y}_{i} ) - R ( x , y ) ) ) + 64 ] ≫ 7 \}$$

In VVC, the possibility to clip the difference between the neighboring sample value and the current to-be-filtered sample is added to equation (3) as follows:

$$\tilde{R} ( x , y ) = R ( x , y ) + \{ [ {\sum }_{i = 0}^{N - 2} {c}_{i} {f}_{i} + 64 ] ≫ 7 \}$$

Where

$${f}_{i} = min ( {b}_{i} , max ( - {b}_{i} , R ( x + {x}_{i} , y + {y}_{i} ) - R ( x , y ) ) ) + min ( {b}_{i} , max ( - {b}_{i} , R ( x - {x}_{i} , y - {y}_{i} ) - R ( x , y ) ) )$$

bᵢ is the clipping parameter for a coefficient cᵢ determined by a clipping index dᵢ. bᵢ is derived as follows:

$${b}_{i} = \{ \begin{matrix}{2}^{BD} , when {d}_{i} = 0 \\ {2}^{BD - 1 - 2 {d}_{i}} , otherwise\end{matrix}$$

where BD is the sample bit depth and dᵢ can be 0, 1, 2 or 3.

### Luma Sub-Block Level Filter Adaptation

In VVC, sub-block level filter adaption is only applied to luma component. Each 4×4 luma block is classified based on its directionality and 2D Laplacian activity. First, the values of sample gradients for horizontal, vertical and two diagonal directions are calculated:

$${H}_{k , l} = \vert 2 R ( k , l ) - R ( k - 1 , l ) - R ( k + 1 , l ) \vert , \\ {V}_{k , l} = \vert 2 R ( k , l ) - R ( k , l - 1 ) - R ( k , l + 1 ) \vert , \\ D {0}_{k , l} = \vert 2 R ( k , l ) - R ( k - 1 , l - 1 ) - R ( k + 1 , l + 1 ) \vert , \\ D {1}_{k , l} = \vert 2 R ( k , l ) - R ( k - 1 , l + 1 ) - R ( k + 1 , l - 1 ) \vert .$$

Based on the sample gradients, sub-block horizontal gradient, gₕ, vertical gradient, gᵥ, and two diagonal gradients, g_{d0} and g_{d1}, are calculated as

$${g}_{h} = {\sum }_{k = i - 2}^{i + 5} {\sum }_{l = j - 2}^{j + 5} {H}_{k , l} , \\ {g}_{v} = {\sum }_{k = i - 2}^{i + 5} {\sum }_{l = j - 2}^{j + 5} {V}_{k , l} , \\ {g}_{d 0} = {\sum }_{k = i - 2}^{i + 5} {\sum }_{l = j - 2}^{j + 5} D {0}_{k , l} , \\ {g}_{d 1} = {\sum }_{k = i - 2}^{i + 5} {\sum }_{l = j - 2}^{j + 5} D {1}_{k , l}$$

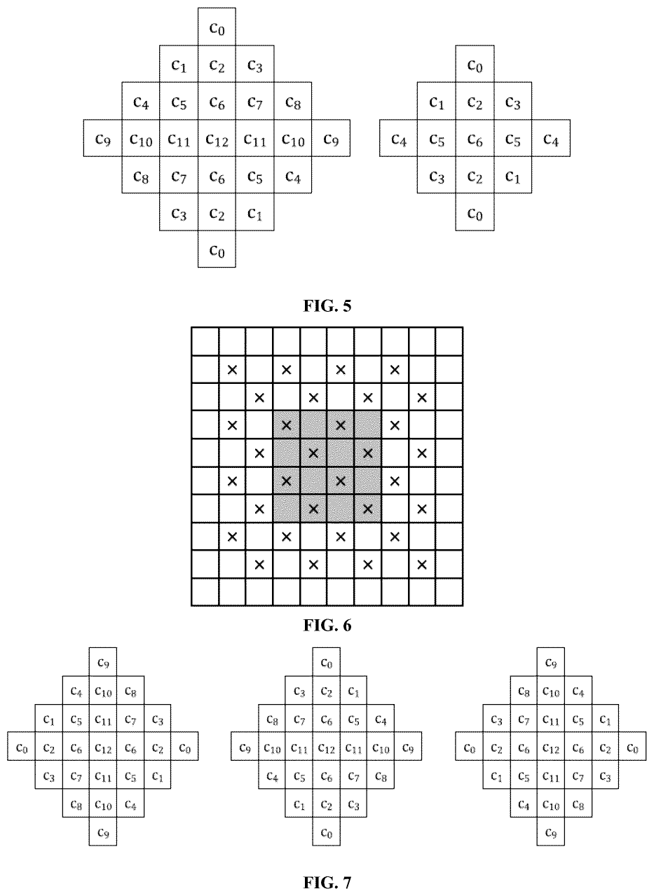

Indices i and j refer to the coordinates of the upper left sample in the 4×4 luma block. As it can be seen from equation (8), the sum of sample gradients within a 10×10 luma window that covers the target 4×4 block is used for classifying that block. To reduce the complexity, only gradient of every second sample in a 10×10 window is calculated as illustrated in FIG. 6. (See FIG. 6 depicting subsampled sample gradients for a 4×4 sub-block ALF classification. Gradient values of samples marked with x are calculated. Gradient values of other samples are set to 0). The values of other sample gradients are set to 0.

Second, to assign the directionality D, the ratio of the maximum and the minimum of the sub-block horizontal and vertical gradients:

$${g}_{h , v}^{max} = max ( {g}_{h} , {g}_{v} ) , {g}_{h , v}^{min} = min ( {g}_{h} , {g}_{v} ) ,$$

and the ratio of the maximum and the minimum of two sub-block diagonal gradients:

$${g}_{d 0 , d 1}^{max} = max ( {g}_{d 0} , {g}_{d 1} ) , {g}_{d 0 , d 1}^{min} = min ( {g}_{d 0} , {g}_{d 1} ) ,$$

are compared against each other with a set of thresholds t₁ and t₂:
Step 1: If both g_{h,v}^{max}≤t₁·g_{h,v}^{min} and g_{d0,d1}^{max}≤t₁·g_{d0,d1}^{min}, D is set to 0.
Step 2: If g_{h,v}^{max}/g_{h,v}^{min}>g_{d0,d1}^{max}/g_{d0,d1}^{min}, the directionality D is calculated in Step 3, otherwise in Step 4.
Step 3: If g_{h,v}^{max}>t₂·g_{h,v}^{min}, D is set to 2, otherwise D is set to 1.
Step 4: If g_{d0,d1}^{max}>t₂·g_{d0,d1}^{min}, D is set to 4, otherwise D is set to 3.

Each subsequent step in the above calculation of D is only executed if there is no value assigned to D in the previous steps. Third, an activity value A is calculated as

$$A = ( {\sum }_{k = i - 2}^{i + 5} {\sum }_{l = j - 2}^{j + 5} ( {V}_{k , l} + {H}_{k , l} ) ) ≫ ( BD - 2 )$$

A is further mapped to the range of 0 to 4: Â=Q_{min(A,15)}, where {Qₙ}={0,1,2,2,2,2,2,3,3,3,3,3,3,3,3,4}. Finally, each 4×4 luma block is categorized into one of the 25 classes:

$$C = 5 D + \hat{A}$$

Each class can have its own filter assigned. Before filtering each 4×4 luma block, a geometric transformation, such as 90-degree rotation, diagonal or vertical flip, is applied to the filter coefficients, as illustrated in FIG. 7 (illustrating a geometric transformation of a 7×7 diamond filter shape. From left to right: diagonal flip, vertical flip, and 90-degree rotation), depending on the sub-block gradient value as specified in Table 1.

TABLE 1
Geometric transformation based on sub-block gradient values

| Sub-block gradient values | Transformation |
|---|---|
| g_{d1} < g_{d0} and gₕ < gᵥ | No transformation |
| g_{d1} < g_{d0} and gᵥ ≤ gₕ | Diagonal flip |
| 9_{do} ≤ 9_{d1} and gₕ < gᵥ | Vertical flip |
| 9_{do} ≤ g_{d1} and gᵥ ≤ gₕ | 90-degree rotation |

### Coding Tree Block Level Filter Adaptation

In addition to the luma 4×4 block-level filter adaptation, ALF supports CTB-level filter adaptation. A luma CTB can use a filter set calculated for the current slice or one of the filter sets calculated for the already coded slices. It can also use one of the 16 offline trained filter sets. Within each luma CTB, which filter from the chosen filter set should be applied to each 4×4 block, is determined by the class C calculated in equation (12) for this block. Chroma uses only CTB-level filter adaptation. Up to 8 filters can be used for chroma components in a slice. Each CTB can select one of these filters.

### Syntax Design

Filter coefficients and clipping indices are carried in ALF APSs. An ALF APS can include up to 8 chroma filters and one luma filter set with up to 25 filters. An index ic is also included for each of the 25 luma classes. Classes having the same index ic share the same filter. By merging different classes, the number of bits required to represent the filter coefficients is reduced. The absolute value of a filter coefficient is represented using a 0th order Exp-Golomb code followed by a sign bit for a non-zero coefficient. When clipping is enabled, a clipping index is also signaled for each filter coefficient using a two-bit fixed-length code. The storage needed for ALF coefficients and clipping indices within an APS is at most 3480 bits. Up to 8 ALF APSs can be used by the decoder at the same time.

Filter control syntax elements include two types of information. First, ALF on/off flags are signaled at sequence, picture, slice and CTB levels. Chroma ALF can be enabled at picture and slice level only if luma ALF is enabled at the corresponding level. Second, filter usage information is signaled at picture, slice and CTB level, if ALF is enabled at that level. Referenced ALF APSs IDs are coded at a slice level or at a picture level if all the slices within the picture use the same APSs. Luma component can reference up to 7 ALF APSs and chroma components can reference 1 ALF APS. For a luma CTB, an index is signaled indicating which ALF APS or offline trained luma filter set is used. For a chroma CTB, the index indicates which filter in the referenced APS is used.

### Line Buffer Reduction

To reduce the storage requirement for ALF, VVC employs line buffer boundary processing. In VVC, line buffer boundaries are placed 4 luma samples and 2 chroma samples above horizontal CTU boundaries. When applying ALF to a sample on one side of a line buffer boundary, samples on the other side of the line buffer boundary cannot be used.

### ALF in ECM

### ALF Simplification Removal

ALF gradient subsampling and ALF virtual boundary processing are removed. Block size for classification is reduced from 4×4 to 2×2. Filter size for both luma and chroma, for which ALF coefficients are signalled, is increased to 9×9.

ALF with Fixed Filters

To filter a luma sample, three different classifiers (C₀, C₁ and C₂) and three different sets of filters (F₀, F₁ and F₂) are used. Sets F₀ and F₁ contain fixed filters, with coefficients trained for classifiers C₀ and C₁. Coefficients of filters in F₂ are signalled. Which filter from a set Fᵢ is used for a given sample is decided by a class Cᵢ assigned to this sample using classifier Cᵢ.

### Filtering

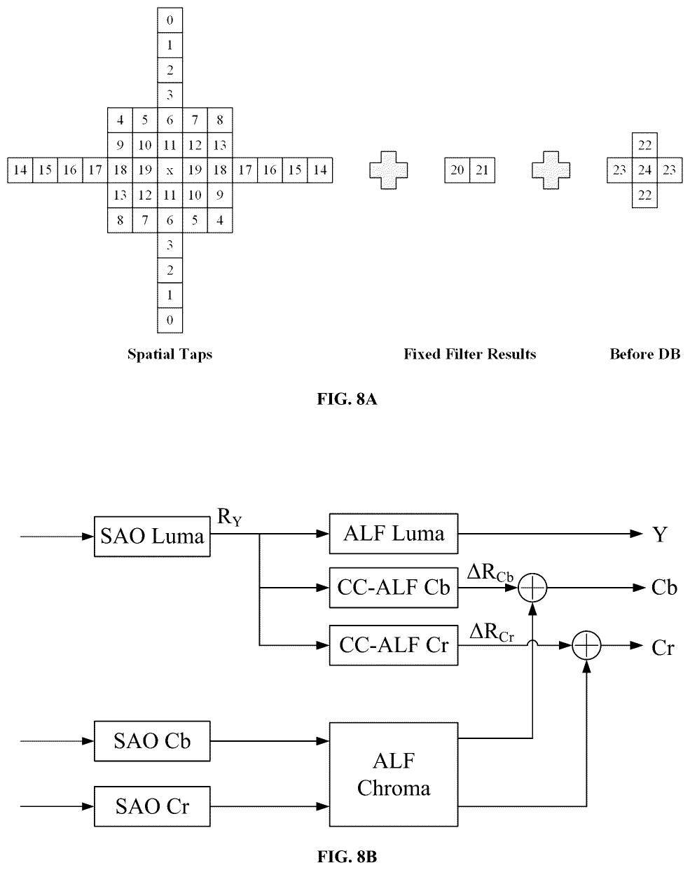

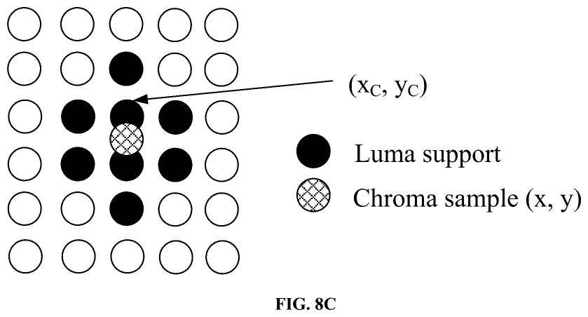

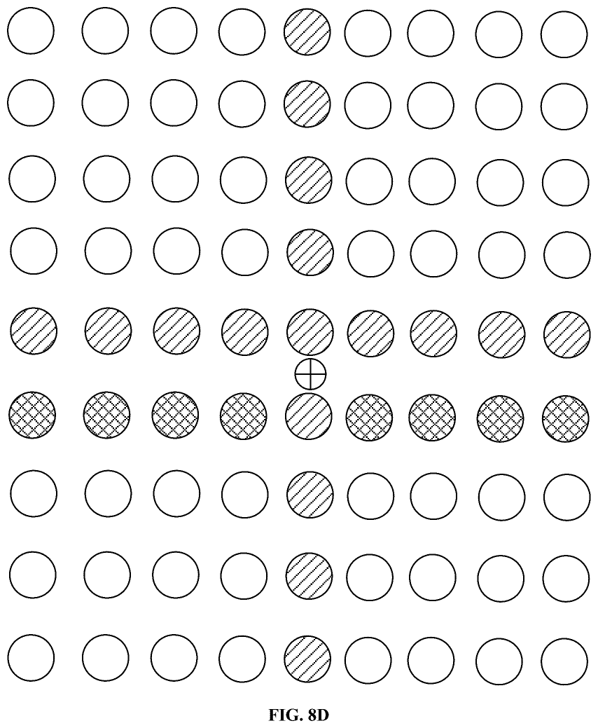

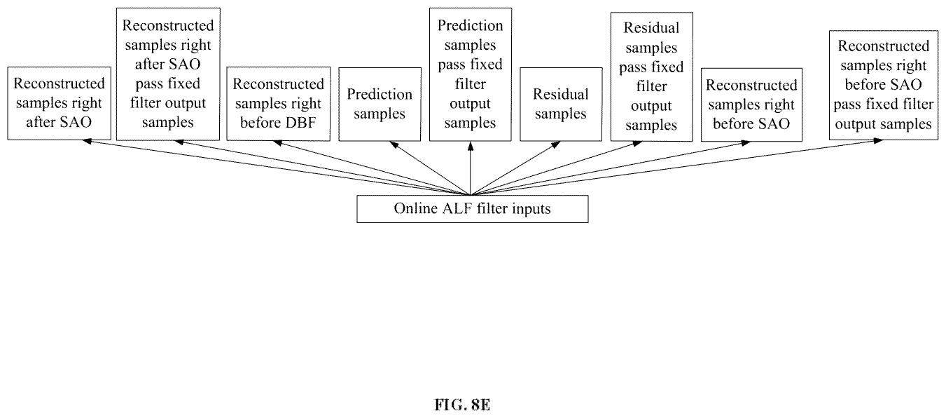

At first, two 13×13 diamond shape fixed filters F₀ and F₁ are applied to derive two intermediate samples R₀(x,y) and R₁ (x,y). After that, F₂ is applied to R₀(x,y), R₁ (x,y), neighboring samples, and samples before deblocking filter (DBF) to derive a filtered sample as:

$$\tilde{R} ( x , y ) = R ( x , y ) + [ {\sum }_{i = 0}^{19} {c}_{i} ( {f}_{i , 0} + {f}_{i , 1} ) ] + [ {\sum }_{i = 20}^{21} {c}_{i} {g}_{i} ] + [ {\sum }_{i = 22}^{24} {c}_{i} ( {h}_{i , 0} + {h}_{i , 1} ) ]$$

where f_{i,j} is the clipped difference between a neighboring sample and current sample R(x,y), gᵢ is the clipped difference between Rᵢ₋₂₀(x,y) and current sample R(x,y), h_{i,j} is the clipped difference between a neighboring sample before DBF and current sample R(x,y). The filter coefficients cᵢ, i=0, . . . 24, are signaled. The filter shape of F₂ is presented in FIG. 8A.

### Classification

Based on directionality Dᵢ and activity Âᵢ, a class Cᵢ is assigned to each 2×2 block:

$${C}_{i} = {\hat{A}}_{i} * {M}_{D , i} + {D}_{i}$$

where M_{D,i} represents the total number of directionalities Dᵢ. As in VVC, values of the horizontal, vertical, and two diagonal gradients are calculated for each sample using 1-D Laplacian. The sum of the sample gradients within a 4×4 window that covers the target 2×2 block is used for classifier C₀ and the sum of sample gradients within a 12×12 window is used for classifiers C₁ and C₂. The sums of horizontal, vertical and two diagonal gradients are denoted, respectively, as gₕⁱ, gᵥⁱ, g_{d1}ⁱ and g_{d2}ⁱ. The directionality Dᵢ is determined by comparing:

$${r}_{h , v}^{i} = \frac{max ( {g}_{h}^{i} , {g}_{v}^{i} )}{min ( {g}_{h}^{i} , {g}_{v}^{i} )} , {r}_{d 1 , d 2}^{i} = \frac{max ( {g}_{d 1}^{i} , {g}_{d 2}^{i} )}{min ( {g}_{d 1}^{i} , {g}_{d 2}^{i} )}$$

with a set of thresholds. The directionality D₂ is derived as in VVC using thresholds 2 and 4.5. For D₀ and D₁, horizontal/vertical edge strength E_{HV}ⁱ and diagonal edge strength E_{D}ⁱ are calculated first. Thresholds Th=[1.25, 1.5, 2, 3, 4.5, 8] are used. Edge strength E_{HV}ⁱ is 0 if r_{h,v}ⁱ≤Th[0]; otherwise, E_{HV}ⁱ is the maximum integer such that r_{h,v}ⁱ>Th[E_{HV}ⁱ−1]. Edge strength E_{D}ⁱ is 0 if r_{d1,d2}ⁱ≤Th[0]; otherwise, E_{D}ⁱ is the maximum integer such that r_{d1,d2}ⁱ>Th[E_{D}ⁱ−1]. When r_{h,v}ⁱ>r_{d1,d2}ⁱ, i.e., horizontal/vertical edges are dominant, the Dᵢ is derived by using Table 2 (a); otherwise, diagonal edges are dominant, the Dᵢ is derived by using Table 2. (b).

TABLE 2
Mapping of E_{D}ⁱ and E_{HV}ⁱ to Dᵢ

| (a) | | (b) | |
|---|---|---|---|
| | E_{D}ⁱ | | E_{HV}ⁱ |

| E_{HV}ⁱ | 0 | 1 | 2 | 3 | 4 | 5 | 6 | E_{D}ⁱ | 0 | 1 | 2 | 3 | 4 | 5 | 6 |
|---|---|---|---|---|---|---|---|---|---|---|---|---|---|---|---|
| 1 | 1 | 2 | 0 | 0 | 0 | 0 | 0 | 0 | 28 | 0 | 0 | 0 | 0 | 0 | 0 |
| 2 | 3 | 4 | 5 | 0 | 0 | 0 | 0 | 1 | 29 | 30 | 0 | 0 | 0 | 0 | 0 |
| 3 | 6 | 7 | 8 | 9 | 0 | 0 | 0 | 2 | 31 | 32 | 33 | 0 | 0 | 0 | 0 |
| 4 | 10 | 11 | 12 | 13 | 14 | 0 | 0 | 3 | 34 | 35 | 36 | 37 | 0 | 0 | 0 |
| 5 | 15 | 16 | 17 | 18 | 19 | 20 | 0 | 4 | 38 | 39 | 40 | 41 | 42 | 0 | 0 |
| 6 | 21 | 22 | 23 | 24 | 25 | 26 | 27 | 5 | 43 | 44 | 45 | 46 | 47 | 48 | 0 |

To obtain Âᵢ, the sum of vertical and horizontal gradients Aᵢ is mapped to the range of 0 to n, where n is equal to 4 for Â₂ and 15 for Â₀ and Â₁. In an ALF_APS, up to 4 luma filter sets are signaled, each set may have up to 25 filters.

### Alternative 2×2 ALF Classifier

Classification in ALF is extended with an additional alternative classifier. For a signaled luma filter set, a flag is signaled to indicate whether the alternative classifier is applied. Geometrical transformation is not applied to the alternative band classifier. When the band-based classifier is applied, the sum of sample values of a 2×2 luma block is calculated at first. Then the class index is calculated as: class_index=(sum*25)>>(sample bit depth+2).

Reference will now be made in detail to specific implementations, examples of which are illustrated in the accompanying drawings. In the following detailed description, numerous non-limiting specific details are set forth in order to assist in understanding the subject matter presented herein. But it will be apparent to one of ordinary skill in the art that various alternatives may be used without departing from the scope of claims and the subject matter may be practiced without these specific details. For example, it will be apparent to one of ordinary skill in the art that the subject matter presented herein can be implemented on many types of electronic devices with digital video capabilities.

It should be illustrated that the terms “first,” “second,” and the like used in the description, claims of the present disclosure, and the accompanying drawings are used to distinguish objects, and not used to describe any specific order or sequence. It should be understood that the data used in this way may be interchanged under an appropriate condition, such that the embodiments of the present disclosure described herein may be implemented in orders besides those shown in the accompanying drawings or described in the present disclosure.

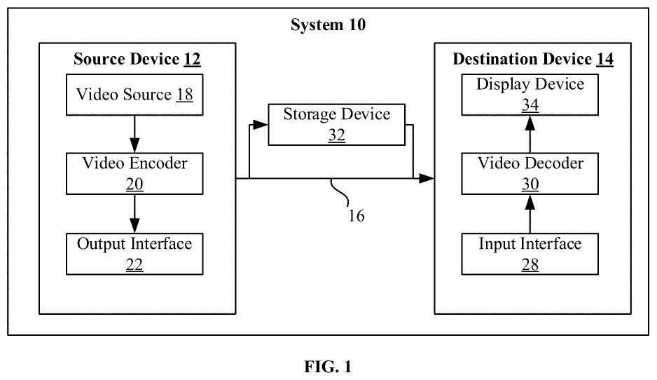

FIG. 1 is a block diagram illustrating an exemplary system 10 for encoding and decoding video blocks in parallel in accordance with some implementations of the present disclosure. As shown in FIG. 1, the system 10 includes a source device 12 that generates and encodes video data to be decoded at a later time by a destination device 14. The source device 12 and the destination device 14 may comprise any of a wide variety of electronic devices, including desktop or laptop computers, tablet computers, smart phones, set-top boxes, digital televisions, cameras, display devices, digital media players, video gaming consoles, video streaming device, or the like. In some implementations, the source device 12 and the destination device 14 are equipped with wireless communication capabilities.

In some implementations, the destination device 14 may receive the encoded video data to be decoded via a link 16. The link 16 may comprise any type of communication medium or device capable of moving the encoded video data from the source device 12 to the destination device 14. In one example, the link 16 may comprise a communication medium to enable the source device 12 to transmit the encoded video data directly to the destination device 14 in real time. The encoded video data may be modulated according to a communication standard, such as a wireless communication protocol, and transmitted to the destination device 14. The communication medium may comprise any wireless or wired communication medium, such as a Radio Frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from the source device 12 to the destination device 14.

In some other implementations, the encoded video data may be transmitted from an output interface 22 to a storage device 32. Subsequently, the encoded video data in the storage device 32 may be accessed by the destination device 14 via an input interface 28. The storage device 32 may include any of a variety of distributed or locally accessed data storage media such as a hard drive, Blu-ray discs, Digital Versatile Disks (DVDs), Compact Disc Read-Only Memories (CD-ROMs), flash memory, volatile or non-volatile memory, or any other suitable digital storage media for storing the encoded video data. In a further example, the storage device 32 may correspond to a file server or another intermediate storage device that may hold the encoded video data generated by the source device 12. The destination device 14 may access the stored video data from the storage device 32 via streaming or downloading. The file server may be any type of computer capable of storing the encoded video data and transmitting the encoded video data to the destination device 14. Exemplary file servers include a web server (e.g., for a website), a File Transfer Protocol (FTP) server, Network Attached Storage (NAS) devices, or a local disk drive. The destination device 14 may access the encoded video data through any standard data connection, including a wireless channel (e.g., a Wireless Fidelity (Wi-Fi) connection), a wired connection (e.g., Digital Subscriber Line (DSL), cable modem, etc.), or a combination of both that is suitable for accessing encoded video data stored on a file server. The transmission of the encoded video data from the storage device 32 may be a streaming transmission, a download transmission, or a combination of both.

As shown in FIG. 1, the source device 12 includes a video source 18, a video encoder 20 and the output interface 22. The video source 18 may include a source such as a video capturing device, e.g., a video camera, a video archive containing previously captured video, a video feeding interface to receive video from a video content provider, and/or a computer graphics system for generating computer graphics data as the source video, or a combination of such sources. As one example, if the video source 18 is a video camera of a security surveillance system, the source device 12 and the destination device 14 may form camera phones or video phones. However, the implementations described in the present application may be applicable to video coding in general, and may be applied to wireless and/or wired applications.

The captured, pre-captured, or computer-generated video may be encoded by the video encoder 20. The encoded video data may be transmitted directly to the destination device 14 via the output interface 22 of the source device 12. The encoded video data may also (or alternatively) be stored onto the storage device 32 for later access by the destination device 14 or other devices, for decoding and/or playback. The output interface 22 may further include a modem and/or a transmitter.

The destination device 14 includes the input interface 28, a video decoder 30, and a display device 34. The input interface 28 may include a receiver and/or a modem and receive the encoded video data over the link 16. The encoded video data communicated over the link 16, or provided on the storage device 32, may include a variety of syntax elements generated by the video encoder 20 for use by the video decoder 30 in decoding the video data. Such syntax elements may be included within the encoded video data transmitted on a communication medium, stored on a storage medium, or stored on a file server.

In some implementations, the destination device 14 may include the display device 34, which can be an integrated display device and an external display device that is configured to communicate with the destination device 14. The display device 34 displays the decoded video data to a user, and may comprise any of a variety of display devices such as a Liquid Crystal Display (LCD), a plasma display, an Organic Light Emitting Diode (OLED) display, or another type of display device.

The video encoder 20 and the video decoder 30 may operate according to proprietary or industry standards, such as VVC, HEVC, MPEG-4, Part 10, AVC, or extensions of such standards. It should be understood that the present application is not limited to a specific video encoding/decoding standard and may be applicable to other video encoding/decoding standards. It is generally contemplated that the video encoder 20 of the source device 12 may be configured to encode video data according to any of these current or future standards. Similarly, it is also generally contemplated that the video decoder 30 of the destination device 14 may be configured to decode video data according to any of these current or future standards.

The video encoder 20 and the video decoder 30 each may be implemented as any of a variety of suitable encoder and/or decoder circuitry, such as one or more microprocessors, Digital Signal Processors (DSPs), Application Specific Integrated Circuits (ASICs), Field Programmable Gate Arrays (FPGAs), discrete logic, software, hardware, firmware or any combinations thereof. When implemented partially in software, an electronic device may store instructions for the software in a suitable, non-transitory computer-readable medium and execute the instructions in hardware using one or more processors to perform the video encoding/decoding operations disclosed in the present disclosure. Each of the video encoder 20 and the video decoder 30 may be included in one or more encoders or decoders, either of which may be integrated as part of a combined encoder/decoder (CODEC) in a respective device.

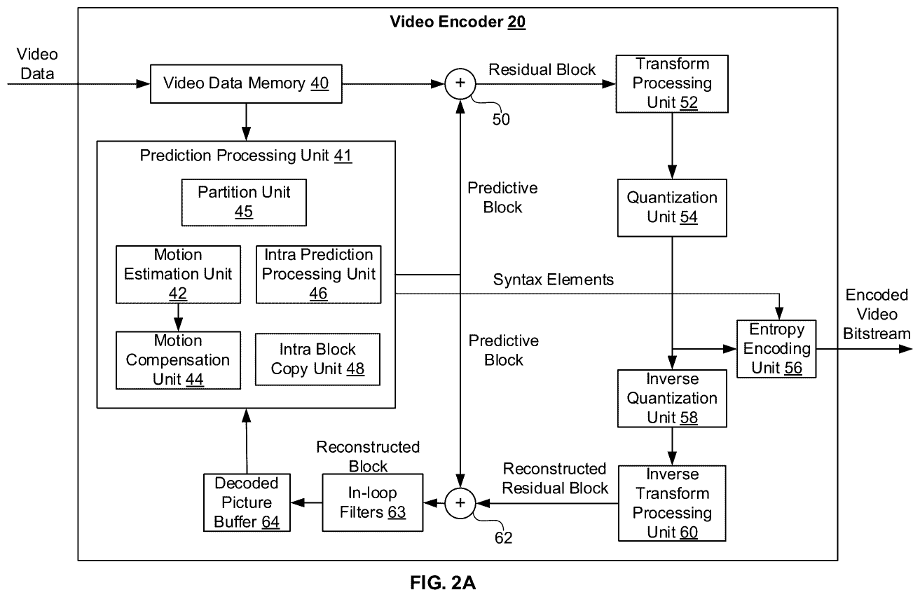

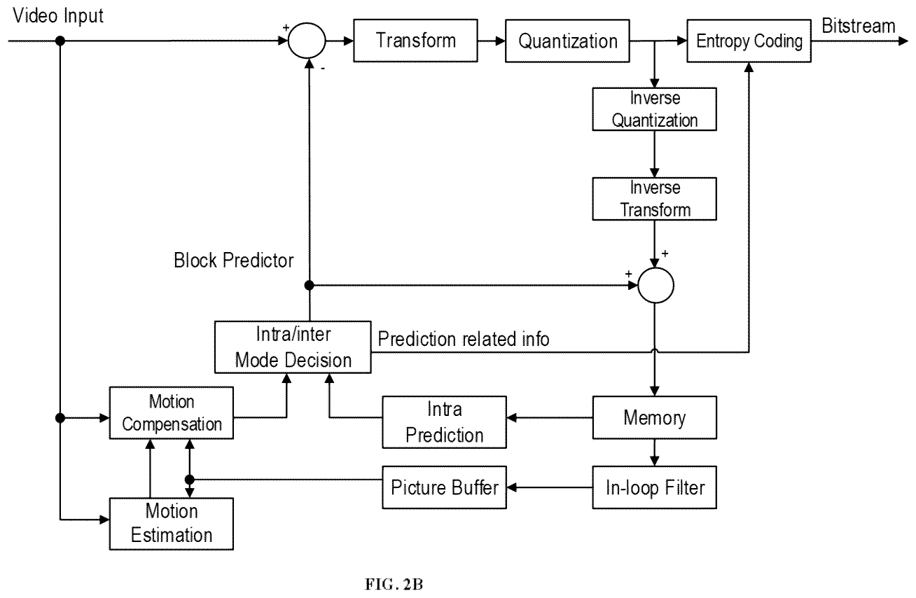

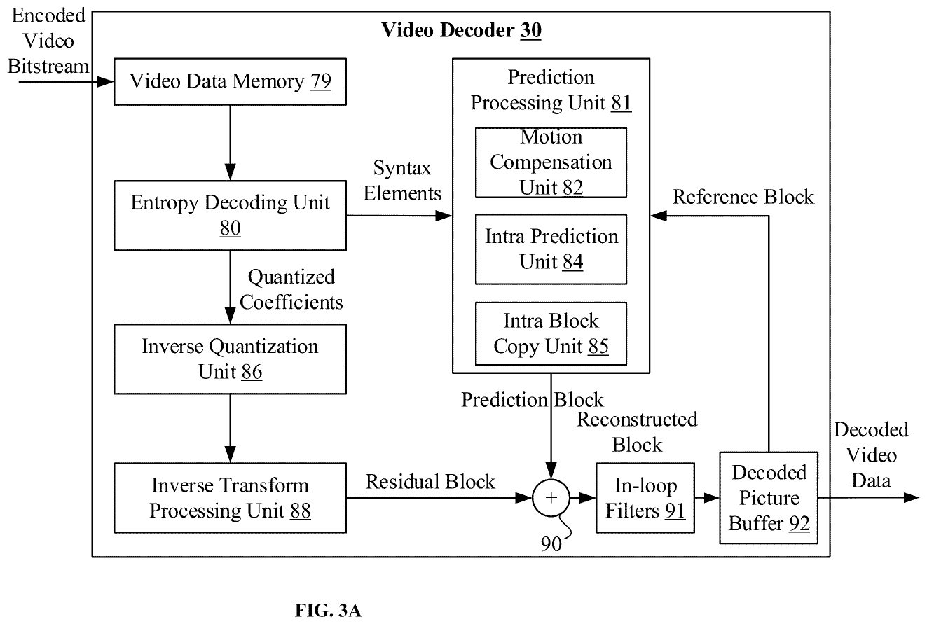

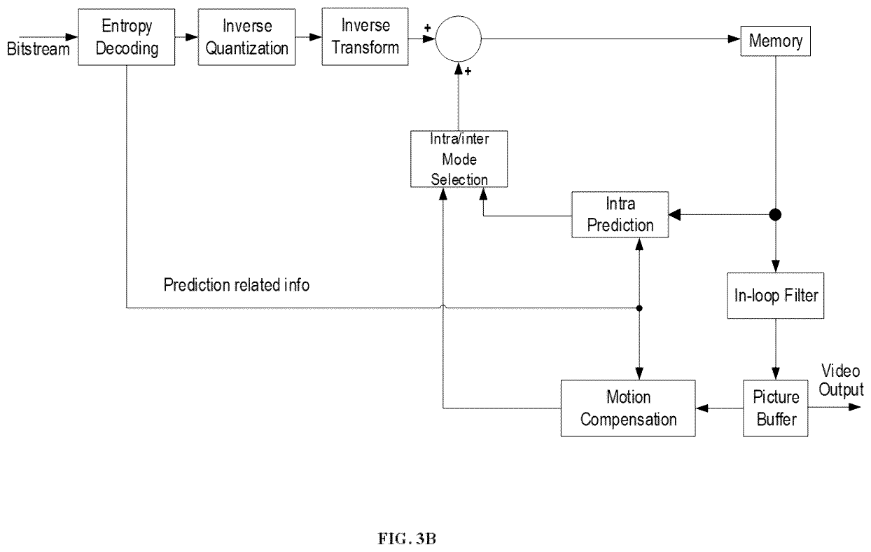

In some implementations, at least a part of components of the source device 12 (for example, the video source 18, the video encoder 20 or components included in the video encoder 20 as described below with reference to FIG. 2A, and the output interface 22) and/or at least a part of components of the destination device 14 (for example, the input interface 28, the video decoder 30 or components included in the video decoder 30 as described below with reference to FIG. 3A, and the display device 34) may operate in a cloud computing service network which may provide software, platforms, and/or infrastructure, such as Software as a Service (SaaS), Platform as a Service (PaaS), or Infrastructure as a Service (IaaS). In some implementations, one or more components in the source device 12 and/or the destination device 14 which are not included in the cloud computing service network may be provided in one or more client devices, and the one or more client devices may communicate with server computers in the cloud computing service network through a wireless communication network (for example, a cellular communication network, a short-range wireless communication network, or a global navigation satellite system (GNSS) communication network) or a wired communication network (e.g., a local area network (LAN) communication network or a power line communication (PLC) network). In an embodiment, at least a part of operations described herein may be implemented as cloud-based services provided by one or more server computers which are implemented by the at least a part of the components of the source device 12 and/or the at least a part of the components of the destination device 14 in the cloud computing service network; and one or more other operations described herein may be implemented by the one or more client devices. In some implementations, the cloud computing service network may be a private cloud, a public cloud, or a hybrid cloud. The terms such as “cloud,” “cloud computing,” “cloud-based” etc. herein may be used interchangeably as appropriate without departing from the scope of the present disclosure. It should be understood that the present disclosure is not limited to being implemented in the cloud computing service network described above. Instead, the present disclosure may also be implemented in any other type of computing environments currently known or developed in the future.

FIG. 2A is a block diagram illustrating an exemplary video encoder 20 in accordance with some implementations described in the present application. The video encoder 20 may perform intra and inter predictive coding of video blocks within video frames. Intra predictive coding relies on spatial prediction to reduce or remove spatial redundancy in video data within a given video frame or picture. Inter predictive coding relies on temporal prediction to reduce or remove temporal redundancy in video data within adjacent video frames or pictures of a video sequence. It should be noted that the term “frame” may be used as synonyms for the term “image” or “picture” in the field of video coding.

As shown in FIG. 2A, the video encoder 20 includes a video data memory 40, a prediction processing unit 41, a Decoded Picture Buffer (DPB) 64, a summer 50, a transform processing unit 52, a quantization unit 54, and an entropy encoding unit 56. The prediction processing unit 41 further includes a motion estimation unit 42, a motion compensation unit 44, a partition unit 45, an intra prediction processing unit 46, and an intra Block Copy (BC) unit 48. In some implementations, the video encoder 20 also includes an inverse quantization unit 58, an inverse transform processing unit 60, and a summer 62 for video block reconstruction. An in-loop filter 63, such as a deblocking filter, may be positioned between the summer 62 and the DPB 64 to filter block boundaries to remove blockiness artifacts from reconstructed video. Another in-loop filter, such as Sample Adaptive Offset (SAO) filter, Cross Component Sample Adaptive Offset (CCSAO) filter and/or Adaptive in-Loop Filter (ALF), may also be used in addition to the deblocking filter to filter an output of the summer 62. It should be illustrated that for the CCSAO technique, the present application is not limited to the embodiments described herein, and instead, the application may be applied to a situation where an offset is selected for any of a luma component, a Cb chroma component and a Cr chroma component according to any other of the luma component, the Cb chroma component and the Cr chroma component to modify said any component based on the selected offset. Further, it should also be illustrated that a first component mentioned herein may be any of the luma component, the Cb chroma component and the Cr chroma component, a second component mentioned herein may be any other of the luma component, the Cb chroma component and the Cr chroma component, and a third component mentioned herein may be a remaining one of the luma component, the Cb chroma component and the Cr chroma component. In some examples, the in-loop filters may be omitted, and the decoded video block may be directly provided by the summer 62 to the DPB 64. The video encoder 20 may take the form of a fixed or programmable hardware unit or may be divided among one or more of the illustrated fixed or programmable hardware units.

The video data memory 40 may store video data to be encoded by the components of the video encoder 20. The video data in the video data memory 40 may be obtained, for example, from the video source 18 as shown in FIG. 1. The DPB 64 is a buffer that stores reference video data (for example, reference frames or pictures) for use in encoding video data by the video encoder 20 (e.g., in intra or inter predictive coding modes). The video data memory 40 and the DPB 64 may be formed by any of a variety of memory devices. In various examples, the video data memory 40 may be on-chip with other components of the video encoder 20, or off-chip relative to those components.

As shown in FIG. 2A, after receiving the video data, the partition unit 45 within the prediction processing unit 41 partitions the video data into video blocks. This partitioning may also include partitioning a video frame into slices, tiles (for example, sets of video blocks), or other larger Coding Units (CUs) according to predefined splitting structures such as a Quad-Tree (QT) structure associated with the video data. The video frame is or may be regarded as a two-dimensional array or matrix of samples with sample values. A sample in the array may also be referred to as a pixel or a pel. A number of samples in horizontal and vertical directions (or axes) of the array or picture define a size and/or a resolution of the video frame. The video frame may be divided into multiple video blocks by, for example, using QT partitioning. The video block again is or may be regarded as a two-dimensional array or matrix of samples with sample values, although of smaller dimension than the video frame. A number of samples in horizontal and vertical directions (or axes) of the video block define a size of the video block. The video block may further be partitioned into one or more block partitions or sub-blocks (which may form again blocks) by, for example, iteratively using QT partitioning, Binary-Tree (BT) partitioning or Triple-Tree (TT) partitioning or any combination thereof. It should be noted that the term “block” or “video block” as used herein may be a portion, in particular a rectangular (square or non-square) portion, of a frame or a picture. With reference, for example, to HEVC and VVC, the block or video block may be or correspond to a Coding Tree Unit (CTU), a CU, a Prediction Unit (PU) or a Transform Unit (TU) and/or may be or correspond to a corresponding block, e.g. a Coding Tree Block (CTB), a Coding Block (CB), a Prediction Block (PB) or a Transform Block (TB) and/or to a sub-block.

The prediction processing unit 41 may select one of a plurality of possible predictive coding modes, such as one of a plurality of intra predictive coding modes or one of a plurality of inter predictive coding modes, for the current video block based on error results (e.g., coding rate and the level of distortion). The prediction processing unit 41 may provide the resulting intra or inter prediction coded block to the summer 50 to generate a residual block and to the summer 62 to reconstruct the encoded block for use as part of a reference frame subsequently. The prediction processing unit 41 also provides syntax elements, such as motion vectors, intra-mode indicators, partition information, and other such syntax information, to the entropy encoding unit 56.

In order to select an appropriate intra predictive coding mode for the current video block, the intra prediction processing unit 46 within the prediction processing unit 41 may perform intra predictive coding of the current video block relative to one or more neighbor blocks in the same frame as the current block to be coded to provide spatial prediction. The motion estimation unit 42 and the motion compensation unit 44 within the prediction processing unit 41 perform inter predictive coding of the current video block relative to one or more predictive blocks in one or more reference frames to provide temporal prediction. The video encoder 20 may perform multiple coding passes, e.g., to select an appropriate coding mode for each block of video data.

In some implementations, the motion estimation unit 42 determines the inter prediction mode for a current video frame by generating a motion vector, which indicates the displacement of a video block within the current video frame relative to a predictive block within a reference video frame, according to a predetermined pattern within a sequence of video frames. Motion estimation, performed by the motion estimation unit 42, is the process of generating motion vectors, which estimate motion for video blocks. A motion vector, for example, may indicate the displacement of a video block within a current video frame or picture relative to a predictive block within a reference frame relative to the current block being coded within the current frame. The predetermined pattern may designate video frames in the sequence as P frames or B frames. The intra BC unit 48 may determine vectors, e.g., block vectors, for intra BC coding in a manner similar to the determination of motion vectors by the motion estimation unit 42 for inter prediction, or may utilize the motion estimation unit 42 to determine the block vector.

A predictive block for the video block may be or may correspond to a block or a reference block of a reference frame that is deemed as closely matching the video block to be coded in terms of pixel difference, which may be determined by Sum of Absolute Difference (SAD), Sum of Square Difference (SSD), or other difference metrics. In some implementations, the video encoder 20 may calculate values for sub-integer pixel positions of reference frames stored in the DPB 64. For example, the video encoder 20 may interpolate values of one-quarter pixel positions, one-eighth pixel positions, or other fractional pixel positions of the reference frame. Therefore, the motion estimation unit 42 may perform a motion search relative to the full pixel positions and fractional pixel positions and output a motion vector with fractional pixel precision.

The motion estimation unit 42 calculates a motion vector for a video block in an inter prediction coded frame by comparing the position of the video block to the position of a predictive block of a reference frame selected from a first reference frame list (List 0) or a second reference frame list (List 1), each of which identifies one or more reference frames stored in the DPB 64. The motion estimation unit 42 sends the calculated motion vector to the motion compensation unit 44 and then to the entropy encoding unit 56.

Motion compensation, performed by the motion compensation unit 44, may involve fetching or generating the predictive block based on the motion vector determined by the motion estimation unit 42. Upon receiving the motion vector for the current video block, the motion compensation unit 44 may locate a predictive block to which the motion vector points in one of the reference frame lists, retrieve the predictive block from the DPB 64, and forward the predictive block to the summer 50. The summer 50 then forms a residual video block of pixel difference values by subtracting pixel values of the predictive block provided by the motion compensation unit 44 from the pixel values of the current video block being coded. The pixel difference values forming the residual video block may include luma or chroma component differences or both. The motion compensation unit 44 may also generate syntax elements associated with the video blocks of a video frame for use by the video decoder 30 in decoding the video blocks of the video frame. The syntax elements may include, for example, syntax elements defining the motion vector used to identify the predictive block, any flags indicating the prediction mode, or any other syntax information described herein. Note that the motion estimation unit 42 and the motion compensation unit 44 may be highly integrated, but are illustrated separately for conceptual purposes.

In some implementations, the intra BC unit 48 may generate vectors and fetch predictive blocks in a manner similar to that described above in connection with the motion estimation unit 42 and the motion compensation unit 44, but with the predictive blocks being in the same frame as the current block being coded and with the vectors being referred to as block vectors as opposed to motion vectors. In particular, the intra BC unit 48 may determine an intra-prediction mode to use to encode a current block. In some examples, the intra BC unit 48 may encode a current block using various intra-prediction modes, e.g., during separate encoding passes, and test their performance through rate-distortion analysis. Next, the intra BC unit 48 may select, among the various tested intra-prediction modes, an appropriate intra-prediction mode to use and generate an intra-mode indicator accordingly. For example, the intra BC unit 48 may calculate rate-distortion values using a rate-distortion analysis for the various tested intra-prediction modes, and select the intra-prediction mode having the best rate-distortion characteristics among the tested modes as the appropriate intra-prediction mode to use. Rate-distortion analysis generally determines an amount of distortion (or error) between an encoded block and an original, unencoded block that was encoded to produce the encoded block, as well as a bitrate (i.e., a number of bits) used to produce the encoded block. Intra BC unit 48 may calculate ratios from the distortions and rates for the various encoded blocks to determine which intra-prediction mode exhibits the best rate-distortion value for the block. In other examples, the intra BC unit 48 may use the motion estimation unit 42 and the motion compensation unit 44, in whole or in part, to perform such functions for Intra BC prediction according to the implementations described herein. In either case, for Intra block copy, a predictive block may be a block that is deemed as closely matching the block to be coded, in terms of pixel difference, which may be determined by SAD, SSD, or other difference metrics, and identification of the predictive block may include calculation of values for sub-integer pixel positions.

Whether the predictive block is from the same frame according to intra prediction, or a different frame according to inter prediction, the video encoder 20 may form a residual video block by subtracting pixel values of the predictive block from the pixel values of the current video block being coded, forming pixel difference values. The pixel difference values forming the residual video block may include both luma and chroma component differences.

The intra prediction processing unit 46 may intra-predict a current video block, as an alternative to the inter-prediction performed by the motion estimation unit 42 and the motion compensation unit 44, or the intra block copy prediction performed by the intra BC unit 48, as described above. In particular, the intra prediction processing unit 46 may determine an intra prediction mode to use to encode a current block. To do so, the intra prediction processing unit 46 may encode a current block using various intra prediction modes, e.g., during separate encoding passes, and the intra prediction processing unit 46 (or a mode selection unit, in some examples) may select an appropriate intra prediction mode to use from the tested intra prediction modes. The intra prediction processing unit 46 may provide information indicative of the selected intra-prediction mode for the block to the entropy encoding unit 56. The entropy encoding unit 56 may encode the information indicating the selected intra-prediction mode in the bitstream.

After the prediction processing unit 41 determines the predictive block for the current video block via either inter prediction or intra prediction, the summer 50 forms a residual video block by subtracting the predictive block from the current video block. The residual video data in the residual block may be included in one or more TUs and is provided to the transform processing unit 52. The transform processing unit 52 transforms the residual video data into residual transform coefficients using a transform, such as a Discrete Cosine Transform (DCT) or a conceptually similar transform.

The transform processing unit 52 may send the resulting transform coefficients to the quantization unit 54. The quantization unit 54 quantizes the transform coefficients to further reduce the bit rate. The quantization process may also reduce the bit depth associated with some or all of the coefficients. The degree of quantization may be modified by adjusting a quantization parameter. In some examples, the quantization unit 54 may then perform a scan of a matrix including the quantized transform coefficients. Alternatively, the entropy encoding unit 56 may perform the scan.

Following quantization, the entropy encoding unit 56 entropy encodes the quantized transform coefficients into a video bitstream using, e.g., Context Adaptive Variable Length Coding (CAVLC), Context Adaptive Binary Arithmetic Coding (CABAC), Syntax-based context-adaptive Binary Arithmetic Coding (SBAC), Probability Interval Partitioning Entropy (PIPE) coding or another entropy encoding methodology or technique. The encoded bitstream may then be transmitted to the video decoder 30 as shown in FIG. 1, or archived in the storage device 32 as shown in FIG. 1 for later transmission to or retrieval by the video decoder 30. The entropy encoding unit 56 may also entropy encode the motion vectors and the other syntax elements for the current video frame being coded.

The inverse quantization unit 58 and the inverse transform processing unit 60 apply inverse quantization and inverse transformation, respectively, to reconstruct the residual video block in the pixel domain for generating a reference block for prediction of other video blocks. As noted above, the motion compensation unit 44 may generate a motion compensated predictive block from one or more reference blocks of the frames stored in the DPB 64. The motion compensation unit 44 may also apply one or more interpolation filters to the predictive block to calculate sub-integer pixel values for use in motion estimation.

The summer 62 adds the reconstructed residual block to the motion compensated predictive block produced by the motion compensation unit 44 to produce a reference block for storage in the DPB 64. The reference block may then be used by the intra BC unit 48, the motion estimation unit 42 and the motion compensation unit 44 as a predictive block to inter predict another video block in a subsequent video frame.

FIG. 3A is a block diagram illustrating an exemplary video decoder 30 in accordance with some implementations of the present application. The video decoder 30 includes a video data memory 79, an entropy decoding unit 80, a prediction processing unit 81, an inverse quantization unit 86, an inverse transform processing unit 88, a summer 90, and a DPB 92. The prediction processing unit 81 further includes a motion compensation unit 82, an intra prediction unit 84, and an intra BC unit 85. The video decoder 30 may perform a decoding process generally reciprocal to the encoding process described above with respect to the video encoder 20 in connection with FIG. 2A. For example, the motion compensation unit 82 may generate prediction data based on motion vectors received from the entropy decoding unit 80, while the intra-prediction unit 84 may generate prediction data based on intra-prediction mode indicators received from the entropy decoding unit 80.

In some examples, a unit of the video decoder 30 may be tasked to perform the implementations of the present application. Also, in some examples, the implementations of the present disclosure may be divided among one or more of the units of the video decoder 30. For example, the intra BC unit 85 may perform the implementations of the present application, alone, or in combination with other units of the video decoder 30, such as the motion compensation unit 82, the intra prediction unit 84, and the entropy decoding unit 80. In some examples, the video decoder 30 may not include the intra BC unit 85 and the functionality of intra BC unit 85 may be performed by other components of the prediction processing unit 81, such as the motion compensation unit 82.

The video data memory 79 may store video data, such as an encoded video bitstream, to be decoded by the other components of the video decoder 30. The video data stored in the video data memory 79 may be obtained, for example, from the storage device 32, from a local video source, such as a camera, via wired or wireless network communication of video data, or by accessing physical data storage media (e.g., a flash drive or hard disk). The video data memory 79 may include a Coded Picture Buffer (CPB) that stores encoded video data from an encoded video bitstream. The DPB 92 of the video decoder 30 stores reference video data for use in decoding video data by the video decoder 30 (e.g., in intra or inter predictive coding modes). The video data memory 79 and the DPB 92 may be formed by any of a variety of memory devices, such as dynamic random access memory (DRAM), including Synchronous DRAM (SDRAM), Magneto-resistive RAM (MRAM), Resistive RAM (RRAM), or other types of memory devices. For illustrative purpose, the video data memory 79 and the DPB 92 are depicted as two distinct components of the video decoder 30 in FIG. 3A. But it will be apparent to one skilled in the art that the video data memory 79 and the DPB 92 may be provided by the same memory device or separate memory devices. In some examples, the video data memory 79 may be on-chip with other components of the video decoder 30, or off-chip relative to those components.

During the decoding process, the video decoder 30 receives an encoded video bitstream that represents video blocks of an encoded video frame and associated syntax elements. The video decoder 30 may receive the syntax elements at the video frame level and/or the video block level. The entropy decoding unit 80 of the video decoder 30 entropy decodes the bitstream to generate quantized coefficients, motion vectors or intra-prediction mode indicators, and other syntax elements. The entropy decoding unit 80 then forwards the motion vectors or intra-prediction mode indicators and other syntax elements to the prediction processing unit 81.

When the video frame is coded as an intra predictive coded (I) frame or for intra coded predictive blocks in other types of frames, the intra prediction unit 84 of the prediction processing unit 81 may generate prediction data for a video block of the current video frame based on a signaled intra prediction mode and reference data from previously decoded blocks of the current frame.

When the video frame is coded as an inter-predictive coded (i.e., B or P) frame, the motion compensation unit 82 of the prediction processing unit 81 produces one or more predictive blocks for a video block of the current video frame based on the motion vectors and other syntax elements received from the entropy decoding unit 80. Each of the predictive blocks may be produced from a reference frame within one of the reference frame lists. The video decoder 30 may construct the reference frame lists, List 0 and List 1, using default construction techniques based on reference frames stored in the DPB 92.

In some examples, when the video block is coded according to the intra BC mode described herein, the intra BC unit 85 of the prediction processing unit 81 produces predictive blocks for the current video block based on block vectors and other syntax elements received from the entropy decoding unit 80. The predictive blocks may be within a reconstructed region of the same picture as the current video block defined by the video encoder 20.

The motion compensation unit 82 and/or the intra BC unit 85 determines prediction information for a video block of the current video frame by parsing the motion vectors and other syntax elements, and then uses the prediction information to produce the predictive blocks for the current video block being decoded. For example, the motion compensation unit 82 uses some of the received syntax elements to determine a prediction mode (e.g., intra or inter prediction) used to code video blocks of the video frame, an inter prediction frame type (e.g., B or P), construction information for one or more of the reference frame lists for the frame, motion vectors for each inter predictive encoded video block of the frame, inter prediction status for each inter predictive coded video block of the frame, and other information to decode the video blocks in the current video frame.

Similarly, the intra BC unit 85 may use some of the received syntax elements, e.g., a flag, to determine that the current video block was predicted using the intra BC mode, construction information of which video blocks of the frame are within the reconstructed region and should be stored in the DPB 92, block vectors for each intra BC predicted video block of the frame, intra BC prediction status for each intra BC predicted video block of the frame, and other information to decode the video blocks in the current video frame.

The motion compensation unit 82 may also perform interpolation using the interpolation filters as used by the video encoder 20 during encoding of the video blocks to calculate interpolated values for sub-integer pixels of reference blocks. In this case, the motion compensation unit 82 may determine the interpolation filters used by the video encoder 20 from the received syntax elements and use the interpolation filters to produce predictive blocks.

The inverse quantization unit 86 inverse quantizes the quantized transform coefficients provided in the bitstream and entropy decoded by the entropy decoding unit 80 using the same quantization parameter calculated by the video encoder 20 for each video block in the video frame to determine a degree of quantization. The inverse transform processing unit 88 applies an inverse transform, e.g., an inverse DCT, an inverse integer transform, or a conceptually similar inverse transform process, to the transform coefficients in order to reconstruct the residual blocks in the pixel domain.

After the motion compensation unit 82 or the intra BC unit 85 generates the predictive block for the current video block based on the vectors and other syntax elements, the summer 90 reconstructs decoded video block for the current video block by summing the residual block from the inverse transform processing unit 88 and a corresponding predictive block generated by the motion compensation unit 82 and the intra BC unit 85. An in-loop filter 91 such as deblocking filter, SAO filter, CCSAO filter and/or ALF may be positioned between the summer 90 and the DPB 92 to further process the decoded video block. In some examples, the in-loop filter 91 may be omitted, and the decoded video block may be directly provided by the summer 90 to the DPB 92. The decoded video blocks in a given frame are then stored in the DPB 92, which stores reference frames used for subsequent motion compensation of next video blocks. The DPB 92, or a memory device separate from the DPB 92, may also store decoded video for later presentation on a display device, such as the display device 34 of FIG. 1.

In a typical video coding process, a video sequence typically includes an ordered set of frames or pictures. Each frame may include three sample arrays, denoted SL, SCb, and SCr. SL is a two-dimensional array of luma samples. SCb is a two-dimensional array of Cb chroma samples. SCr is a two-dimensional array of Cr chroma samples. In other instances, a frame may be monochrome and therefore includes only one two-dimensional array of luma samples.

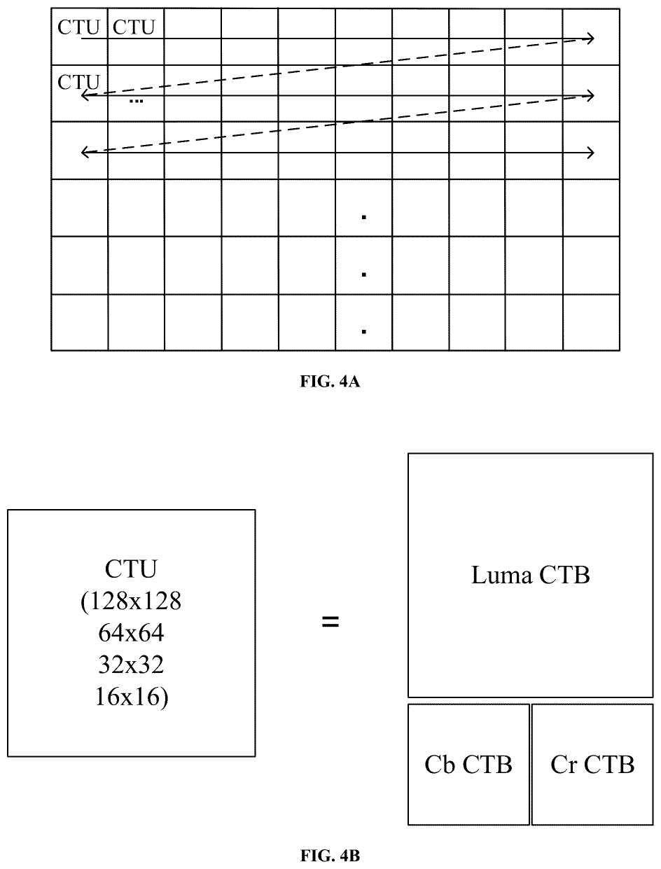

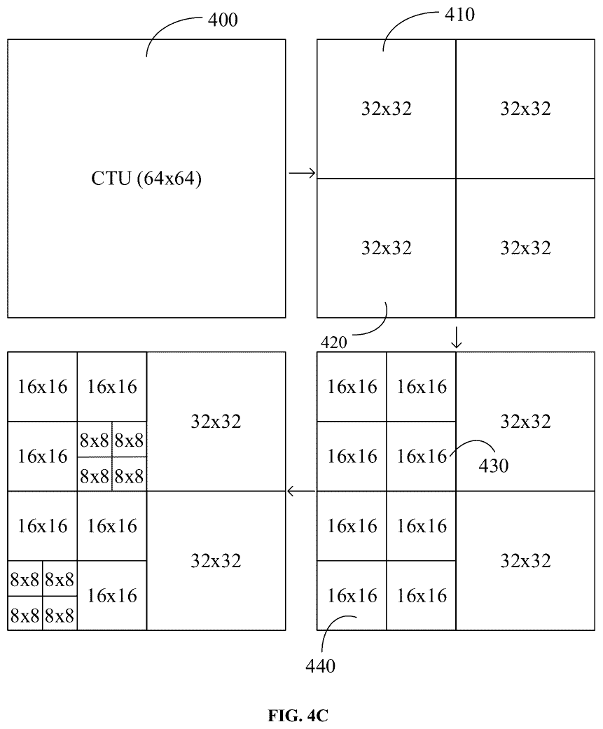

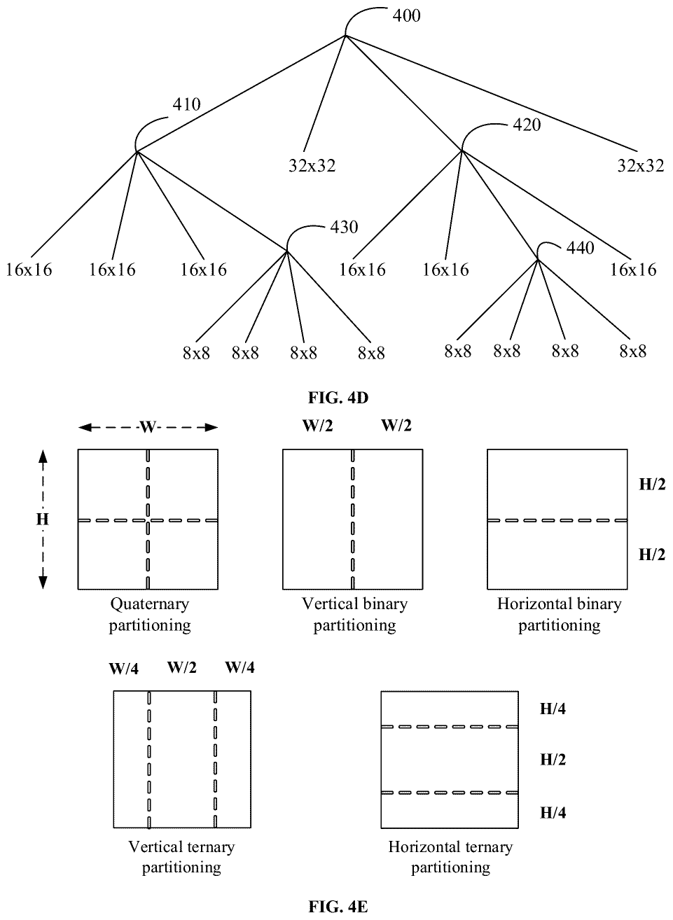

As shown in FIG. 4A, the video encoder 20 (or more specifically the partition unit 45) generates an encoded representation of a frame by first partitioning the frame into a set of CTUs. A video frame may include an integer number of CTUs ordered consecutively in a raster scan order from left to right and from top to bottom. Each CTU is a largest logical coding unit and the width and height of the CTU are signaled by the video encoder 20 in a sequence parameter set, such that all the CTUs in a video sequence have the same size being one of 128×128, 64×64, 32×32, and 16×16. But it should be noted that the present application is not necessarily limited to a particular size. As shown in FIG. 4B, each CTU may comprise one CTB of luma samples, two corresponding coding tree blocks of chroma samples, and syntax elements used to code the samples of the coding tree blocks. The syntax elements describe properties of different types of units of a coded block of pixels and how the video sequence can be reconstructed at the video decoder 30, including inter or intra prediction, intra prediction mode, motion vectors, and other parameters. In monochrome pictures or pictures having three separate color planes, a CTU may comprise a single coding tree block and syntax elements used to code the samples of the coding tree block. A coding tree block may be an N×N block of samples.

To achieve a better performance, the video encoder 20 may recursively perform tree partitioning such as binary-tree partitioning, ternary-tree partitioning, quad-tree partitioning or a combination thereof on the coding tree blocks of the CTU and divide the CTU into smaller CUs. As depicted in FIG. 4C, the 64×64 CTU 400 is first divided into four smaller CUs, each having a block size of 32×32. Among the four smaller CUs, CU 410 and CU 420 are each divided into four CUs of 16×16 by block size. The two 16×16 CUs 430 and 440 are each further divided into four CUs of 8×8 by block size. FIG. 4D depicts a quad-tree data structure illustrating the end result of the partition process of the CTU 400 as depicted in FIG. 4C, each leaf node of the quad-tree corresponding to one CU of a respective size ranging from 32×32 to 8×8. Like the CTU depicted in FIG. 4B, each CU may comprise a CB of luma samples and two corresponding coding blocks of chroma samples of a frame of the same size, and syntax elements used to code the samples of the coding blocks. In monochrome pictures or pictures having three separate color planes, a CU may comprise a single coding block and syntax structures used to code the samples of the coding block. It should be noted that the quad-tree partitioning depicted in FIGS. 4C and 4D is only for illustrative purposes and one CTU can be split into CUs to adapt to varying local characteristics based on quad/ternary/binary-tree partitions. In the multi-type tree structure, one CTU is partitioned by a quad-tree structure and each quad-tree leaf CU can be further partitioned by a binary and ternary tree structure. As shown in FIG. 4E, there are five possible partitioning types of a coding block having a width W and a height H, i.e., quaternary partitioning, horizontal binary partitioning, vertical binary partitioning, horizontal ternary partitioning, and vertical ternary partitioning.

In some implementations, the video encoder 20 may further partition a coding block of a CU into one or more M×N PBs. A PB is a rectangular (square or non-square) block of samples on which the same prediction, inter or intra, is applied. A PU of a CU may comprise a PB of luma samples, two corresponding PBs of chroma samples, and syntax elements used to predict the PBs. In monochrome pictures or pictures having three separate color planes, a PU may comprise a single PB and syntax structures used to predict the PB. The video encoder 20 may generate predictive luma, Cb, and Cr blocks for luma, Cb, and Cr PBs of each PU of the CU.

The video encoder 20 may use intra prediction or inter prediction to generate the predictive blocks for a PU. If the video encoder 20 uses intra prediction to generate the predictive blocks of a PU, the video encoder 20 may generate the predictive blocks of the PU based on decoded samples of the frame associated with the PU. If the video encoder 20 uses inter prediction to generate the predictive blocks of a PU, the video encoder 20 may generate the predictive blocks of the PU based on decoded samples of one or more frames other than the frame associated with the PU.

After the video encoder 20 generates predictive luma, Cb, and Cr blocks for one or more PUs of a CU, the video encoder 20 may generate a luma residual block for the CU by subtracting the CU's predictive luma blocks from its original luma coding block such that each sample in the CU's luma residual block indicates a difference between a luma sample in one of the CU's predictive luma blocks and a corresponding sample in the CU's original luma coding block. Similarly, the video encoder 20 may generate a Cb residual block and a Cr residual block for the CU, respectively, such that each sample in the CU's Cb residual block indicates a difference between a Cb sample in one of the CU's predictive Cb blocks and a corresponding sample in the CU's original Cb coding block and each sample in the CU's Cr residual block may indicate a difference between a Cr sample in one of the CU's predictive Cr blocks and a corresponding sample in the CU's original Cr coding block.

Furthermore, as illustrated in FIG. 4C, the video encoder 20 may use quad-tree partitioning to decompose the luma, Cb, and Cr residual blocks of a CU into one or more luma, Cb, and Cr transform blocks respectively. A transform block is a rectangular (square or non-square) block of samples on which the same transform is applied. A TU of a CU may comprise a transform block of luma samples, two corresponding transform blocks of chroma samples, and syntax elements used to transform the transform block samples. Thus, each TU of a CU may be associated with a luma transform block, a Cb transform block, and a Cr transform block. In some examples, the luma transform block associated with the TU may be a sub-block of the CU's luma residual block. The Cb transform block may be a sub-block of the CU's Cb residual block. The Cr transform block may be a sub-block of the CU's Cr residual block. In monochrome pictures or pictures having three separate color planes, a TU may comprise a single transform block and syntax structures used to transform the samples of the transform block.

The video encoder 20 may apply one or more transforms to a luma transform block of a TU to generate a luma coefficient block for the TU. A coefficient block may be a two-dimensional array of transform coefficients. A transform coefficient may be a scalar quantity. The video encoder 20 may apply one or more transforms to a Cb transform block of a TU to generate a Cb coefficient block for the TU. The video encoder 20 may apply one or more transforms to a Cr transform block of a TU to generate a Cr coefficient block for the TU.

After generating a coefficient block (e.g., a luma coefficient block, a Cb coefficient block or a Cr coefficient block), the video encoder 20 may quantize the coefficient block. Quantization generally refers to a process in which transform coefficients are quantized to possibly reduce the amount of data used to represent the transform coefficients, providing further compression. After the video encoder 20 quantizes a coefficient block, the video encoder 20 may entropy encode syntax elements indicating the quantized transform coefficients. For example, the video encoder 20 may perform CABAC on the syntax elements indicating the quantized transform coefficients. Finally, the video encoder 20 may output a bitstream that includes a sequence of bits that forms a representation of coded frames and associated data, which is either saved in the storage device 32 or transmitted to the destination device 14.

After receiving a bitstream generated by the video encoder 20, the video decoder 30 may parse the bitstream to obtain syntax elements from the bitstream. The video decoder 30 may reconstruct the frames of the video data based at least in part on the syntax elements obtained from the bitstream. The process of reconstructing the video data is generally reciprocal to the encoding process performed by the video encoder 20. For example, the video decoder 30 may perform inverse transforms on the coefficient blocks associated with TUs of a current CU to reconstruct residual blocks associated with the TUs of the current CU. The video decoder 30 also reconstructs the coding blocks of the current CU by adding the samples of the predictive blocks for PUs of the current CU to corresponding samples of the transform blocks of the TUs of the current CU. After reconstructing the coding blocks for each CU of a frame, video decoder 30 may reconstruct the frame.

As noted above, video coding achieves video compression using primarily two modes, i.e., intra-frame prediction (or intra-prediction) and inter-frame prediction (or inter-prediction). It is noted that IBC could be regarded as either intra-frame prediction or a third mode. Between the two modes, inter-frame prediction contributes more to the coding efficiency than intra-frame prediction because of the use of motion vectors for predicting a current video block from a reference video block.

But with the ever improving video data capturing technology and more refined video block size for preserving details in the video data, the amount of data required for representing motion vectors for a current frame also increases substantially. One way of overcoming this challenge is to benefit from the fact that not only a group of neighboring CUs in both the spatial and temporal domains have similar video data for predicting purpose but the motion vectors between these neighboring CUs are also similar. Therefore, it is possible to use the motion information of spatially neighboring CUs and/or temporally co-located CUs as an approximation of the motion information (e.g., motion vector) of a current CU by exploring their spatial and temporal correlation, which is also referred to as “Motion Vector Predictor (MVP)” of the current CU.

Instead of encoding, into the video bitstream, an actual motion vector of the current CU determined by the motion estimation unit 42 as described above in connection with FIG. 2A, the motion vector predictor of the current CU is subtracted from the actual motion vector of the current CU to produce a Motion Vector Difference (MVD) for the current CU. By doing so, there is no need to encode the motion vector determined by the motion estimation unit 42 for each CU of a frame into the video bitstream and the amount of data used for representing motion information in the video bitstream can be significantly decreased.

Like the process of choosing a predictive block in a reference frame during inter-frame prediction of a code block, a set of rules need to be adopted by both the video encoder 20 and the video decoder 30 for constructing a motion vector candidate list (also known as a “merge list”) for a current CU using those potential candidate motion vectors associated with spatially neighboring CUs and/or temporally co-located CUs of the current CU and then selecting one member from the motion vector candidate list as a motion vector predictor for the current CU. By doing so, there is no need to transmit the motion vector candidate list itself from the video encoder 20 to the video decoder 30 and an index of the selected motion vector predictor within the motion vector candidate list is sufficient for the video encoder 20 and the video decoder 30 to use the same motion vector predictor within the motion vector candidate list for encoding and decoding the current CU.

This disclosure is related to video coding and compression. More specifically, this disclosure relates to methods and apparatus on improving the coding efficiency of adaptive loop filter (ALF) and cross-component adaptive loop filter (CCALF).

Various video coding techniques may be used to compress video data. Video coding is performed according to one or more video coding standards. For example, nowadays, some well-known video coding standards include Versatile Video Coding (VVC), High Efficiency Video Coding (HEVC, also known as H.265 or MPEG-H Part2) and Advanced Video Coding (AVC, also known as H.264 or MPEG-4 Part 10), which are jointly developed by ISO/IEC MPEG and ITU-T VCEG. AOMedia Video 1 (AV1) was developed by Alliance for Open Media (AOM) as a successor to its preceding standard VP9. Audio Video Coding (AVS), which refers to digital audio and digital video compression standard, is another video compression standard series developed by the Audio and Video Coding Standard Workgroup of China. Most of the existing video coding standards are built upon the famous hybrid video coding framework i.e., using block-based prediction methods (e.g., inter-prediction, intra-prediction) to reduce redundancy present in video images or sequences and using transform coding to compact the energy of the prediction errors. An important goal of video coding techniques is to compress video data into a form that uses a lower bit rate while avoiding or minimizing degradations to video quality.

The first generation AVS standard includes Chinese national standard “Information Technology, Advanced Audio Video Coding, Part 2: Video” (known as AVS1) and “Information Technology, Advanced Audio Video Coding Part 16: Radio Television Video” (known as AVS+). It can offer around 50% bit-rate saving at the same perceptual quality compared to MPEG-2 standard. The AVS1 standard video part was promulgated as the Chinese national standard in February 2006. The second generation AVS standard includes the series of Chinese national standard “Information Technology, Efficient Multimedia Coding” (knows as AVS2), which is mainly targeted at the transmission of extra HD TV programs. The coding efficiency of the AVS2 is double of that of the AVS+. In May 2016, the AVS2 was issued as the Chinese national standard. Meanwhile, the AVS2 standard video part was submitted by Institute of Electrical and Electronics Engineers (IEEE) as one international standard for applications. The AVS3 standard is one new generation video coding standard for UHD video application aiming at surpassing the coding efficiency of the latest international standard HEVC. In March 2019, at the 68-th AVS meeting, the AVS3-P2 baseline was finished, which provides approximately 30% bit-rate savings over the HEVC standard. Currently, there is one reference software, called high performance model (HPM), is maintained by the AVS group to demonstrate a reference implementation of the AVS3 standard.

Like the HEVC, the AVS3 standard is built upon the block-based hybrid video coding framework. FIG. 2B gives the block diagram of a generic block-based hybrid video encoding system. The input video signal is processed block by block (called coding units (CUs)). Different from the HEVC which partitions blocks only based on quad-trees, in the AVS3, one coding tree unit (CTU) is split into CUs to adapt to varying local characteristics based on quad/binary/extended-quad-tree. Additionally, the concept of multiple partition unit type in the HEVC is removed, i.e., the separation of CU, prediction unit (PU) and transform unit (TU) does not exist in the AVS3; instead, each CU is always used as the basic unit for both prediction and transform without further partitions. In the tree partition structure of the AVS3, one CTU is firstly partitioned based on a quad-tree structure. Then, each quad-tree leaf node can be further partitioned based on a binary and extended-quad-tree structure. In FIG. 2B, spatial prediction and/or temporal prediction may be performed. Spatial prediction (or “intra prediction”) uses pixels from the samples of already coded neighboring blocks (which are called reference samples) in the same video picture/slice to predict the current video block. Spatial prediction reduces spatial redundancy inherent in the video signal. Temporal prediction (also referred to as “inter prediction” or “motion compensated prediction”) uses reconstructed pixels from the already coded video pictures to predict the current video block. Temporal prediction reduces temporal redundancy inherent in the video signal. Temporal prediction signal for a given CU is usually signaled by one or more motion vectors (MVs) which indicate the amount and the direction of motion between the current CU and its temporal reference. Also, if multiple reference pictures are supported, one reference picture index is additionally sent, which is used to identify from which reference picture in the reference picture store the temporal prediction signal comes. After spatial and/or temporal prediction, the mode decision block in the encoder chooses the best prediction mode, for example based on the rate-distortion optimization method. The prediction block is then subtracted from the current video block; and the prediction residual is de-correlated using transform and then quantized. The quantized residual coefficients are inverse quantized and inverse transformed to form the reconstructed residual, which is then added back to the prediction block to form the reconstructed signal of the CU. Further in-loop filtering, such as deblocking filter, sample adaptive offset (SAO) and adaptive in-loop filter (ALF) may be applied on the reconstructed CU before it is put in the reference picture store and used as reference to code future video blocks. To form the output video bit-stream, coding mode (inter or intra), prediction mode information, motion information, and quantized residual coefficients are all sent to the entropy coding unit to be further compressed and packed.

The first version of the HEVC standard was finalized in October 2013, which offers approximately 50% bit-rate saving or equivalent perceptual quality compared to the prior generation video coding standard H.264/MPEG AVC. Although the HEVC standard provides significant coding improvements than its predecessor, there is evidence that superior coding efficiency can be achieved with additional coding tools over HEVC. Based on that, both VCEG and MPEG started the exploration work of new coding technologies for future video coding standardization. One Joint Video Exploration Team (JVET) was formed in October 2015 by ITU-T VCEG and ISO/IEC MPEG to begin significant study of advanced technologies that could enable substantial enhancement of coding efficiency. One reference software called joint exploration model (JEM) was maintained by the JVET by integrating several additional coding tools on top of the HEVC test model (HM).

In October 2017, the joint call for proposals (CfP) on video compression with capability beyond HEVC was issued by ITU-T and ISO/IEC. In April 2018, 23 CfP responses were received and evaluated at the 10-th JVET meeting, which demonstrated compression efficiency gain over the HEVC around 40%. Based on such evaluation results, the JVET launched a new project to develop the new generation video coding standard that is named as Versatile Video Coding (VVC). In the same month, one reference software codebase, called VVC test model (VTM), was established for demonstrating a reference implementation of the VVC standard.

Like HEVC, the VVC is built upon the block-based hybrid video coding framework. FIG. 2B gives the block diagram of a generic block-based hybrid video encoding system. The input video signal is processed block by block (called coding units (CUs)). In VTM-1.0, a CU can be up to 128×128 pixels. However, different from the HEVC which partitions blocks only based on quad-trees, in the VVC, one coding tree unit (CTU) is split into CUs to adapt to varying local characteristics based on quad/binary/ternary-tree. Additionally, the concept of multiple partition unit type in the HEVC is removed, i.e., the separation of CU, prediction unit (PU) and transform unit (TU) does not exist in the VVC anymore; instead, each CU is always used as the basic unit for both prediction and transform without further partitions. In the multi-type tree structure, one CTU is firstly partitioned by a quad-tree structure. Then, each quad-tree leaf node can be further partitioned by a binary and ternary tree structure. As shown in FIG. 4E, there are five splitting types, quaternary partitioning, horizontal binary partitioning, vertical binary partitioning, horizontal ternary partitioning, and vertical ternary partitioning. In FIG. 2B, spatial prediction and/or temporal prediction may be performed. Spatial prediction (or “intra prediction”) uses pixels from the samples of already coded neighboring blocks (which are called reference samples) in the same video picture/slice to predict the current video block. Spatial prediction reduces spatial redundancy inherent in the video signal. Temporal prediction (also referred to as “inter prediction” or “motion compensated prediction”) uses reconstructed pixels from the already coded video pictures to predict the current video block. Temporal prediction reduces temporal redundancy inherent in the video signal. Temporal prediction signal for a given CU is usually signaled by one or more motion vectors (MVs) which indicate the amount and the direction of motion between the current CU and its temporal reference. Also, if multiple reference pictures are supported, one reference picture index is additionally sent, which is used to identify from which reference picture in the reference picture store the temporal prediction signal comes. After spatial and/or temporal prediction, the mode decision block in the encoder chooses the best prediction mode, for example based on the rate-distortion optimization method. The prediction block is then subtracted from the current video block; and the prediction residual is de-correlated using transform and quantized. The quantized residual coefficients are inverse quantized and inverse transformed to form the reconstructed residual, which is then added back to the prediction block to form the reconstructed signal of the CU. Further in-loop filtering, such as deblocking filter, sample adaptive offset (SAO) and adaptive in-loop filter (ALF) may be applied on the reconstructed CU before it is put in the reference picture store and used to code future video blocks. To form the output video bit-stream, coding mode (inter or intra), prediction mode information, motion information, and quantized residual coefficients are all sent to the entropy coding unit to be further compressed and packed to form the bit-stream.

FIG. 3B gives a general block diagram of a block-based video decoder. The video bit-stream is first entropy decoded at entropy decoding unit. The coding mode and prediction information are sent to either the spatial prediction unit (if intra coded) or the temporal prediction unit (if inter coded) to form the prediction block. The residual transform coefficients are sent to inverse quantization unit and inverse transform unit to reconstruct the residual block. The prediction block and the residual block are then added together. The reconstructed block may further go through in-loop filtering before it is stored in reference picture store. The reconstructed video in reference picture store is then sent out to drive a display device, as well as used to predict future video blocks.

The main focus of the disclosure is to improve the adaptive loop filter (ALF) and cross-component adaptive loop filter (CCALF). The related knowledge is elaborated in the following sections.

Although ALF has been improved in ECM, there is room to further improve its performance. First, an online ALF filter in ECM takes spatial neighboring pixels, fixed ALF filter results and spatial neighboring pixels before deblocking filter as input. Other information such as spatial neighboring pixels in prediction signal, spatial neighboring pixels in residual signal, or spatial neighboring pixels before SAO can also be used as an input to the online ALF filter equation, which may benefit the coding performance.

Second, edge based classifiers and band based classifiers are used adaptively for the online ALF filter in ECM. However, these two classifiers may be further combined to provide other classifiers, which may benefit the coding performance.

Third, the filter shape for the chroma ALF is a diamond filter shape in ECM, while the filter shape for luma ALF is long cross shape, such non-unified design may not be optimal from standardization point of view.

Fourth, the edge based classifier and the band based classifier in the ECM only consider the pixel values after SAO. However, after the pixel values before the deblocking filter, prediction signal, residual signal, or before SAO are saved as inputs to the online ALF filter equation, these pixel values can also be utilized to design new classifiers, which may benefit the coding performance.

Fifth, the edge based classifier and band based classifier in ECM only considers luma pixel values after SAO. However, the chroma pixel values can also be utilized to design a new classifier, which may benefit the coding performance.

To improve the quality of reconstructed video frames, the video coding process can include sample adaptive offset (SAO) and adaptive loop filtering (ALF) processes. These techniques aim to reduce artifacts and enhance visual quality of the decoded video. Addition information from neighboring pixels can be extracted and used by the encoder and decoder to improve the ALF process. For example, information in the prediction signal, residual signal, or before a sample adaptive offset (SAO) process can be used as additional ALF inputs. This spatial information can therefore be useful for determining how to filter or adjust pixel values during the decoding and encoding process to generate better video quality.

The methods disclosed herein include: computing spatial neighboring pixels in a prediction signal, residual signal, or spatial neighboring pixels before sample adaptive offset (SAO); using classifiers which combine the features of the edge based classifier and band based classifier as additional classifiers for the online ALF filter; changing the filter shape from chroma ALF from diamond shape to long cross shape to unify with the filter shape from the luma ALF; computing classifiers which utilize pixel values before a deblocking filter, prediction signal, residual signal, or before the SAO, as additional classifiers for an online ALF process; and computing classifiers which utilize chroma pixel values as additional classifiers for online ALF filters

### Information in Prediction, Residual or Before SAO Used as Additional ALF Input

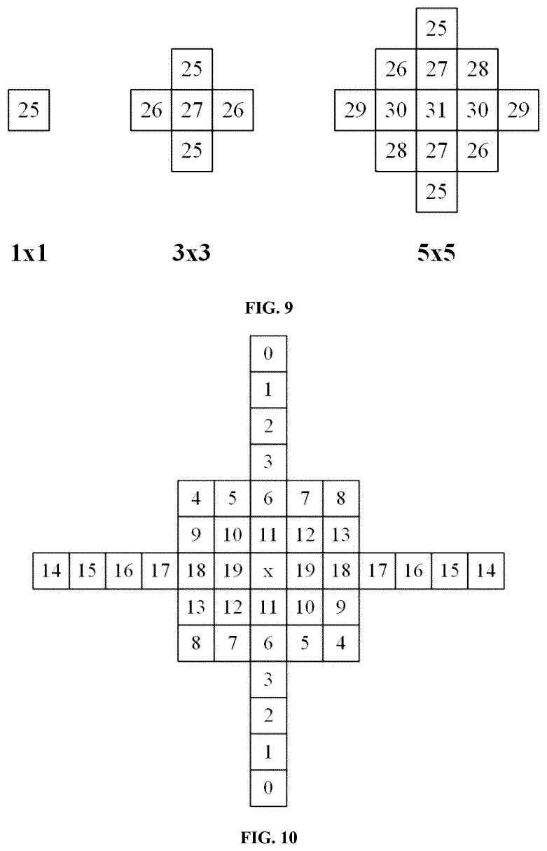

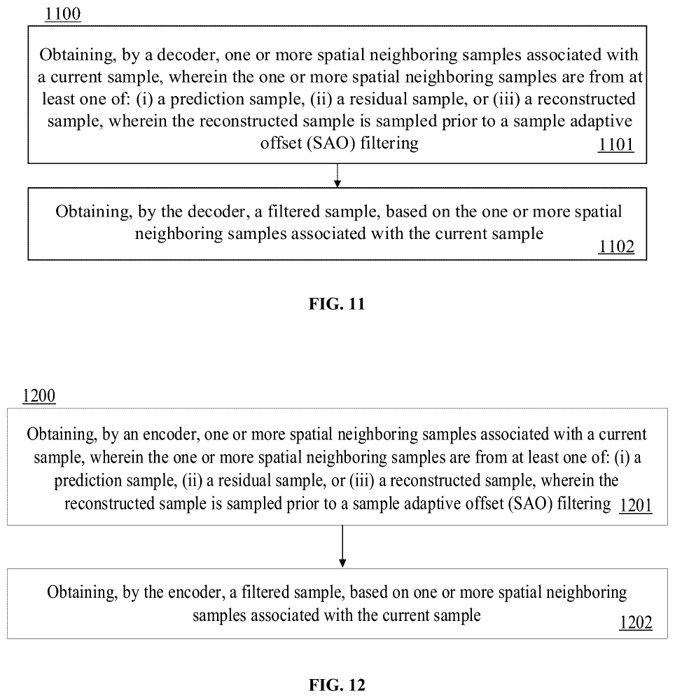

FIG. 11 is a flowchart illustrating a method 1100 for video decoding in accordance with some examples of the present disclosure. The method includes obtaining, by the decoder, one or more spatial neighboring samples associated with a current sample, wherein the one or more spatial neighboring samples are from at least one of: (i) a prediction sample, (ii) a residual sample, or (iii) a reconstructed sample, and wherein the reconstructed sample is sampled prior to the SAO filtering, and obtaining, by the decoder, a filtered sample, based on the one or more spatial neighboring samples associated with the current sample. Various filter shapes may be used to extract the information in residual signal. For example, the filter shape can be 1×1, 3×3 or 5×5 as shown in FIG. 9. Various equation forms may be used to extract the information in residual signal. In one example, the clipping results of the collocated pixel in residual signal are used as ALF equation input.

At step 1101, the method 1100 includes obtaining, by the decoder, one or more spatial neighboring samples associated with a current sample, wherein the one or more spatial neighboring samples are from at least one of: (i) a prediction sample, (ii) a residual sample, or (iii) a reconstructed sample, and wherein the reconstructed sample is sampled prior to the SAO filtering.

At step 1102, the method 1100 includes obtaining, by the decoder, a filtered sample, based on the one or more spatial neighboring samples associated with the current sample.

In one example, the method 1100 further includes obtaining, by the decoder, clipped results based on one or more spatial neighboring samples from the residual sample associated with the current sample, and obtaining, by the decoder, the filtered sample using clipped results based on one or more spatial neighboring samples from the residual sample associated with the current sample and one or more filter coefficients, the one or more filter coefficients associated with different filter shapes. The clipped results can comprise clipped results of one or more surrounding sample, wherein the one or more surrounding samples are from one or more spatial neighboring samples from the residual samples.

In another example, the decoder uses spatial neighboring pixels in the prediction signal as an additional ALF equation input. Various filter shapes can be used to extract the information in prediction signal (e.g., the filter shape can be 1×1, 3×3 or 5×5 as shown in FIG. 9). Various equation forms can be used to extract the information in prediction signal. For example, clipping differences between the surrounding pixels in prediction signal and current pixel can be used as an input to the ALF equation. In another example, clipping differences between the surrounding pixels in the prediction signal and the collocated pixel in the prediction signal, and the clipping difference between the collocated pixel in prediction signal and current pixel can be used as inputs to the ALF equation.

In another example, the decoder uses spatial neighboring pixels before the SAO signal as an additional input to the ALF equation. Various filter shapes can be used to extract the information in before SAO signal (e.g., the filter shape can be 1×1, 3×3 or 5×5 as shown in FIG. 9). Various equation forms can be used to extract the information in before SAO signal. For example, the clipping differences between the surrounding pixels before the SAO signal and the current pixel can be used as inputs to the ALF equation. In another example, the clipping differences between the surrounding pixels before the SAO signal and the collocated pixels before SAO signal and the clipping difference between the collocated pixels before SAO signal and current pixels can be used as an input to the ALF equation.

In yet another example, the decoder is configured to use information in the prediction signal, residual signal or before the SAO signal as an input to the ALF equation. Any of the aforementioned methods proposed herein can be combined to generate the input.

FIG. 12 is a flowchart illustrating a method 1200 for video encoding in accordance with some examples of the present disclosure. The method includes obtaining, by the encoder one or more spatial neighboring samples associated with a current sample, wherein the one or more spatial neighboring samples are from at least one of: (i) a prediction sample, (ii) a residual sample, or (iii) a reconstructed sample, and wherein the reconstructed sample is sampled prior to the SAO filtering, and obtaining, by the encoder, a filtered sample, based on the one or more spatial neighboring samples associated with the current sample.

At step 1201, the method 1200 includes obtaining, by the encoder, one or more spatial neighboring samples associated with a current sample, wherein the one or more spatial neighboring samples are from at least one of: (i) a prediction sample, (ii) a residual sample, or (iii) a reconstructed sample, and wherein the reconstructed sample is sampled prior to the SAO filtering.

At step 1202, the method 1200 includes obtaining, by the encoder, a filtered sample, based on the one or more spatial neighboring samples associated with the current sample.

In one example, the method 1200 includes obtaining, by the encoder, clipped results based on one or more spatial neighboring samples from the residual sample associated with the current sample, and obtaining by the encoder, the filtered sample using clipped results based on one or more spatial neighboring samples from the residual sample associated with the current sample and one or more filter coefficients, the one or more filter coefficients associated with different filter shapes. The clipped results can comprise clipped results of one or more surrounding samples, wherein the one or more surrounding samples are from one or more spatial neighboring samples from the residual sample.

### New Classifiers Combining the Features of Edge-Based Classifier and Band-Based Classifier

In one example, the features of edge based classifier and band based classifier are combined to derive new classifiers for online ALF filter. Different methods may be used to achieve this goal.

For example, the decoder (and/or alternatively the encoder) can first compute the directionality D of the sub-block of luma component, then the sum of sample values of the sub-block is calculated and it is mapped to the index referring to the band based classifier, and the class index for the sub-block is calculated as:

$$C = B * {M}_{D} + D$$

where B is the index calculated referring to the band based classifier, M_{D} represents the total number of directionalities D. In one example, for the 2×2 luma block, the directionality D is calculated the same to D₂ in ECM, and B is calculated as:

$$B = ( sum * 5 ) ≫ ( sample bit depth + 2 )$$

For example, the decoder (and/or alternatively the encoder) can first compute the activity value A of the sub-block of luma component, then the sum of sample values of the sub-block is calculated and it is mapped to the index referring to the band based classifier, and the class index for the sub-block is calculated as:

$$C = B * {M}_{A} + A$$

where B is the index calculated referring to the band based classifier, M_{A} represents the total number of the activity value A. In one example, for the 2×2 luma block, the activity value A is calculated the same to Â₂ in ECM, and B is calculated as:

$$B = ( sum * 5 ) ≫ ( sample bit depth + 2 )$$

For example, the decoder (and/or alternatively the encoder) can first compute the index of the sub-block of luma component referring to the edge based classifier, then the sum of sample values of the sub-block is calculated and it is mapped to the index referring to the band based classifier, and the class index for the sub-block is calculated as:

$$C = B * {M}_{E} + E$$

where B is the index calculated referring to the band based classifier, M_{E} represents the total number of the index calculated referring to the edge based classifier, E is the index calculated referring to the edge based classifier. In one example, for the 2×2 luma block, the index E is calculated the same to C₂ in ECM, and B is calculated as:

$$B = ( sum * 2 ) ≫ ( sample bit depth + 2 )$$

Adjust the Chroma ALF Filter Shape to Unify with Luma ALF Filter Shape

In one example, the chroma ALF filter shape can be changed from diamond shape to long cross shape, which is unified with the luma ALF filter shape. Examples of the ALF filter shapes can be found in FIG. 10.

### New Classifiers Utilizing the Pixel Values Before Deblocking Filter

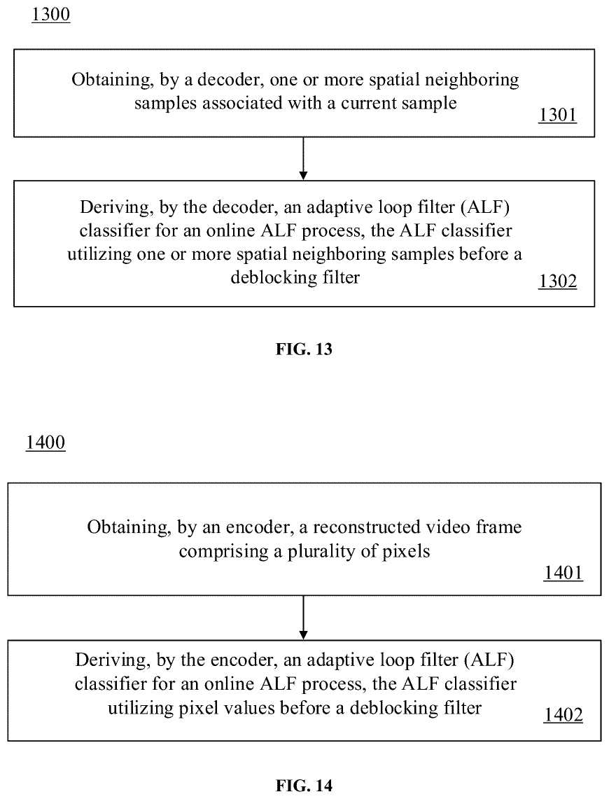

FIG. 13 is a flowchart illustrating a method 1300 for video decoding in accordance with some examples of the present disclosure. The method 1300 includes obtaining, by a decoder, one or more spatial neighboring samples associated with a current sample, and deriving, by the decoder, the ALF classifier for an online ALF process, the ALF classifier utilizing one or more spatial neighboring samples before a deblocking filter.

At step 1301, the method 1300 includes obtaining, by a decoder, one or more spatial neighboring samples associated with a current sample.

At step 1302, the method 1300 includes deriving, by the decoder, the ALF classifier for an online ALF process, the ALF classifier utilizing one or more spatial neighboring samples before a deblocking filter.

In one example, the method 1300 further includes obtaining, by the decoder, a first feature by computing directionality of the sub-block of the luma component, obtaining, by the decoder, a second feature by calculating a sum of differences values between a sample after the SAO process and a collocated sample before a deblocking filter of the sub-block, mapping, by the decoder, the sum to a difference index, and deriving, by the decoder, a combined classifier for the online ALF process based on the first feature and the second feature.

For example, the decoder can first compute the directionality D of the sub-block of luma component, then the sum of difference values between samples after SAO and collocated samples before the deblocking filter of the sub-block. The sum of difference values is then mapped to the difference index. The class index for the sub-block is calculated as

$$C = Dif * {M}_{D} + D$$

where Dif is the difference index, M_{D} represents the total number of directionalities D. In one example, for the 2×2 luma block, the directionality D is calculated the same to D₂ in ECM, and Dif is calculated as

$$Dif = {sum}_{Dif} > 0 ? 2 : ( {sum}_{Dif} < 0 ? 0 : 1 )$$

In one example, the method 1300 further includes obtaining, by the decoder, a first feature by computing an activity value of a sub-block of a luma component, obtaining, by the decoder, a second feature by calculating a sum of difference values between a sample after the SAO process and a collocated sample before a deblocking filter of the sub-block, mapping, by the decoder, the sum to a difference index, and deriving, by the decoder, a combined classifier for the online ALF process based on the first feature and the second feature.

For example, the decoder can first compute the activity value A of the sub-block of luma component. Upon computing the activity value A, the decoder can calculate the sum of difference values between samples after SAO and collocated samples before the deblocking filter of the sub. The sum of difference values is then mapped to the difference index. The class index for the sub-block is calculated as

$$C = Dif * {M}_{A} + A$$

where Dif is the difference index, M_{A} represents the total number of the activity value A. In one example, for the 2×2 luma block, the activity value A is calculated the same to Â₂ in ECM, and Dif is calculated as in equation:

$$Dif = {sum}_{Dif} > 0 ? 2 : ( {sum}_{Dif} < 0 ? 0 : 1 )$$

In one example, the method 1300 further includes obtaining, by the decoder, a first feature by computing an ALF edge based classifier index of a sub-block of a luma component, obtaining, by the decoder, a second feature by calculating a sum of difference values between a sample after the SAO process and a collocated sample before a deblocking filter of the sub-block, mapping, by the decoder, the sum to a difference index, and deriving, by the decoder, a combined classifier for the online ALF process based on the first feature and the second feature.

For example, the decoder can first compute the index of the sub-block of luma component referring to the edge-based classifier, then the sum of difference values between samples after SAO and collocated samples before the deblocking filter. The sum of the difference values are then mapped to the difference index. The class index for the sub-block is calculated as

$$C = Dif * {M}_{E} + E$$

where Dif is the difference index, M_{E} represents the total number of the index calculated referring to the edge based classifier, E is the index calculated referring to the edge based classifier. In one example, for the 2×2 luma block, the index E is calculated the same to C₂ in ECM, and Dif is calculated as:

$$Dif = {sum}_{Dif} > 0 ? 2 : ( {sum}_{Dif} < 0 ? 0 : 1 )$$

In one example, the method 1300 further includes obtaining, by the decoder, a first feature based on a band index of a sub-block of a luma component, obtaining, by the decoder, a second feature by calculating a sum of difference values between a sample after the SAO process and a collocated sample before a deblocking filter, mapping, by the decoder, the sum to a difference index, and deriving, by the decoder, a combined classifier for the online ALF process based on the first feature and the second feature.

For example, the decoder can first compute the band index B of the sub-block of luma component, then the sum of difference values between samples after SAO and collocated samples before deblocking filter of the sub-block. The difference values are then mapped to the difference index. The class index for the sub-block is calculated as:

$$C = Dif * {M}_{B} + B$$

where Dif is the difference index, M_{B} represents the total number of the band value. In one example, for the 2×2 luma block, the band index B is calculated as:

$$B = ( sum * 8 ) ≫ ( sample bit depth + 2 )$$

and Dif is calculated as:

$$Dif = {sum}_{Dif} > 0 ? 2 : ( {sum}_{Dif} < 0 ? 0 : 1 )$$

In one example, the method 1300 further includes obtaining, by the decoder, a first feature by calculating a sum of difference values between a sample after the SAO process and a collocated sample before a deblocking filter, mapping, by the decoder, the sum to a difference index, and deriving, by the decoder, a new classifier for the online ALF process based on the first feature.

For example, the decoder can compute the sum of difference values between samples after SAO and collocated samples before the deblocking filter of the sub-block. The sum of difference values is then mapped to the difference index and the difference index is used as the class index.

In one example, the method 1300 further includes deriving, by the decoder, a new classifier for the online ALF process by computing an ALF edge based classifier index based on the samples before a deblocking filter. The method 1300 can further include deriving, by the decoder, a new classifier for the online ALF process by computing a band index based on the samples before a deblocking filter.

For example, the decoder can calculate the edged based classifier or band based classifier based on the sample values in before deblocking filter, where the calculation method is the same calculation method as the original edge based classifier or band based classifier (which is calculated based on the sample values after SAO).

It should be noted that the aforementioned examples can alternatively be performed by the encoder. Examples of the aforementioned methods performed by the encoder are explained in further detail in FIG. 14.

FIG. 14 is a flowchart illustrating a method 1400 for video encoding in accordance with some examples of the present disclosure. The method 1400 includes obtaining, by the encoder, a reconstructed video frame comprising a plurality of pixels, and deriving, by the encoder, the ALF classifier for the online ALF process, the ALF classifier utilizing pixel values before a deblocking filter.

At step 1401, the method includes obtaining, by the encoder, a reconstructed video frame comprising a plurality of pixels. At step 1402, the method includes deriving, by the encoder, the ALF classifier for the online ALF process, the ALF classifier utilizing pixel values before a deblocking filter.

In one example, the method 1400 includes obtaining, by the encoder, a first feature by computing a directionality of the sub-block of the luma component, obtaining, by the encoder, a second feature by calculating a sum of difference values between a sample after the SAO process and a collocated sample before a deblocking filter of the sub-block, mapping, by the encoder, the sum to a difference index, and deriving, by the encoder, a combined classifier for the online ALF process based on the first feature and the second feature.

In one example, the method 1400 further includes obtaining, by the encoder, a first feature by computing an activity value of a sub-block of the luma component, obtaining, by the encoder, a second feature by calculating a sum of difference values between a sample after the SAO process and a collocated sample before a deblocking filter of the sub-block, mapping, by the encoder, the sum to a difference index, and deriving, by the encoder, a combined classifier for the online ALF process based on the first feature and the second feature.

In one example, the method 1400 further includes obtaining, by the encoder, the first feature by computing an ALF edge based classifier index of the sub-block of a luma component, obtaining, by the encoder, a second feature by calculating a sum of difference values between a sample after the SAO process and a collocated sample before a deblocking filter of the sub-block, mapping, by the encoder, the sum to a difference index, and deriving, by the encoder, a combined classifier for the online ALF process based on the first feature and the second feature.

In one example, the method 1400 further includes obtaining, by the encoder, a first feature based on a band index of a sub-block of a luma component, obtaining, by the encoder, a second feature by calculating a sum of difference values between a sample after the SAO process and a collocated sample before a deblocking filter, mapping, by the encoder, the sum to a difference index, and deriving, by the encoder, a combined classifier for the online ALF process based on the first feature and the second feature.

In one example, the method 1400 further includes obtaining, by the encoder, a first feature by calculating a sum of difference values between a sample after the SAO process and a collocated sample before a deblocking filter, mapping, by the encoder, the sum to a difference index, and deriving, by the encoder, a new classifier for the online ALF process based on the first feature.

In one example, the method 1400 further includes deriving, by the encoder, a new classifier for the online ALF process by computing an ALF edge based classifier index based on the samples before a deblocking filter. The method 1400 can further include deriving, by the encoder, a new classifier for the online ALF process by computing a band index based on the samples before a deblocking filter.

### New Classifiers Utilizing the Pixel Values in the Prediction Signal

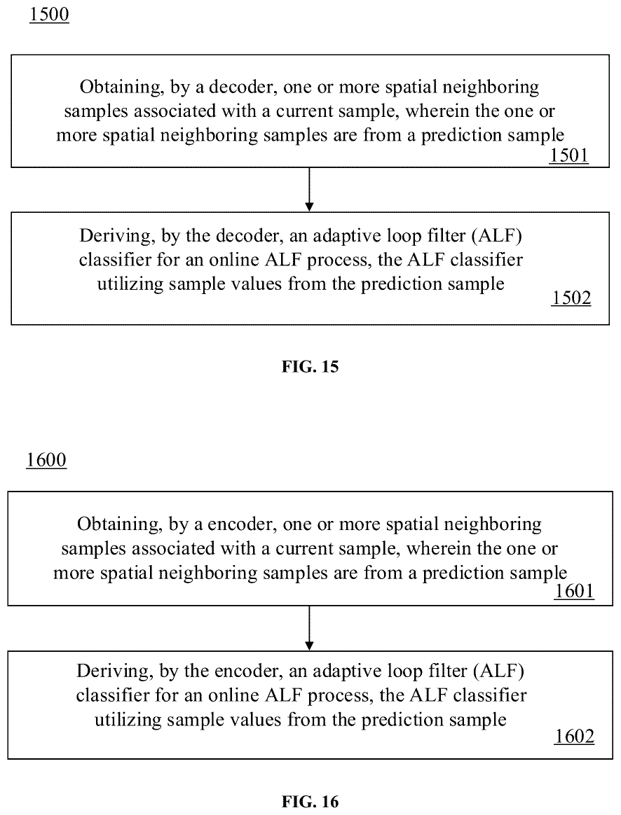

FIG. 15 is a flowchart illustrating a method 1500 for video decoding in accordance with some examples of the present disclosure. The method 1500 includes obtaining, by the decoder, one or more spatial neighboring samples associated with a current sample, wherein the one or more spatial neighboring sample are from a prediction sample, and deriving, by the decoder, the ALF classifier for an online ALF process, the ALF classifier utilizing sample values from the prediction sample.

At step 1501, the method 1500 include obtaining, by the decoder, one or more spatial neighboring samples associated with a current sample, wherein the one or more spatial neighboring sample are from a prediction sample.

At step 1502, the method 1500 includes deriving, by the decoder, the ALF classifier for an online ALF process, the ALF classifier utilizing sample values from the prediction sample.

In one example, the method 1500 includes obtaining, by the decoder, a first feature by computing directionality of a sub-block of a luma component, obtaining, by the decoder, a second feature by calculating a sum of difference between a sample after a sample adaptive offset (SAO) process and a collocated sample in the prediction sample, mapping, by the decoder, the sum of difference values to a difference index, and deriving, by the decoder, a combined classifier for the online ALF process based on the first feature and the second feature.

For example, the decoder can first compute the directionality D of the sub-block of luma component. Upon computing the directionality D, the decoder can then compute the sum of the difference values between samples after SAO and collocated samples in prediction signals of the sub-block. The difference values can then be mapped to the difference index. The class index for the sub-block is calculated as:

$$C = Dif * {M}_{D} + D$$

where Dif is the difference index, M_{D} represents the total number of directionalities D. In one example, for the 2×2 luma block, the directionality D is calculated the same to D₂ in ECM, and Dif is calculated as:

$$Dif = {sum}_{Dif} > 0 ? 2 : ( {sum}_{Dif} < 0 ? 0 : 1 )$$

In one example, the method 1500 includes obtaining, by the decoder, a first feature by computing an activity value of a sub-block of a luma component, obtaining, by the decoder, a second feature by calculating a sum of difference values between a sample after a sample adaptive offset (SAO) process and a collocated sample in the prediction sample, mapping, by the decoder, the sum of difference values to a difference index, and deriving, by the decoder, a combined classifier for the online ALF process based on the first feature and the second feature.

For example, the decoder can first compute the activity value A of the sub-block of luma component, then the sum of difference values between samples after SAO and collocated samples in the prediction signal of the sub-block. The sum of difference values can then be mapped to the difference index. The class index for the sub-block is calculated as:

$$C = Dif * {M}_{A} + A$$

where Dif is the difference index, M_{A} represents the total number of the activity value A. In one example, for the 2×2 luma block, the activity value A is calculated the same to Â₂ in ECM, and Dif is calculated as:

$$Dif = {sum}_{Dif} > 0 ? 2 : ( {sum}_{Dif} < 0 ? 0 : 1 )$$

In one example, the method 1500 include obtaining, by the decoder, a first feature by computing an ALF edge based classifier index of a sub-block of a luma component, calculating, by the decoder, a second feature by calculating a sum of difference values between a sample after the SAO process and a collocated sample in the prediction sample, mapping, by the decoder, the sum of difference values to a difference index, and deriving, by the decoder, a combined classifier for the online ALF process based on the first feature and the second feature.

For example, the decoder can first compute the index of the sub-block of luma component referring to the edge based classifier, then the sum of difference values between samples after SAO and collocated samples in prediction signals of the sub-block. The sum of the difference values are then mapped to the difference index. The class index for the sub-block is calculated as

$$C = Dif * {M}_{E} + E$$

where Dif is the difference index, M_{E} represents the total number of the index calculated referring to the edge based classifier, E is the index calculated referring to the edge based classifier. In one example, for the 2×2 luma block, the index E is calculated the same to C₂ in ECM, and Dif is calculated as:

$$Dif = {sum}_{Dif} > 0 ? 2 : ( {sum}_{Dif} < 0 ? 0 : 1 )$$

In one example, the method 1500 includes obtaining, by the decoder, a first feature by computing a band index of a sub-block of a luma component, calculating, by the decoder, a second feature by calculating a sum of difference values between a sample after the SAO process and a collocated sample in the prediction sample of the sub-block, mapping, by the decoder, the sum of difference values to a difference index, and deriving, by the decoder, a combined classifier for the online ALF process based on the first feature and the second feature.

For example, the decoder can compute the band index B of the sub-block of luma component, then the sum of difference values between samples after SAO and collocated samples in the prediction signal of the sub-block. The sum of difference values are then mapped to the difference index. The class index for the sub-block is calculated as:

$$C = Dif * {M}_{B} + B$$

where Dif is the difference index, M_{B} represents the total number of the band value. In one example, for the 2×2 luma block, the band index B is calculated as:

$$B = ( sum * 8 ) ≫ ( sample bit depth + 2 )$$

and Dif is calculated as:

$$Dif = {sum}_{Dif} > 0 ? 2 : ( {sum}_{Dif} < 0 ? 0 : 1 )$$

In one example, the method 1500 includes obtaining, by the decoder, a first feature by calculating a sum of difference values between a sample after the SAO process and a collocated sample in the prediction sample of the sub-block, mapping, by the decoder, the sum of difference values to a difference index, and deriving, by the decoder, a new classifier for the online ALF process based on the first feature.

For example, the decoder can compute the sum of difference values between samples after SAO and collocated samples in the prediction signal of the sub-block. Upon computing the sum of the difference values, the decoder can then map the sum of the difference values to the difference index. The difference index can then be used as the class index.

In one example, the method 1500 includes deriving, by the decoder, a new classifier for the online ALF process by computing an ALF edge based classifier index based on the samples from the prediction sample. In another example, the method 1500 includes deriving, by the decoder, a new classifier for the online ALF process by computing a band index based on the samples from the prediction sample.

For example, the decoder can calculate the edged based classifier or band based classifier based on the sample values in prediction signal. The calculation can be the same as the edge based classifier or band based classifier (calculated based on the sample values after SAO).

It should be noted that the aforementioned examples can alternatively be performed by the encoder. Examples of the aforementioned methods performed by the encoder are explained in further detail in FIG. 16.

FIG. 16 is a flowchart illustrating a method 1600 for video encoding in accordance with some examples of the present disclosure. The method 1600 includes obtaining, by the encoder, one or more spatial neighboring samples associated with a current sample, wherein the one or more spatial neighboring sample are from a prediction sample, and deriving, by the encoder, the ALF classifier for an online ALF process, the ALF classifier utilizing sample values from the prediction sample.

At step 1601, the method 1600 include obtaining, by the encoder, one or more spatial neighboring samples associated with a current sample, wherein the one or more spatial neighboring sample are from a prediction sample.

At step 1602, the method 1600 includes deriving, by the encoder, the ALF classifier for an online ALF process, the ALF classifier utilizing sample values from the prediction sample.

In one example, the method 1600 includes obtaining, by the encoder, a first feature by computing directionality of the sub-block of the luma component, obtaining, by the encoder, a second feature by calculating a sum of difference between a sample after the SAO process and a collocated sample in the prediction sample, mapping, by the encoder, the sum of difference values to a difference index, and deriving, by the encoder, a combined classifier for the online ALF process based on the first feature and the second feature.

In one example, the method 1600 includes obtaining, by the encoder, a first feature by computing an activity value of a sub-block of a luma component, obtaining, by the encoder, a second feature by calculating a sum of difference values between a sample after the SAO process and a collocated sample in the prediction sample, mapping, by the encoder, the sum of difference values to a difference index, and deriving, by the encoder, a combined classifier for the online ALF process based on the first feature and the second feature.

In one example, the method 1600 include obtaining, by the encoder, a first feature by computing an ALF edge based classifier index of a sub-block of a luma component, calculating, by the encoder, a second feature by calculating a sum of difference values between a sample after the SAO process and a collocated sample in the prediction sample, mapping, by the encoder, the sum of difference values to a difference index, and deriving, by the encoder, a combined classifier for the online ALF process based on the first feature and the second feature.

In one example, the method 1600 includes obtaining, by the encoder, a first feature by computing a band index of a sub-block of a luma component, calculating, by the encoder, a second feature by calculating a sum of difference values between a sample after the SAO process and a collocated sample in the prediction sample of the sub-block, mapping, by the encoder, the sum of difference values to a difference index, and deriving, by the encoder, a combined classifier for the online ALF process based on the first feature and the second feature.

In one example, the method 1600 includes obtaining, by the encoder, a first feature by calculating a sum of difference values between a sample after the SAO process and a collocated sample in the prediction sample of the sub-block, mapping, by the encoder, the sum of difference values to a difference index, and deriving, by the encoder, a new classifier for the online ALF process based on the first feature.

In one example, the method 1600 includes deriving, by the encoder, a new classifier for the online ALF process by computing an ALF edge based classifier index based on the samples from the prediction sample. In another example, the method 1600 includes deriving, by the encoder, a new classifier for the online ALF process by computing a band index based on the samples from the prediction sample.

### New Classifiers Utilizing the Pixel Values in the Residual Signal

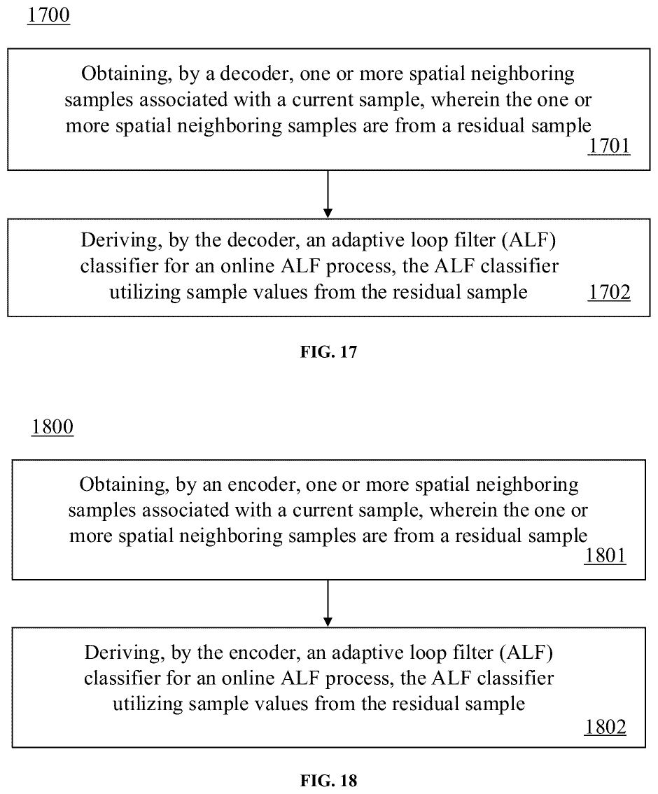

FIG. 17 is a flowchart illustrating a method 1700 for video decoding in accordance with some examples of the present disclosure. The method 1700 includes obtaining, by the decoder, one or more spatial neighboring samples associated with a current sample, wherein the one or more spatial neighboring samples are from a residual sample, and deriving, by the decoder, the ALF classifier for the online ALF process, the ALF classifier utilizing sample values from the residual sample.

At step 1701, the method 1700 includes obtaining, by the decoder, one or more spatial neighboring samples associated with a current sample, wherein the one or more spatial neighboring samples are from a residual sample.

At step 1702, the method 1700 includes deriving, by the decoder, the ALF classifier for the online ALF process, the ALF classifier utilizing sample values from the residual sample.

In one example, the method 1700 includes obtaining, by the decoder, a first feature by computing directionality of the sub-block of the luma component, obtaining, by the decoder, a second feature by calculating a sum of sample values in the residual sample, mapping, by the decoder, the sum of sample values to a residual index, and deriving, by the decoder, a combined classifier for the online ALF process based on the first feature and the second feature.

For example, the decoder can first compute the directionality D of the sub-block of luma component. Upon computing the directionality D, the sub-block can then compute the sum of pixel values in the residual signal of the sub-block. The sum is then mapped to the residual index. The class index for the sub-block is calculated as:

$$C = Resi * {M}_{D} + D$$

where Resi is the residual index, M_{D} represents the total number of directionalities D. In one example, for the 2×2 luma block, the directionality D is calculated the same to D₂ in ECM, and Resi is calculated as

$$Resi = {sum}_{Resi} > 0 ? 2 : ( {sum}_{Resi} < 0 ? 0 : 1 )$$

In one example, the method 1700 includes obtaining, by the decoder, a first feature by computing an activity value of the sub-block of the luma component, obtaining, by the decoder, a second feature by calculating a sum of sample values in the residual sample, mapping, by the decoder, the sum of sample values to a residual index, and deriving, by the decoder, a combined classifier for the online ALF process based on the first feature and the second feature.

For example, the decoder can first compute the activity value A of the sub-block of luma component, then the sum of pixel values in the residual signal of the sub-block. The sum of the pixel values can then be mapped to the residual index. The class index for the sub-block is calculated as:

$$C = Resi * {M}_{A} + A$$

where Resi is the residual index, M_{A} represents the total number of the activity value A. In one example, for the 2×2 luma block, the activity value A is calculated the same to Â₂ in ECM, and Resi is calculated as:

$$Resi = {sum}_{Resi} > 0 ? 2 : ( {sum}_{Resi} < 0 ? 0 : 1 )$$

In one example, the method 1700 includes obtaining, by the decoder, a first feature by computing an ALF edge based classifier index of a sub-block of a luma component, calculating, by the decoder, a second feature by calculating a sum of sample values in the residual sample, mapping, by the decoder, the sum of sample values to a residual index, and deriving, by the decoder, a combined classifier for the online ALF process based on the first feature and the second feature.

For example, the decoder can first compute the index of the sub-block of luma component referring to the edge based classifier. Upon computing the index of the sub-block of luma component referring to the edge based classifier, the decoder can then calculate the sum of the pixel values in the residual signal of the sub-block. The sum of the pixel values in the residual signal can then be mapped to the residual index. The class index for the sub-block is calculated as:

$$C = Resi * {M}_{E} + E$$

where Resi is the residual index, M_{E} represents the total number of the index calculated referring to the edge based classifier, E is the index calculated referring to the edge based classifier. In one example, for the 2×2 luma block, the index E is calculated the same to C₂ in ECM, and Resi is calculated as:

$$Resi = {sum}_{Resi} > 0 ? 2 : ( {sum}_{Resi} < 0 ? 0 : 1 )$$

In one example, the method 1700 includes obtaining, by the decoder, a first feature by computing a band index of a sub-block of a luma component, calculating, by the decoder, a second feature by calculating a sum of sample values in the residual sample, mapping, by the decoder, the sum of sample values to a residual index, and deriving, by the decoder, a combined classifier for the online ALF process based on the first feature and the second feature.

For example, the decoder can first compute the band index B of the sub-block of luma component. Upon computing the B of the sub-block of luma component, the decoder can then sum the pixel values in the residual signal of the sub-block. The sum of the pixel values in the residual signal are then mapped to the residual index. The class index for the sub-block is calculated as:

$$C = Resi * {M}_{B} + B$$

where Resi is the residual index, M_{B} represents the total number of the band value. In one example, for the 2×2 luma block, the band index B is calculated as:

$$B = ( sum * 8 ) ≫ ( sample bit depth + 2 )$$

and Resi is calculated as:

$$Resi = {sum}_{Resi} > 0 ? 2 : ( {sum}_{Resi} < 0 ? 0 : 1 )$$

In one example, the method 1700 includes the residual index used as a class index. For example, the decoder can compute the sum of the pixel values in the residual signal of the sub-block and then map the sum of the residual values to the residual index. The residual index can then be used as the class index.

It should be noted that the aforementioned examples can alternatively be performed by the encoder. Examples of the aforementioned methods performed by the encoder are explained in further detail in FIG. 18.

FIG. 18 is a flowchart illustrating a method 1800 for video encoding in accordance with some examples of the present disclosure. The method 1800 includes obtaining, by the encoder, one or more spatial neighboring samples associated with a current sample, wherein the one or more spatial neighboring samples are from a residual sample, and deriving, by the encoder, the ALF classifier for an online ALF process, the ALF classifier utilizing sample values from the residual sample.

At step 1801, the method 1800 includes obtaining, by the encoder, one or more spatial neighboring samples associated with the current sample, wherein the one or more spatial neighboring samples are from a residual sample. At step 1802, the method 1800 includes deriving, by the encoder, the ALF classifier for the online ALF process, the ALF classifier utilizing sample values from the residual sample.

In one example, the method 1800 includes obtaining, by the encoder, a first feature by computing directionality of the sub-block of the luma component, obtaining, by the encoder, a second feature by calculating a sum of sample values in the residual sample, mapping, by the encoder, the sum of sample values to a residual index, and deriving, by the encoder, a combined classifier for the online ALF process based on the first feature and the second feature.

In one example, the method 1800 includes obtaining, by the encoder, a first feature by computing an activity value of the sub-block of the luma component, obtaining, by the encoder, a second feature by calculating a sum of sample values in the residual sample, mapping, by the encoder, the sum of sample values to a residual index, and deriving, by the encoder, a combined classifier for the online ALF process based on the first feature and the second feature.

In one example, the method 1800 includes obtaining, by the encoder, a first feature by computing an ALF edge based classifier index of a sub-block of a luma component, calculating, by the encoder, a second feature by calculating a sum of sample values in the residual sample, mapping, by the encoder, the sum of sample values to a residual index, and deriving, by the encoder, a combined classifier for the online ALF process based on the first feature and the second feature.

In one example, the method 1800 includes obtaining, by the encoder, a first feature by computing a band index of a sub-block of a luma component, calculating, by the encoder, a second feature by calculating a sum of sample values in the residual sample, mapping, by the encoder, the sum of sample values to a residual index, and deriving, by the encoder, a combined classifier for the online ALF process based on the first feature and the second feature.

In one example, the method 1800 includes wherein the residual index is used as a class index.

### New Classifiers Utilizing Pixel Values Before SAO

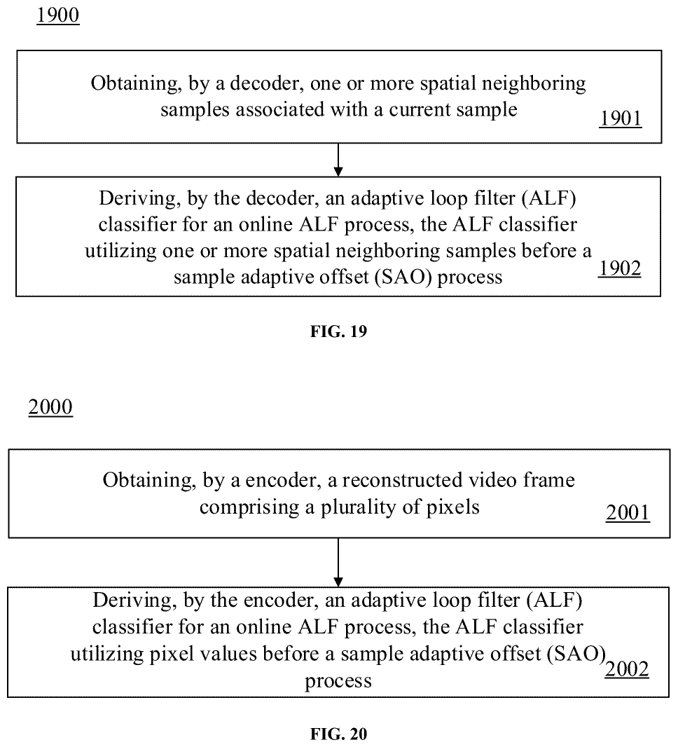

FIG. 19 is a flowchart illustrating a method 1900 for video decoding in accordance with some examples of the present disclosure. The method 1900 includes obtaining, by the decoder, one or more spatial neighboring samples associated with a current sample, and deriving, by the decoder, the ALF classifier for an online ALF process, the ALF classifier utilizing one or more spatial neighboring samples before the SAO process.

At step 1901, the method 1900 includes obtaining, by the decoder, one or more spatial neighboring samples associated with a current sample.

At step 1902, the method 1900 includes deriving, by the decoder, the ALF classifier for an online ALF process, the ALF classifier utilizing one or more spatial neighboring samples before the SAO process.

In one example, the method 1900 further comprises obtaining, by the decoder, a first feature by computing directionality of a sub-block of a luma component, obtaining, by the decoder, a second feature by calculating a sum of differences values between a sample after the SAO process and a collocated sample before the SAO process of the sub-block, mapping, by the decoder, the sum to a difference index, and deriving, by the decoder, a combined classifier for the online ALF process based on the first feature and the second feature.

For example, the decoder can first compute the directionality D of the sub-block of luma component. Upon computing the directionality D, the decoder can determine the sum of difference values between samples after SAO and collocated samples before SAO of the sub-block is calculated. The difference values are then mapped to the difference index. The class index for the sub-block is calculated as:

$$C = Dif * {M}_{D} + D$$

where Dif is the difference index, M_{D} represents the total number of directionalities D. In one example, for the 2×2 luma block, the directionality D is calculated the same to D₂ in ECM, and Dif is calculated as:

$$Dif = {sum}_{Dif} > 0 ? 2 : ( {sum}_{Dif} < 0 ? 0 : 1 )$$

In one example, the method 1900 further comprises obtaining, by the decoder, a first feature by computing an activity value of a sub-block of a luma component, obtaining, by the decoder, a second feature by calculating a sum of difference values between a sample after the SAO process and a collocated sample before the SAO process of the sub-block, mapping, by the decoder, the sum to a difference index, and deriving, by the decoder, a combined classifier for the online ALF process based on the first feature and the second feature.

For example, the decoder can first compute the activity value A of the sub-block of luma component. Upon computing the activity value A, the decoder can then determine the sum of difference values between sample after SAO and collocated sample before SAO of the sub-block. The difference values are then mapped to the difference index. The class index for the sub-block is calculated as:

$$C = Dif * {M}_{A} + A$$

where Dif is the difference index, M_{A} represents the total number of the activity value A. In one example, for the 2×2 luma block, the activity value A is calculated the same to Â₂ in ECM, and Dif is calculated:

$$Dif = {sum}_{Dif} > 0 ? 2 : ( {sum}_{Dif} < 0 ? 0 : 1 )$$

In one example, the method 1900 further comprises obtaining, by the decoder, a first feature by computing an ALF edge based classifier index of a sub-block of a luma component, obtaining, by the decoder, a second feature by calculating a sum of difference values between a sample after the SAO process and a collocated sample before the SAO process of the sub-block, mapping, by the decoder, the sum to a difference index, and deriving, by the decoder, a combined classifier for the online ALF process based on the first feature and the second feature.

For example, the decoder can first compute the index of the sub-block of a luma component referring to the edge based classifier. Upon computing the index of the sub-block of the luma component referring to the edge based classifier, the decoder can then compute the sum of difference values between sample after SAO and collocated sample before SAO of the sub-block is calculated. The difference values are then mapped to the difference index. The class index for the sub-block is calculated as:

$$C = Dif * {M}_{E} + E$$

where Dif is the difference index, M_{E} represents the total number of the index calculated referring to the edge based classifier, E is the index calculated referring to the edge based classifier. In one example, for the 2×2 luma block, the index E is calculated the same to C₂ in ECM, and Dif is calculated as:

$$Dif = {sum}_{Dif} > 0 ? 2 : ( {sum}_{Dif} < 0 ? 0 : 1 )$$

In one example, the method 1900 further comprises obtaining, by the decoder, a first feature based on a band index of a sub-block of a luma component, obtaining, by the decoder, a second feature by calculating a sum of difference values between a sample after the SAO process and a collocated sample before the SAO process, mapping, by the decoder, the sum to a difference index, and deriving, by the decoder, a combined classifier for the online ALF process based on the first feature and the second feature.

For example, the decoder can first compute the band index B of the sub-block of luma component, then the sum of difference values between samples after SAO and collocated samples before SAO of the sub-block is calculated. The difference values are then mapped to the difference index. The class index for the sub-block is calculated as:

$$C = Dif * {M}_{B} + B$$

where Dif is the difference index, M_{B} represents the total number of the band value. In one example, for the 2×2 luma block, the band index B is calculated as

$$B = ( sum * 8 ) ≫ ( sample bit depth + 2 )$$

and Dif is calculated as:

$$Dif = {sum}_{Dif} > 0 ? 2 : ( {sum}_{Dif} < 0 ? 0 : 1 )$$

In one example, the method 1900 further comprises obtaining, by the decoder, a first feature by calculating a sum of difference values between a sample after the SAO process and a collocated sample before the SAO process, mapping, by the decoder, the sum to a difference index, and deriving, by the decoder, a new classifier for the online ALF process based on the first feature.

For example, the decoder can compute the sum of difference values between samples after SAO and collocated samples before SAO of the sub-block. The sum of difference values can then be mapped to the difference index which is used as the class index.

In one example, the method 1900 further comprises deriving, by the decoder, a new classifier for the online ALF process by computing an ALF edge based classifier index based on the samples before the SAO process. In another example, the method 1900 further comprises deriving, by the decoder, a new classifier for the online ALF process by computing a band index based on the samples before the SAO process.

For example, the decoder can calculate the edged based classifier or band based classifier based on the sample values before SAO, using the same calculation method that original edge based classifier or band based classifier used based on the sample values after SAO.

It should be noted that the aforementioned examples can alternatively be performed by the encoder. Examples of the aforementioned methods performed by the encoder are explained in further detail in FIG. 20.

FIG. 20 is a flowchart illustrating a method 2000 for video encoding in accordance with some examples of the present disclosure. The method 2000 includes obtaining, by the encoder, a reconstructed video frame comprising a plurality of pixels, and deriving, by the encoder, the ALF classifier for an online ALF process, the ALF classifier utilizing one or more spatial neighboring samples before the SAO process.

At step 2001, the method 2000 includes obtaining, by the encoder, a reconstructed video frame comprising a plurality of pixels. At step 2002, the method 2000 includes deriving, by the encoder, the ALF classifier for an online ALF process, the ALF classifier utilizing one or more spatial neighboring samples before the SAO process.

In one example, the method 2000 further comprises obtaining, by the encoder, a first feature by computing directionality of a sub-block of a luma component, obtaining, by the encoder, a second feature by calculating a sum of differences values between a sample after the SAO process and a collocated sample before the SAO process of the sub-block, mapping, by the encoder, the sum to a difference index, and deriving, by the encoder, a combined classifier for the online ALF process based on the first feature and the second feature.

In one example, the method 2000 further comprises obtaining, by the encoder, a first feature by computing an activity value of a sub-block of a luma component, obtaining, by the encoder, a second feature by calculating a sum of difference values between a sample after the SAO process and a collocated sample before the SAO process of the sub-block, mapping, by the encoder, the sum to a difference index, and deriving, by the encoder, a combined classifier for the online ALF process based on the first feature and the second feature.

In one example, the method 2000 further comprises obtaining, by the encoder, a first feature by computing an ALF edge based classifier index of a sub-block of a luma component, obtaining, by the encoder, a second feature by calculating a sum of difference values between a sample after the SAO process and a collocated sample before a sample adaptive offset (SAO) process of the sub-block, mapping, by the encoder, the sum to a difference index, and deriving, by the encoder, a combined classifier for the online ALF process based on the first feature and the second feature.

In one example, the method 2000 further comprises obtaining, by the encoder, a first feature based on a band index of a sub-block of a luma component, obtaining, by the encoder, a second feature by calculating a sum of difference values between a sample after the SAO process and a collocated sample before the SAO process, mapping, by the encoder, the sum to a difference index, and deriving, by the encoder, a combined classifier for the online ALF process based on the first feature and the second feature.

In one example, the method 2000 further comprises obtaining, by the encoder, a first feature by calculating a sum of difference values between a sample after the SAO process and a collocated sample before the SAO process, mapping, by the encoder, the sum to a difference index, and deriving, by the encoder, a new classifier for the online ALF process based on the first feature.

In one example, the method 2000 further comprises deriving, by the encoder, a new classifier for the online ALF process by computing an ALF edge based classifier index based on the samples before the SAO process. In another example, the method 2000 further comprises deriving, by the encoder, a new classifier for the online ALF process by computing a band index based on the samples before the SAO process.

### New Classifiers Utilizing Chroma Pixel Values

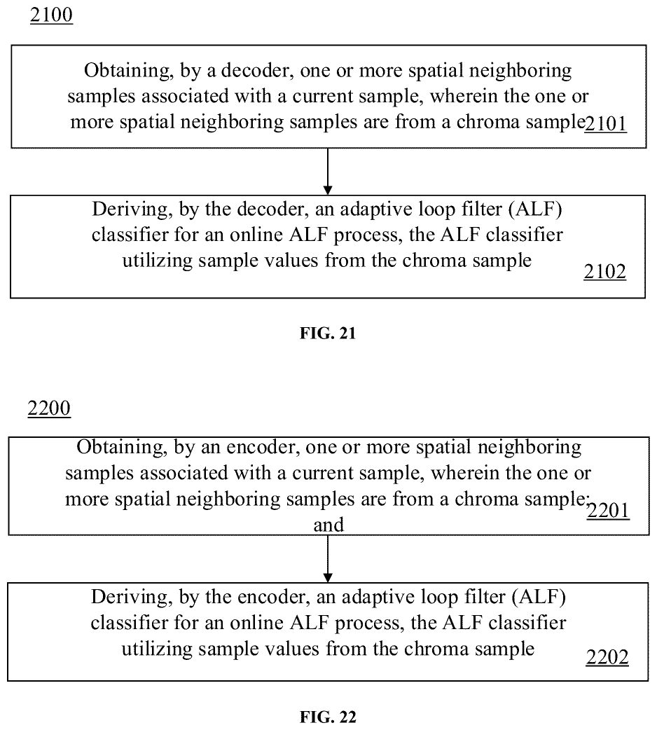

FIG. 21 is a flowchart illustrating a method 2100 for video decoding in accordance with some examples of the present disclosure. The method 2100 includes obtaining, by the decoder, one or more spatial neighboring samples associated with a current sample, wherein the one or more spatial neighboring samples are from a chroma sample, and deriving, by the decoder, the ALF classifier for the online ALF process, the ALF classifier utilizing sample values from the chroma sample.

At step 2101, the method 2100 includes obtaining, by the decoder, one or more spatial neighboring samples associated with the current sample, wherein the one or more spatial neighboring samples are from the chroma sample. At step 2102, the method 2100 includes deriving, by the decoder, the ALF classifier for the online ALF process, the ALF classifier utilizing sample values from the chroma sample.

In one example, the method 2100 includes obtaining, by the decoder, a first feature based on the band index of the sub-block of the luma component, obtaining, by the decoder, a second feature based on a band index of a sub-block of a Cb chroma component, obtaining, by the decoder, a third feature based on a band index of a sub-block of a Cr chroma component, deriving, by the decoder, a combined classifier for the online ALF process based on the first feature, the second and the third feature.

The decoder can first compute the band index B_{Y} of the sub-block of luma component. Upon computing the band index B_{Y} of the sub-block of luma component, the decoder can then compute the band index B_{U} and B_{V} of the corresponding U and V components. The class index for the sub-block is calculated as

$$C = {B}_{Y} * {M}_{U} * {M}_{V} + {B}_{U} * {M}_{V} + {B}_{V}$$

where B_{Y}, B_{U} and B_{V} are the Y, U and V index calculated referring to the band based classifier, M_{U} and M_{V} represent the total number of the U and V band index value. In one example, for the 2×2 luma block, the B_{Y}, B_{U} and B_{V} are calculated as

$${B}_{Y} = ( sumY * 6 ) ≫ ( sample bit depth + 2 ) \\ {B}_{U} = ( sumU * 2 ) ≫ ( sample bit depth + 2 ) \\ {B}_{V} = ( sumV * 2 ) ≫ ( sample bit depth + 2 )$$

It should be noted that the aforementioned examples can alternatively be performed by the encoder. Examples of the aforementioned methods performed by the encoder are explained in further detail in FIG. 22.

FIG. 22 is a flowchart illustrating a method 2200 for video encoding in accordance with some examples of present disclosure. The method 2200 includes obtaining, by the encoder, one or more spatial neighboring sample associated with a current sample, wherein the one or more spatial neighboring samples are from a chroma sample, and deriving by the encoder, the ALF classifier for the online ALF process, the ALF classifier utilizes sample values from the chroma sample.

At step 2201, the method 2200 includes obtaining, by the encoder, one or more spatial neighboring sample associated with the current sample, wherein the one or more spatial neighboring samples are from the chroma sample. At step 2202, the method 2200 includes deriving, by the encoder, the ALF classifier for the online ALF process, the ALF classifier utilizes sample values from the chroma sample.

In one example, the method 2200 includes obtaining, by the encoder, a first feature based on the band index of the sub-block of the luma component, obtaining, by the encoder, a second feature based on a band index of a sub-block of a Cb chroma component, obtaining, by the encoder, a third feature based on a band index of a sub-block of a Cr chroma component, deriving, by the encoder, a combined classifier for the online ALF process based on the first feature, the second and the third feature.

### CCALF in VVC

### Filter Shapes and Precision

CCALF uses the luma sample values to refine the chroma sample values within the ALF process. As shown in FIG. 8B, a linear filtering operation takes the luma sample values as input and generates the correction values for the chroma sample values. The correction is generated independently for each chroma component i, i∈{Cb, Cr} and can be represented by: ΔRᵢ(x,y)=Σ₍ₓ_{₀}_{,y}_{₀}_{)∈S}_{ᵢ}R_{γ}(x_{C}+x₀,y_{C}+y₀)cᵢ(x₀,y₀), where (x,y) is the sample location of the chroma component i, (x_{C},y_{C}) is the luma sample location derived from (x,y), (x₀,y₀) are the filter support offset around (x_{C},y_{C}), Sᵢ is the filter support region in luma for the chroma component i. The luma location (x_{C},y_{C}) is determined based on the spatial scaling factor between the luma and chroma planes. The sample values in the luma support region are also inputs to the ALF luma stage and correspond to the output of the SAO stage.

As shown in FIG. 8C, the CCALF filter has a diamond shape. As seen in FIG. 8C, for a 4:2:0 video sequence, with chroma location type 0, i.e., when the chroma samples are horizontally co-sited with the even numbered columns of the luma samples and vertically interstitial between the rows of the luma samples, the center of the diamond is aligned with a chroma sample location.

CCALF coefficients have a greater degree of flexibility compared to regular ALF coefficients, since no symmetry constraints are enforced. However, two limitations are enforced:

To preserve DC neutrality, the sum of CCALF coefficient values is required to be zero. As a result, only seven of the eight CCALF coefficients need to be signalled in the bitstream, and the coefficient at location (x_{C},y_{C}) is derived at the decoder.

The absolute value of CCALF coefficients is restricted to be either zero or an integer power of two, specifically {0, 1, 2, 4, 8, 16, 32, 64}. This enables implementations to use variable bit-shift operations in place of multiplications for CCALF, if desired.

### Syntax Design

The maximum number of filters per chroma component of a picture was four in the final design of VVC. A different set of CCALF coefficients can be selected for each CTU of a chroma component. As is the case for the regular ALF coefficients, CCALF coefficients are signalled within an ALF APS. Each ALF APS contains up to four CCALF filters for each chroma component. While CCALF can be enabled at a sequence level, it can only be enabled if ALF is also enabled for the sequence. Similarly, CCALF can be enabled at picture and slice level only if luma ALF is enabled at the corresponding level.

### Line Buffer Reduction

As described in section 3.1.5, the luma and the chroma line buffer boundaries are four and two samples, respectively, above the CTU boundary. For the 4:2:0 chroma format, this results in line buffer boundaries that are aligned for chroma and luma. However, for 4:2:2 and 4:4:4 chroma formats, the chroma and the luma line buffer boundaries are not aligned with each other. As a result of this misalignment, for 4:2:2 and 4:4:4 chroma formats, CC-ALF is not applied to the rows three and four samples above the CTU boundary.

### CCALF in ECM

The CCALF process uses a linear filter to filter luma sample values and generate a residual correction for the chroma samples. A 25-tap large filter is used in CCALF process, which is illustrated in FIG. 8D. For a given slice, the encoder can collect the statistics of the slice, analyze them and can signal up to 16 filters through APS.

Although ALF and CCALF have been improved in ECM, there is room to further improve the performance.

First, online ALF filter in ECM takes spatial neighboring pixels, fixed ALF filter results and spatial neighboring pixels before deblocking filter as input. However, besides these information, other information such as spatial neighboring pixels in prediction signal, spatial neighboring pixels in residual signal, or spatial neighboring pixels before SAO can also be used as online ALF filter equation input, which may benefit the coding performance.

Second, edge based classifier and band based classifier are used adaptively for online ALF filter in ECM. However, these two classifier may be further combined to provide other classifiers, which may benefit the coding performance.

Third, the filter shape for chroma ALF is diamond in ECM, while the filter shape for luma ALF is long cross shape, such non-unified design may not be optimal from standardization point of view.

Fourth, the edge based classifier and band based classifier in ECM only consider the pixel values after SAO. However, after the pixel values from the stages: 1) right before deblocking filter 2) prediction signal 3) residual signal 4) right before SAO are saved as online ALF filter equation input, these pixel values can also be utilized to design new classifiers, which may benefit the coding performance.

Fifth, the edge based classifier and band based classifier in ECM only consider luma pixel values after SAO. However, the chroma pixel values can also be utilized to design new classifier, which may benefit the coding performance.

Sixth, similar to the luma pixel values from the stages: 1) right before deblocking filter 2) prediction signal 3) residual signal 4) right before SAO are saved as additional online luma ALF filter equation input, the chroma pixel values from the stages: 1) before deblocking filter 2) prediction signal 3) residual signal 4) right before SAO can also be saved as additional online chroma ALF filter equation input, which may benefit the coding performance.

Seventh, similar to the luma pixel values from the stages: 1) right before deblocking filter 2) prediction signal 3) residual signal 4) right before SAO are saved as additional online luma ALF filter equation input, the luma pixel values from the stages: 1) right before deblocking filter 2) prediction signal 3) residual signal 4) right before SAO can also be saved as additional CCALF filter equation input, which may benefit the coding performance.

Eighth, the classifiers design in ECM only considers the reconstruction pixel values. However, the coding mode information such as whether a coding block is coded with skip mode, whether the coding block is coded with intra, inter P or inter B mode can also be utilized to design classifier, which may benefit the coding performance.

Ninth, after online ALF filter takes samples as additional input from the stages: 1) samples right before deblocking 2) prediction samples 3) residual samples 4) samples right before SAO, etc., according to current line buffer settings in VVC, additional line buffers are needed to save 4 rows of corresponding luma samples and 2 rows of corresponding chroma samples above horizontal CTU boundaries, which increases the implementation complexity.

Tenth, after CCALF filter takes samples as additional input from the stages: 1) samples right before deblocking 2) prediction samples 3) residual samples 4) samples right before SAO, etc., according to current line buffer settings in VVC, additional line buffers are needed to save 4 rows of corresponding luma samples above horizontal CTU boundaries, which increases the implementation complexity.

In this disclosure, to address the issues as pointed out in the “problem statement” section, methods are provided to further improve the existing design of the ALF. In general, the main features of the proposed technologies in this disclosure are summarized as follows.

Online ALF filter takes spatial neighboring pixels in prediction signal, spatial neighboring pixels in residual signal, or spatial neighboring pixels before SAO as additional input.

The classifiers which combine the features of edge based classifier and band based classifier are used as additional classifier for online ALF filter.

The filter shape for chroma ALF is changed from diamond shape to long cross shape to unify with the filter shape for luma ALF.

The classifiers which utilize the pixel values from the stages: 1) right before deblocking filter 2) prediction signal 3) residual signal 4) right before SAO are used as additional classifier for online ALF filter.

The classifiers which utilize the chroma pixel values are used as additional classifier for online ALF filter.

Online chroma ALF filter takes spatial neighboring pixels in chroma prediction signal, spatial neighboring pixels in chroma residual signal, spatial neighboring pixels from the stage right before chroma SAO, or spatial neighboring pixels from the stage right before chroma deblocking as additional input.

CCALF filter takes spatial neighboring pixels in luma prediction signal, spatial neighboring pixels in luma residual signal, spatial neighboring pixels from the stage right before luma SAO, or spatial neighboring pixels from the stage right before luma deblocking as additional input.

The classifiers which utilize the coding mode information such as whether a coding block is coded with skip mode, whether the coding block is coded with intra, inter P or inter B mode are used as additional classifiers for online ALF filter.

When online ALF filter takes samples as additional input from the stages: 1) samples right before deblocking 2) prediction samples 3) residual samples 4) samples right before SAO, etc., according to current line buffer settings in VVC, 4 rows of corresponding luma samples and 2 rows of corresponding chroma samples above horizontal CTU boundaries are assumed to default values, which may save these line buffers.

When CCALF filter takes samples as additional input from the stages: 1) samples right before deblocking 2) prediction samples 3) residual samples, 4) samples right before SAO, etc., according to current line buffer settings in VVC, 4 rows of corresponding luma samples above horizontal CTU boundaries are assumed to default values, which may save these line buffers.

In some embodiments of the present disclosure, the disclosed methods may be applied independently or jointly.

### Information in Prediction, Residual or Before SAO Used as Additional ALF Input

According to the one or more embodiments of the disclosure, information in prediction, residual or before SAO are used as additional ALF equation input. Different methods may be used to achieve this goal.

FIG. 8E presents the online ALF filter inputs. Online ALF filter can take all or a subset of prediction samples, output samples which are obtained by feeding prediction samples into the offline trained fixed filters, residual samples, output samples which are obtained by feeding residual samples into the offline trained fixed filters, reconstructed samples right before SAO, and output samples which are obtained by feeding reconstructed samples right before SAO into the offline trained fixed filters, as additional inputs.

In the first method, it is proposed to take the spatial neighboring pixels in prediction signal as additional ALF equation input. Various filter shapes may be used to extract the information in prediction signal. For example, the filter shape may be 1×1, 3×3 or 5×5 as shown in FIG. 9. Various equation forms may be used to extract the information in prediction signal. In an embodiment, the clipping differences between the surrounding pixels in prediction signal and current pixel are used as ALF equation input. In another example, the clipping differences between the surrounding pixels in prediction signal and the collocated pixel in prediction signal, the clipping difference between the collocated pixel in prediction signal and current pixel are used as ALF equation input.

Besides applying additional online ALF filter taps directly to prediction signal, additional online ALF filter taps may also be applied to the midterm results which are obtained by feeding prediction signal to fixed filters. Various fixed filters may be applied to filter prediction signal to obtain the midterm results, which may gather the prediction signal information in a large receptive field. For example, the two 13×13 diamond shape fixed filters utilized in ALF in ECM may be utilized to filter prediction signal to obtain the midterm results. When applying fixed filters to prediction signal, the block level classification results may directly utilize the block level classification results computed for right after SAO signal, or recomputed based on prediction signal. When applying fixed filters to prediction signal, one fixed filter trained based on one block level classifier may be utilized to obtain one midterm result, or two or more fixed filters trained based on two or more block level classifiers may be utilized to obtain two or more midterm results. In video coding standards, there are usually several groups fixed filters prepared, and one group fixed filter may be chosen from them by a rate distortion optimization (RDO) process. For example, in ECM, one group fixed filter (contains two 13×13 diamond shape fixed filters) is chosen from two groups by RDO process, and the group index is transmitted to decoder. When applying fixed filters to prediction signal, the group index for prediction signal may be same to the group index for right after SAO signal, or different from the group index for right after SAO signal based on a predefined criterion (In ECM, there are two groups, so if the group index for right after SAO signal is 0, then the group index for prediction signal is 1; if the group index for right after SAO signal is 1, then the group index for prediction signal is 0), or decided for prediction signal by RDO process, where no group index for prediction signal is needed to transmitted to decoder in the first and second cases and the group index for prediction signal needed to transmitted to decoder in the third case.

When applying additional online filter taps to the midterm results which are obtained by feeding prediction signal to fixed filters, various filter shapes may be used to extract the information in the midterm results. For example, the filter shape may be 1×1, 3×3 or 5×5 as shown in FIG. 9. Various equation forms may be used to extract the information in the midterm results. In an embodiment, the clipping differences between the surrounding pixels in the midterm results and current pixel are used as ALF equation input. In another example, the clipping differences between the surrounding pixels in the midterm results and the collocated pixel in the midterm results, the clipping difference between the collocated pixel in the midterm results and current pixel are used as ALF equation input.

It should be noted that the additional online ALF filter taps may be applied to only prediction signal, or only the midterm results which are obtained by feeding prediction signal to fixed filters, or both prediction signal and the midterm results which are obtained by feeding prediction signal to fixed filters. For example, in AI (all intra) test, the additional online ALF filter taps are applied to only prediction signal; in RA (random access) test, the additional online ALF filter taps are applied to both prediction signal and the midterm results which are obtained by feeding prediction signal to fixed filters.

In the second method, it is proposed to take the spatial neighboring pixels in residual signal as additional ALF equation input. Various filter shapes may be used to extract the information in residual signal. For example, the filter shape may be 1×1, 3×3 or 5×5 as shown in FIG. 9. Various equation forms may be used to extract the information in residual signal. In an embodiment, the clipping results of the collocated pixel in residual signal are used as ALF equation input.

Besides applying additional online ALF filter taps directly to residual signal, additional online ALF filter taps may also be applied to the midterm results which are obtained by feeding residual signal to fixed filters. Various fixed filters may be applied to filter residual signal to obtain the midterm results, which may gather the residual signal information in a large receptive field. For example, the two 13×13 diamond shape fixed filters utilized in ALF in ECM may be utilized to filter residual signal to obtain the midterm results. In one or more examples, considering that for prediction and before SAO signals, the ranges are just same to range after SAO signal, i.e. (0, 1024), which are positive, but for residual signals, the range may be positive or negative. Thus, when applying fixed filters to residual signal, the filtering results may be clipped to different range such as (−1024, 1024), (−512, 512), (−256, 256), (−128, 128), and so on. When applying fixed filters to residual signal, the block level classification results may directly utilize the block level classification results computed for right after SAO signal, or recomputed based on residual signal. When applying fixed filters to residual signal, one fixed filter trained based on one block level classifier may be utilized to obtain one midterm result, or two or more fixed filters trained based on two or more block level classifiers may be utilized to obtain two or more midterm results. When applying fixed filters to residual signal, the group index for residual signal may be same to the group index for right after SAO signal, or different from the group index for right after SAO signal based on a predefined criterion (In ECM, there are two groups, so if the group index for right after SAO signal is 0, then the group index for residual signal is 1; if the group index for right after SAO signal is 1, then the group index for residual signal is 0), or decided for residual signal by the RDO process, where no group index for residual signal is needed to transmitted to decoder in the first and second cases and the group index for residual signal needed to transmitted to decoder in the third case.

When applying additional online filter taps to the midterm results which are obtained by feeding residual signal to fixed filters, various filter shapes may be used to extract the information in the midterm results. For example, the filter shape may be 1×1, 3×3 or 5×5 as shown in FIG. 9. Various equation forms may be used to extract the information in the midterm results. In an embodiment, the clipping results of the collocated pixel in the midterm results are used as ALF equation input.

It should be noted that the additional online ALF filter taps may be applied to only residual signal, or only the midterm results which are obtained by feeding residual signal to fixed filters, or both residual signal and the midterm results which are obtained by feeding residual signal to fixed filters. For example, in AI (all intra) test, the additional online ALF filter taps are applied to only residual signal; in RA (random access) test, the additional online ALF filter taps are applied to both residual signal and the midterm results which are obtained by feeding residual signal to fixed filters.

In the third method, it is proposed to take the spatial neighboring pixels from the stage right before SAO signal as additional ALF equation input. Various filter shapes may be used to extract the information in before SAO signal. For example, the filter shape may be 1×1, 3×3 or 5×5 as shown in FIG. 9. Various equation forms may be used to extract the information in before SAO signal. In an embodiment, the clipping differences between the surrounding pixels in before SAO signal and current pixel are used as ALF equation input. In another example, the clipping differences between the surrounding pixels in before SAO signal and the collocated pixel in before SAO signal, the clipping difference between the collocated pixel in before SAO signal and current pixel are used as ALF equation input.

Besides applying additional online ALF filter taps directly to right before SAO signal, additional online ALF filter taps may also be applied to the midterm results which are obtained by feeding right before SAO signal to fixed filters. Various fixed filters may be applied to filter right before SAO signal to obtain the midterm results, which may gather the right before SAO signal information in a large receptive field. For example, the two 13×13 diamond shape fixed filters utilized in ALF in ECM may be utilized to filter right before SAO signal to obtain the midterm results. When applying fixed filters to right before SAO signal, the block level classification results may directly utilize the block level classification results computed for right after SAO signal, or recomputed based on right before SAO signal. When applying fixed filters to right before SAO signal, one fixed filter trained based on one block level classifier may be utilized to obtain one midterm result, or two or more fixed filters trained based on two or more block level classifiers may be utilized to obtain two or more midterm results. When applying fixed filters to right before SAO signal, the group index for right before SAO signal may be same to the group index for right after SAO signal, or different from the group index for right after SAO signal based on a predefined criterion (In ECM, there are two groups, so if the group index for right after SAO signal is 0, then the group index for right before SAO signal is 1; if the group index for right after SAO signal is 1, then the group index for right before SAO signal is 0), or decided for right before SAO signal by a RDO process, where no group index for right before SAO signal is needed to transmitted to decoder in the first and second cases and the group index for right before SAO signal needed to transmitted to decoder in the third case.

When applying additional online filter taps to the midterm results which are obtained by feeding right before SAO signal to fixed filters, various filter shapes may be used to extract the information in the midterm results. For example, the filter shape may be 1×1, 3×3 or 5×5 as shown in FIG. 9. Various equation forms may be used to extract the information in the midterm results. In an embodiment, the clipping differences between the surrounding pixels in the midterm results and current pixel are used as ALF equation input. In another example, the clipping differences between the surrounding pixels in the midterm results and the collocated pixel in the midterm results, the clipping difference between the collocated pixel in the midterm results and current pixel are used as ALF equation input.

It should be noted that the additional online ALF filter taps may be applied to only right before SAO signal, or only the midterm results which are obtained by feeding right before SAO signal to fixed filters, or both right before SAO signal and the midterm results which are obtained by feeding right before SAO signal to fixed filters. For example, in AI (all intra) test, the additional online ALF filter taps are applied to only right before SAO signal; in RA (random access) test, the additional online ALF filter taps are applied to both right before SAO signal and the midterm results which are obtained by feeding right before SAO signal to fixed filters.

In the fourth method, it is proposed to take the information in prediction, residual or before SAO signal as ALF equation input. The utilization method proposed in the first, second and third method may be combined to achieve the fourth method.

### New Classifiers Combined the Features of Edge Based Classifier and Band Based Classifier

According to the one or more embodiments of the disclosure, the features of edge based classifier and band based classifier are combined to derive new classifiers for online ALF filter. Different methods may be used to achieve this goal.

In the first method, it is proposed to first compute the directionality D of the sub-block of luma component, then the sum of sample values of the sub-block is calculated and it is mapped to the index referring to the band based classifier, and the class index for the sub-block is calculated as

$$C = B * {M}_{D} + D , \qquad ( 17 )$$

where B is the index calculated referring to the band based classifier, M_{D} represents the total number of directionalities D. In an embodiment, for the 2×2 luma block, the directionality D is calculated the same to D₂ in ECM, and B is calculated as

$$B = ( sum * 5 ) ≫ ( sample bit depth + 2 ) . \qquad ( 18 )$$

In the second method, it is proposed to first compute the activity value A of the sub-block of luma component, then the sum of sample values of the sub-block is calculated and it is mapped to the index referring to the band based classifier, and the class index for the sub-block is calculated as

$$C = B * {M}_{A} + A , \qquad ( 19 )$$

where B is the index calculated referring to the band based classifier, M_{A} represents the total number of the activity value A. In an embodiment, for the 2×2 luma block, the activity value A is calculated the same to Â₂ in ECM, and B is calculated as

$$B = ( sum * 5 ) ≫ ( sample bit depth + 2 ) . \qquad ( 20 )$$

In the third method, it is proposed to first compute the index of the sub-block of luma component referring to the edge based classifier, then the sum of sample values of the sub-block is calculated and it is mapped to the index referring to the band based classifier, and the class index for the sub-block is calculated as

$$C = B * {M}_{E} + E , \qquad ( 21 )$$

where B is the index calculated referring to the band based classifier, M_{E} represents the total number of the index calculated referring to the edge based classifier, E is the index calculated referring to the edge based classifier. In an embodiment, for the 2×2 luma block, the index E is calculated the same to C₂ in ECM, and B is calculated as

$$B = ( sum * 2 ) ≫ ( sample bit depth + 2 ) . \qquad ( 22 )$$

Adjust the Chroma ALF Filter Shape to Unify with Luma ALF Filter Shape

In the third aspect of this disclosure, it is proposed to change the chroma ALF filter shape from diamond shape to long cross shape as shown in FIG. 10, which is unified with the luma ALF filter shape.

New Classifiers Utilized the Pixel Values from the Stage Right Before Deblocking Filter

According to the one or more embodiments of the disclosure, the pixel values from the stage right before deblocking filter are utilized to derive new classifiers for online ALF filter. Different methods may be used to achieve this goal.

In the first method, it is proposed to first compute the directionality D of the sub-block of luma component, then the sum of difference values between sample from the stage right after SAO and collocated sample from the stage right before deblocking filter of the sub-block is calculated and it is mapped to the difference index, and the class index for the sub-block is calculated as

$$C = Dif * {M}_{D} + D , \qquad ( 23 )$$

where Dif is the difference index, M_{D} represents the total number of directionalities D. In an embodiment, for the 2×2 luma block, the directionality D is calculated the same to D₂ in ECM, and Dif is calculated as

$$Dif = {sum}_{Dif} > 0 ? 2 : ( {sum}_{Dif} < 0 ? 0 : 1 ) . \qquad ( 24 )$$

In the second method, it is proposed to first compute the activity value A of the sub-block of luma component, then the sum of difference values between sample from the stage right after SAO and collocated sample from the stage right before deblocking filter of the sub-block is calculated and it is mapped to the difference index, and the class index for the sub-block is calculated as

$$C = Dif * {M}_{A} + A , \qquad ( 25 )$$

where Dif is the difference index, M_{A} represents the total number of the activity value A. In an embodiment, for the 2×2 luma block, the activity value A is calculated the same to Â₂ in ECM, and Dif is calculated as in equation (24).

In the third method, it is proposed to first compute the index of the sub-block of luma component referring to the edge based classifier, then the sum of difference values between sample from the stage right after SAO and collocated sample from the stage right before deblocking filter of the sub-block is calculated and it is mapped to the difference index, and the class index for the sub-block is calculated as

$$C = Dif * {M}_{E} + E , \qquad ( 26 )$$

where Dif is the difference index, M_{E} represents the total number of the index calculated referring to the edge based classifier, E is the index calculated referring to the edge based classifier. In an embodiment, for the 2×2 luma block, the index E is calculated the same to C₂ in ECM, and Dif is calculated as in equation (24).

In the fourth method, it is proposed to first compute the band index B of the sub-block of luma component, then the sum of difference values between sample from the stage right after SAO and collocated sample from the stage right before deblocking filter of the sub-block is calculated and it is mapped to the difference index, and the class index for the sub-block is calculated as

$$C = Dif * {M}_{B} + B , \qquad ( 27 )$$

where Dif is the difference index, M_{B} represents the total number of the band value. In an embodiment, for the 2×2 luma block, the band index B is calculated as

$$B = ( sum * 8 ) ≫ ( sample bit depth + 2 ) , \qquad ( 28 )$$

and Dif is calculated as in equation (24).

In the fifth method, it is proposed to compute the sum of difference values between sample from the stage right after SAO and collocated sample from the stage right before deblocking filter of the sub-block, then the sum of difference values is mapped to the difference index and the difference index is used as the class index.

In the sixth method, it is proposed to calculate the edged based classifier or band based classifier based on the sample values from the stage right before deblocking filter, where the calculation method is same to original edge based classifier or band based classifier calculated based on the sample values after SAO.

### New Classifiers Utilized the Pixel Values in Prediction Signal

According to the one or more embodiments of the disclosure, the pixel values in prediction signal are utilized to derive new classifiers for online ALF filter. Different methods may be used to achieve this goal.

In the first method, it is proposed to first compute the directionality D of the sub-block of luma component, then the sum of difference values between sample in after SAO and collocated sample in prediction signal of the sub-block is calculated and it is mapped to the difference index, and the class index for the sub-block is calculated as

$$C = Dif * {M}_{D} + D , \qquad ( 29 )$$

where Dif is the difference index, M_{D} represents the total number of directionalities D. In an embodiment, for the 2×2 luma block, the directionality D is calculated the same to D₂ in ECM, and Dif is calculated as

$$Dif = {sum}_{Dif} > 0 ? 2 : ( {sum}_{Dif} < 0 ? 0 : 1 ) . \qquad ( 30 )$$

In the second method, it is proposed to first compute the activity value A of the sub-block of luma component, then the sum of difference values between sample in after SAO and collocated sample in prediction signal of the sub-block is calculated and it is mapped to the difference index, and the class index for the sub-block is calculated as

$$C = Dif * {M}_{A} + A , \qquad ( 31 )$$

where Dif is the difference index, M_{A} represents the total number of the activity value A. In an embodiment, for the 2×2 luma block, the activity value A is calculated the same to Â₂ in ECM, and Dif is calculated as in equation (30).

In the third method, it is proposed to first compute the index of the sub-block of luma component referring to the edge based classifier, then the sum of difference values between sample in after SAO and collocated sample in prediction signal of the sub-block is calculated and it is mapped to the difference index, and the class index for the sub-block is calculated as

$$C = Dif * {M}_{E} + E , \qquad ( 32 )$$

where Dif is the difference index, M_{E} represents the total number of the index calculated referring to the edge based classifier, E is the index calculated referring to the edge based classifier. In an embodiment, for the 2×2 luma block, the index E is calculated the same to C₂ in ECM, and Dif is calculated as in equation (30).

In the fourth method, it is proposed to first compute the band index B of the sub-block of luma component, then the sum of difference values between sample in after SAO and collocated sample in prediction signal of the sub-block is calculated and it is mapped to the difference index, and the class index for the sub-block is calculated as

$$C = Dif * {M}_{B} + B , \qquad ( 33 )$$

where Dif is the difference index, M_{B} represents the total number of the band value. In an embodiment, for the 2×2 luma block, the band index B is calculated as

$$B = ( sum * 8 ) ≫ ( sample bit depth + 2 ) , \qquad ( 34 )$$

and Dif is calculated as in equation (30).

In the fifth method, it is proposed to compute the sum of difference values between sample in after SAO and collocated sample in prediction signal of the sub-block, then the sum of difference values is mapped to the difference index and the difference index is used as the class index.

In the sixth method, it is proposed to calculate the edged based classifier or band based classifier based on the sample values in prediction signal, where the calculation method is same to original edge based classifier or band based classifier calculated based on the sample values after SAO.

### New Classifiers Utilized the Pixel Values in Residual Signal

According to the one or more embodiments of the disclosure, the pixel values in residual signal are utilized to derive new classifiers for online ALF filter. Different methods may be used to achieve this goal.

In the first method, it is proposed to first compute the directionality D of the sub-block of luma component, then the sum of pixel values in residual signal of the sub-block is calculated and it is mapped to the residual index, and the class index for the sub-block is calculated as

$$C = Resi * {M}_{D} + D , \qquad ( 35 )$$

where Resi is the residual index, M_{D} represents the total number of directionalities D. In an embodiment, for the 2×2 luma block, the directionality D is calculated the same to D₂ in ECM, and Resi is calculated as

$$Resi = {sum}_{Resi} > 0 ? 2 : ( {sum}_{Resi} < 0 ? 0 : 1 ) . \qquad ( 36 )$$

In the second method, it is proposed to first compute the activity value A of the sub-block of luma component, then the sum of pixel values in residual signal of the sub-block is calculated and it is mapped to the residual index, and the class index for the sub-block is calculated as

$$C = Resi * {M}_{A} + A , \qquad ( 37 )$$

where Resi is the residual index, M_{A} represents the total number of the activity value A. In an embodiment, for the 2×2 luma block, the activity value A is calculated the same to Â₂ in ECM, and Resi is calculated as in equation (36).

In the third method, it is proposed to first compute the index of the sub-block of luma component referring to the edge based classifier, then the sum of pixel values in residual signal of the sub-block is calculated and it is mapped to the residual index, and the class index for the sub-block is calculated as

$$C = Resi * {M}_{E} + E , \qquad ( 38 )$$

where Resi is the residual index, M_{E} represents the total number of the index calculated referring to the edge based classifier, E is the index calculated referring to the edge based classifier. In an embodiment, for the 2×2 luma block, the index E is calculated the same to C₂ in ECM, and Resi is calculated as in equation (36).

In the fourth method, it is proposed to first compute the band index B of the sub-block of luma component, then the sum of pixel values in residual signal of the sub-block is calculated and it is mapped to the residual index, and the class index for the sub-block is calculated as

$$C = R e s i * {M}_{B} + B \qquad ( 39 )$$

where Resi is the residual index, M_{B} represents the total number of the band value. In an embodiment, for the 2×2 luma block, the band index B is calculated as

$$B = ( sum * 8 ) ≫ ( sample bit depth + 2 ) , \qquad ( 40 )$$

and Resi is calculated as in equation (36).

In the fifth method, it is proposed to compute the sum of pixel values in residual signal of the sub-block, then the sum of residual values is mapped to the residual index and the residual index is used as the class index.

In the sixth method, it is proposed to first compute the sum of absolute value of the pixel values in residual signal of the sub block and it is mapped to the absolute value of residual index ResiAbso, then the sum of pixel values in residual signal of the sub-block is calculated and it is mapped to the sign of residual index Resi_{Sign}, and the class index for the sub-block is calculated as

$$C = {Resi}_{Sign} * {M}_{Abso} + {Resi}_{Abso} , \qquad ( 41 )$$

where M_{Abso} represents the total number of the absolute value of residual index. In one example, for the 2×2 luma block, the absolute value of residual index ResiAbso is calculated as

$${Resi}_{Abso} = ( {Sum}_{Abso} * 8 ) ≫ ( sample bit depth + 2 ) , \qquad ( 42 )$$

and Resi_{Sign} is calculated as in equation (36).

In the seventh method, it is proposed to compute the index of the sub-block based on the pixel values in residual signal referring to the edge based classifier, then the index is used as the class index.

In the eighth method, it is proposed to compute the index of the sub-block based on the absolute value of the pixel values in residual signal referring to the edge based classifier, then the index is used as the class index.

New Classifiers Utilized the Pixel Values from the Stage Right Before SAO

According to the one or more embodiments of the disclosure, the pixel values from the stage right before SAO are utilized to derive new classifiers for online ALF filter. Different methods may be used to achieve this goal.

In the first method, it is proposed to first compute the directionality D of the sub-block of luma component, then the sum of difference values between sample from the stage right after SAO and collocated sample from the stage right before SAO of the sub-block is calculated and it is mapped to the difference index, and the class index for the sub-block is calculated as

$$C = Dif * {M}_{D} + D , \qquad ( 43 )$$

where Dif is the difference index, M_{D} represents the total number of directionalities D. In an embodiment, for the 2×2 luma block, the directionality D is calculated the same to D₂ in ECM, and Dif is calculated as

$$Dif = {sum}_{Dif} > 0 ? 2 : ( {sum}_{Dif} < 0 ? 0 : 1 ) . \qquad ( 44 )$$

In the second method, it is proposed to first compute the activity value A of the sub-block of luma component, then the sum of difference values between sample from the stage right after SAO and collocated sample from the stage right before SAO of the sub-block is calculated and it is mapped to the difference index, and the class index for the sub-block is calculated as

$$C = Dif * {M}_{A} + A , \qquad ( 45 )$$

where Dif is the difference index, M_{A} represents the total number of the activity value A. In an embodiment, for the 2×2 luma block, the activity value A is calculated the same to Â₂ in ECM, and Dif is calculated as in equation (44).

In the third method, it is proposed to first compute the index of the sub-block of luma component referring to the edge based classifier, then the sum of difference values between sample from the stage right after SAO and collocated sample from the stage right before SAO of the sub-block is calculated and it is mapped to the difference index, and the class index for the sub-block is calculated as

$$C = Dif * {M}_{E} + E , \qquad ( 46 )$$

where Dif is the difference index, M_{E} represents the total number of the index calculated referring to the edge based classifier, E is the index calculated referring to the edge based classifier. In an embodiment, for the 2×2 luma block, the index E is calculated the same to C₂ in ECM, and Dif is calculated as in equation (44).

In the fourth method, it is proposed to first compute the band index B of the sub-block of luma component, then the sum of difference values between sample from the stage right after SAO and collocated sample from the stage right before SAO of the sub-block is calculated and it is mapped to the difference index, and the class index for the sub-block is calculated as

$$C = Dif * {M}_{B} + B , \qquad ( 47 )$$

where Dif is the difference index, M_{B} represents the total number of the band value. In an embodiment, for the 2×2 luma block, the band index B is calculated as

$$B = ( sum * 8 ) ≫ ( sample bit depth + 2 ) , \qquad ( 48 )$$

and Dif is calculated as in equation (44).

In the fifth method, it is proposed to compute the sum of difference values between sample from the stage right after SAO and collocated sample from the stage right before SAO of the sub-block, then the sum of difference values is mapped to the difference index and the difference index is used as the class index.

In the sixth method, it is proposed to calculate the edged based classifier or band based classifier based on the sample values from the stage right before SAO, where the calculation method is same to original edge based classifier or band based classifier calculated based on the sample values after SAO.

### New Classifiers Utilized Chroma Pixel Values

According to the one or more embodiments of the disclosure, the chroma pixel values are utilized to derive new classifiers for online ALF filter. Different methods may be used to achieve this goal.

In the first method, it is proposed to first compute the band index B_{Y} of the sub-block of luma component, then the band index B_{U} and B_{V} of the corresponding U and V components are computed, and the class index for the sub-block is calculated as

$$C = {B}_{Y} * {M}_{U} * {M}_{V} + {B}_{U} * {M}_{V} + {B}_{V} , \qquad ( 49 )$$

where B_{Y}, B_{U} and B_{V} are the Y, U and V index calculated referring to the band based classifier, M_{U} and M_{V} represent the total number of the U and V band index value. In an embodiment, for the 2×2 luma block, the B_{Y}, B_{U} and B_{V} are calculated as

$${B}_{Y} = ( sumY * 6 ) ≫ ( sample bit depth + 2 ) , \qquad ( 50 )$$

Chroma Information from the Stages Right Before Deblocking, Prediction, Residual or Right Before SAO Used as Additional Chroma ALF Input

According to the one or more embodiments of the disclosure, chroma information from the stages right before deblocking, prediction, residual or right before SAO are used as additional chroma ALF equation input. Different methods may be used to achieve this goal.

In the first method, it is proposed to take the spatial neighboring pixels in chroma prediction signal as additional chroma ALF equation input. Various filter shapes may be used to extract the information in chroma prediction signal. For example, the filter shape may be 1×1, 3×3 or 5×5 as shown in FIG. 9. Various equation forms may be used to extract the information in chroma prediction signal. In an embodiment, the clipping differences between the surrounding pixels in chroma prediction signal and current chroma pixel are used as chroma ALF equation input. In another example, the clipping differences between the surrounding pixels in chroma prediction signal and the collocated pixel in chroma prediction signal, the clipping difference between the collocated pixel in chroma prediction signal and current chroma pixel are used as chroma ALF equation input.

In the second method, it is proposed to take the spatial neighboring pixels in chroma residual signal as additional chroma ALF equation input. Various filter shapes may be used to extract the information in chroma residual signal. For example, the filter shape may be 1×1, 3×3 or 5×5 as shown in FIG. 9. Various equation forms may be used to extract the information in chroma residual signal. In an embodiment, the clipping results of the collocated pixel in chroma residual signal are used as chroma ALF equation input.

In the third method, it is proposed to take the spatial neighboring pixels from the stage right before chroma SAO signal as additional chroma ALF equation input. Various filter shapes may be used to extract the information from the stage right before chroma SAO signal. For example, the filter shape may be 1×1, 3×3 or 5×5 as shown in FIG. 9. Various equation forms may be used to extract the information from the stage right before chroma SAO signal. In an embodiment, the clipping differences between the surrounding pixels from the stage right before chroma SAO signal and current chroma pixel are used as chroma ALF equation input. In another example, the clipping differences between the surrounding pixels from the stage right before chroma SAO signal and the collocated pixel from the stage right before chroma SAO signal, the clipping difference between the collocated pixel from the stage right before chroma SAO signal and current chroma pixel are used as chroma ALF equation input.

In the fourth method, it is proposed to take the spatial neighboring pixels from the stage right before chroma deblocking signal as additional chroma ALF equation input. Various filter shapes may be used to extract the information from the stage right before chroma deblocking signal. For example, the filter shape may be 1×1, 3×3 or 5×5 as shown in FIG. 9. Various equation forms may be used to extract the information from the stage right before chroma deblocking signal. In an embodiment, the clipping differences between the surrounding pixels from the stage right before chroma deblocking signal and current chroma pixel are used as chroma ALF equation input. In another example, the clipping differences between the surrounding pixels from the stage right before chroma deblocking signal and the collocated pixel from the stage right before chroma deblocking signal, the clipping difference between the collocated pixel from the stage right before chroma deblocking signal and current chroma pixel are used as chroma ALF equation input.

In the fifth method, it is proposed to take the information in chroma prediction, residual, before SAO or before deblocking signal as chroma ALF equation input. The utilization method proposed in the first, second third, fourth method may be combined to achieve the fifth method.

Luma Information from the Stages Right Before Deblocking, Prediction, Residual or Right Before SAO Used as Additional CCALF Input

According to the one or more embodiments of the disclosure, luma information from the stages right before deblocking, prediction, residual or right before SAO are used as additional CCALF equation input. Different methods may be used to achieve this goal.

In the first method, it is proposed to take the spatial neighboring pixels in luma prediction signal as additional CCALF equation input. Various filter shapes may be used to extract the information in luma prediction signal. For example, the filter shape may be 3×4 as shown in FIG. 8C. Various equation forms may be used to extract the information in luma prediction signal. In an embodiment, the differences between the surrounding pixels in luma prediction signal and current corresponding luma pixel are used as CCALF equation input. In another example, the differences between the surrounding pixels in luma prediction signal and the collocated pixel in current corresponding luma prediction signal, the difference between the collocated pixel in current corresponding luma prediction signal and current corresponding luma pixel are used as CCALF equation input.

In the second method, it is proposed to take the spatial neighboring pixels in luma residual signal as additional CCALF equation input. Various filter shapes may be used to extract the information in luma residual signal. For example, the filter shape may be 3×4 as shown in FIG. 8C. Various equation forms may be used to extract the information in luma residual signal. In an embodiment, the collocated pixel in luma residual signal are used as CCALF equation input.

In the third method, it is proposed to take the spatial neighboring pixels from the stage right before luma SAO signal as additional CCALF equation input. Various filter shapes may be used to extract the information from the stage right before luma SAO signal. For example, the filter shape may be 3×4 as shown in FIG. 8C. Various equation forms may be used to extract the information from the stage right before luma SAO signal. In an embodiment, the differences between the surrounding pixels from the stage right before luma SAO signal and current corresponding luma pixel are used as CCALF equation input. In another example, the differences between the surrounding pixels from the stage right before luma SAO signal and the collocated pixel in current corresponding before luma SAO signal, the difference between the collocated pixel in current corresponding before luma SAO signal and current corresponding luma pixel are used as CCALF equation input.

In the fourth method, it is proposed to take the spatial neighboring pixels from the stage right before luma deblocking signal as additional CCALF equation input. Various filter shapes may be used to extract the information from the stage right before luma deblocking signal. For example, the filter shape may be 3×4 as shown in FIG. 8C. Various equation forms may be used to extract the information from the stage right before luma deblocking signal. In an embodiment, the differences between the surrounding pixels from the stage right before luma deblocking signal and current corresponding luma pixel are used as CCALF equation input. In another example, the differences between the surrounding pixels from the stage right before luma deblocking signal and the collocated pixel in current corresponding before luma deblocking signal, the difference between the collocated pixel in current corresponding before luma deblocking signal and current corresponding luma pixel are used as CCALF equation input.

In the fifth method, it is proposed to take the information in luma prediction, residual, before SAO or before deblocking signal as CCALF equation input. The utilization method proposed in the first, second third, fourth method may be combined to achieve the fifth method.

### New Classifiers Utilized the Coding Mode Information

According to the one or more embodiments of the disclosure, the coding mode information such as whether the coding block is coded with skip mode, whether the coding block is coded with intra, inter P or inter B mode, is utilized to derive new classifiers for online ALF filter. Different methods may be used to achieve this goal.

In the first method, it is proposed to record whether the coding block is coded with skip mode during the encoding and decoding process, then this information is utilized to design a new classifier. In an embodiment, the classifier which has 2 classes corresponding to the skip mode is true or false is added as a new classifier. In another example, the classifier which combines the skip mode information with EO or BO is added as a new classifier.

In the second method, it is proposed to record whether the coding block is coded with intra mode, inter P mode, or inter B mode during the encoding and decoding process, then this information is utilized to design a new classifier. In an embodiment, the classifier which has 3 classes corresponding to the intra mode, inter P mode or inter B mode is added as a new classifier. In another example, the classifier which combines the intra, inter P or inter B mode information with EO or BO is added as a new classifier.

In the third method, it is proposed to take both the coding mode information whether the coding block is coded with skip mode, whether the coding block is coded with intra, inter P or inter B mode to design the new classifier. The utilization method proposed in the first and second method may be combined to achieve the third method.

### Line Buffer Reduction for Additional ALF Input

According to the one or more embodiments of the disclosure, when online ALF filter takes samples as additional input from the stages: 1) samples right before deblocking 2) prediction samples 3) residual samples 4) samples right before SAO, etc., there would be line buffers to save these samples, to reduce the line buffer requirements for these additional inputs, according to current line buffer settings in VVC, 4 rows of corresponding luma samples and 2 rows of corresponding chroma samples above horizontal CTU boundaries are assumed to default values, which may save these line buffers. Different methods may be used to achieve this goal.

In the first method, according to current line buffer settings in VVC, it is proposed to assume 4 rows of luma residual samples and 2 rows of chroma residual samples above horizontal CTU boundaries to zero values, assume 4 rows of luma samples and 2 rows of chroma samples above horizontal CTU boundaries from the stages: 1) samples right before deblocking 2) prediction samples 3) samples right before SAO to collocated sample values from the stage samples right after SAO.

In the second method, according to current line buffer settings in VVC, it is proposed to assume 4 rows of luma samples and 2 rows of chroma samples above horizontal CTU boundaries from the stages: 1) samples right before deblocking 2) prediction samples 3) residual samples 4) samples right before SAO, etc. in a repetitive manner with the corresponding nearest sample values in the horizontal CTU boundaries.

In the third method, according to current line buffer settings in VVC, it is proposed to assume 4 rows of luma samples and 2 rows of chroma samples above horizontal CTU boundaries from the stages: 1) samples right before deblocking 2) prediction samples 3) residual samples 4) samples right before SAO, etc. in a mirrored manner, where the first row of luma samples and first row of chroma samples above horizontal CTU boundaries are assumed to the corresponding sample values in the horizontal CTU boundaries, the second row of luma samples and second row of chroma samples above horizontal CTU boundaries are assumed to the corresponding sample values in the first rows of samples below the horizontal CTU boundaries, and so on.

It should be noted that 4 rows of luma samples and 2 rows of chroma samples above horizontal CTU boundaries are current VVC line buffer settings, the specific values may be adjusted according to customized settings.

### Line Buffer Reduction for Additional CCALF Input

According to the one or more embodiments of the disclosure, when CCALF filter takes samples as additional input from the stages: 1) samples right before deblocking 2) prediction samples 3) residual samples 4) samples right before SAO, etc., there would be line buffers to save these samples, to reduce the line buffer requirements for these additional inputs, according to current line buffer settings in VVC, 4 rows of corresponding luma samples above horizontal CTU boundaries are assumed to default values, which may save these line buffers. Different methods may be used to achieve this goal.

In the first method, according to current line buffer settings in VVC, it is proposed to assume 4 rows of luma residual samples above horizontal CTU boundaries to zero values, assume 4 rows of luma samples above horizontal CTU boundaries from the stages: 1) samples right before deblocking 2) prediction samples 3) samples right before SAO to collocated sample values from the stage samples right after SAO.

In the second method, according to current line buffer settings in VVC, it is proposed to assume 4 rows of luma samples above horizontal CTU boundaries from the stages: 1) samples right before deblocking 2) prediction samples 3) residual samples 4) samples right before SAO, etc. in a repetitive manner with the corresponding nearest sample values in the horizontal CTU boundaries.

In the third method, according to current line buffer settings in VVC, it is proposed to assume 4 rows of luma samples above horizontal CTU boundaries from the stages: 1) samples right before deblocking 2) prediction samples 3) residual samples 4) samples right before SAO, etc. in a mirrored manner, where the first row of luma samples above horizontal CTU boundaries are assumed to the corresponding sample values in the horizontal CTU boundaries, the second row of luma samples above horizontal CTU boundaries are assumed to the corresponding sample values in the first row of samples below the horizontal CTU boundaries, and so on.

It should be noted that 4 rows of luma samples above horizontal CTU boundaries are current VVC line buffer settings, the specific values may be adjusted according to customized settings.

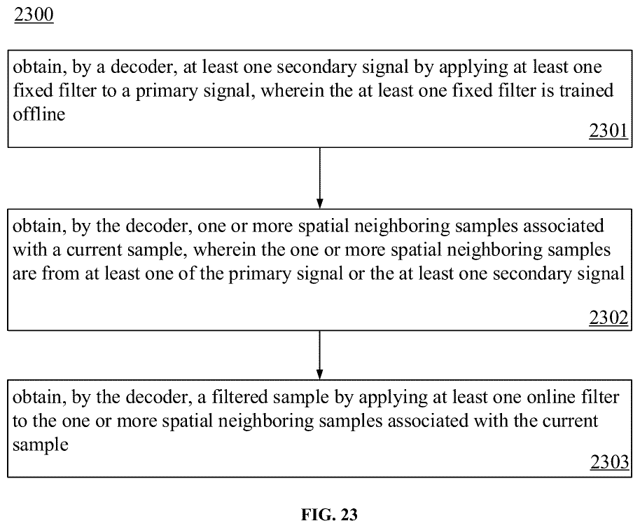

FIG. 23 is a flowchart illustrating a method for video decoding in accordance with some examples of the present disclosure. At step 2301, the method 2300 includes: obtaining, by a decoder, at least one secondary signal by applying at least one fixed filter to a primary signal, wherein the at least one fixed filter is trained offline. At step 2302, the method 2300 includes: obtaining, by the decoder, one or more spatial neighboring samples associated with a current sample, wherein the one or more spatial neighboring samples are from at least one of the primary signal or the at least one secondary signal. At step 2303, the method 2300 includes: obtaining, by the decoder, a filtered sample by applying at least one online filter to the one or more spatial neighboring samples associated with the current sample.

In an embodiment, the primary signal comprises any one of a prediction signal, a residual signal, or a reconstructed signal, and the reconstructed signal comprises at least one sample prior to sample adaptive offset (SAO) filtering.

In an embodiment, applying the at least one fixed filter to the primary signal includes: utilizing, by the decoder, first block level classification results, which are calculated for a signal comprising at least one sample after SAO filtering, to determine the at least one fixed filter; or calculating, by the decoder, second block level classification results based on the primary signal.

In an embodiment, obtaining the at least one secondary signal by applying the at least one fixed filter to the primary signal includes: obtaining multiple secondary signals by applying multiple fixed filters to the primary signal, wherein the multiple fixed filters are trained based on different block level classifiers.

In an embodiment, multiple fixed filter groups are provided, and applying the at least one fixed filter to the primary signal includes: determining, by the decoder, the at least one fixed filter by selecting a fixed filter group indicated by a first group index, wherein the first group index is same to a second group index utilized for an after SAO filtering signal; or determining, by the decoder, the at least one fixed filter by selecting a fixed filter group indicated by a first group index, where the first group index is different from a second group index utilized for an after SAO filtering signal based on a predefined criterion; or in response to receiving, by the decoder, a group index from an encoder, determining the at least one fixed filter by selecting a fixed filter group indicated by the group index.

In an embodiment, two fixed filter groups are provided and a first group index utilized for the primary signal is different from a second group index utilized for an after SAO filtering signal based on a predefined criterion; wherein the method 2300 further includes: in response to that the second group index utilized for the after SAO filtering signal is 0, determining the first group index utilized for the primary signal as 1; or, in response to that the second group index utilized for the after SAO filtering signal is 1, determining the first group index utilized for the primary signal as 0.

In an embodiment, one filter group of the multiple fixed filter groups includes two 13×13 diamond shape fixed filters.

In an embodiment, the primary signal includes a residual signal, and the method 2300 further includes: clipping, by the decoder, the at least one secondary signal into at least one updated range.

In an embodiment, the at least one updated range includes at least one of (−1024, 1024), (−512, 512), (−256, 256), or (−128, 128).

In an embodiment, applying the at least one online filter to the one or more spatial neighboring samples associated with the current sample includes: applying multiple online filters to the one or more spatial neighboring samples, wherein the multiple online filters are associated with multiple filter shapes.

In an embodiment, the multiple filter shapes include anyone or any combination of 1×1, 3×3, or 5×5.

In an embodiment, the primary signal includes a prediction signal or a reconstruction signal prior to SAO filtering, and obtaining the filtered sample by applying the at least one online filter to the one or more spatial neighboring samples associated with the current sample includes: obtaining, by the decoder, clipped difference based on the one or more spatial neighboring samples and the current sample; and obtaining, by the decoder, the filtered sample by applying the at least one online filter to the clipped difference.

In an embodiment, the primary signal includes a prediction signal or a reconstruction signal prior to SAO filtering, and obtaining the filtered sample by applying the at least one online filter to the one or more spatial neighboring samples associated with the current sample includes: obtaining, by the decoder, clipped difference based on the one or more spatial neighboring samples and collocated samples corresponding to the one or more spatial neighboring samples, and clipped difference based on the collocated samples and the current sample; and obtaining, by the decoder, the filtered sample by applying the at least one online filter to the clipped difference. In some embodiments, the one or more spatial neighboring samples may be from the primary signal or the secondary signal. If the one or more spatial neighboring samples are from the primary signal, the collocated samples are from the primary signal; if the spatial neighboring samples are from the secondary signal, the collocated samples are from the secondary signal.

In an embodiment, the primary signal includes a residual signal, and obtaining the filtered sample by applying the at least one online filter to the one or more spatial neighboring samples associated with the current sample includes: obtaining, by the decoder, clipped results based on the one or more spatial neighboring samples; and obtaining, by the decoder, the filtered sample by applying the at least one online filter to the clipped results.

In an embodiment, obtaining the one or more spatial neighboring samples associated with the current sample includes: in response to conducting an All Intra test, determining the one or more spatial neighboring samples from the primary signal; or in response to conducting a Random Access test, determining the one or more spatial neighboring samples from the primary signal and the at least one secondary signal.

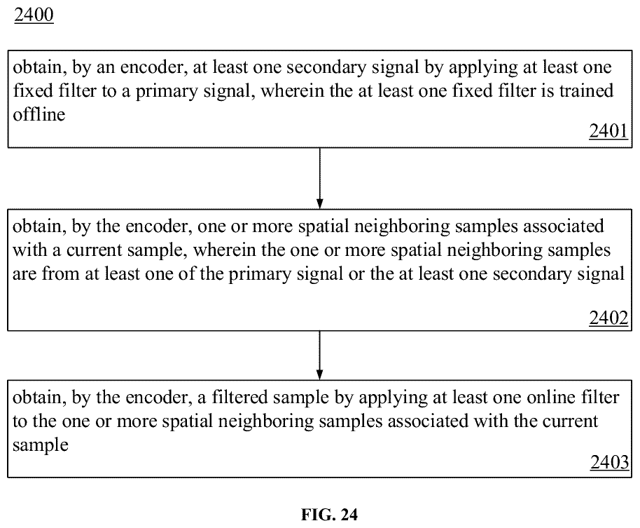

FIG. 24 is a flowchart illustrating a method for video encoding in accordance with some examples of the present disclosure. At step 2401, the method 2400 includes obtaining, by an encoder, at least one secondary signal by applying at least one fixed filter to a primary signal, wherein the at least one fixed filter is trained offline. At step 2402, the method 2400 includes: obtaining, by the encoder, one or more spatial neighboring samples associated with a current sample, wherein the one or more spatial neighboring samples are from at least one of the primary signal or the at least one secondary signal. At step 2403, the method 2400 includes: obtaining, by the encoder, a filtered sample by applying at least one online filter to the one or more spatial neighboring samples associated with the current sample.

In an embodiment, the primary signal includes any one of a prediction signal, a residual signal, or a reconstructed signal, and the reconstructed signal includes at least one sample prior to sample adaptive offset (SAO) filtering.

In an embodiment, applying the at least one fixed filter to the primary signal includes: utilizing, by the encoder, first block level classification results, which are calculated for a signal including at least one sample after SAO filtering, to determine the at least one fixed filter; or calculating, by the encoder, second block level classification results based on the primary signal.

In an embodiment, obtaining the at least one secondary signal by applying the at least one fixed filter to the primary signal includes: obtaining multiple secondary signals by applying multiple fixed filters to the primary signal, wherein the multiple fixed filters are trained based on different block level classifiers.

In an embodiment, multiple fixed filter groups are provided, and applying the at least one fixed filter to the primary signal includes: determining, by the encoder, the at least one fixed filter by selecting a fixed filter group indicated by a first group index, where the first group index is same to a second group index utilized for an after SAO filtering signal; or determining, by the encoder, the at least one fixed filter by selecting a fixed filter group indicated by a first group index, where the first group index is different from a second group index utilized for an after SAO filtering signal based on a predefined criterion; or sending, by the encoder, a group index to a decoder to indicate a selection of a fixed filter group of the multiple fixed filter groups, where the group index is determined through a rate distortion optimization process.

In an embodiment, two fixed filter groups are provided and a first group index utilized for the primary signal is different from a second group index utilized for the after SAO filtering signal based on a predefined criterion; wherein the method 2400 further includes: in response to that the second group index utilized for the after SAO filtering signal is 0, determining the first group index utilized for the primary signal as 1; or, in response to that the second group index utilized for the after SAO filtering signal is 1, determining the first group index utilized for the primary signal as 0.

In an embodiment, one filter group of the multiple fixed filter groups includes two 13×13 diamond shape fixed filters.

In an embodiment, the primary signal includes a residual signal, and the method 2400 further includes: clipping, by the encoder, the at least one secondary signal into at least one updated range.

In an embodiment, the at least one updated range includes at least one of (−1024, 1024), (−512, 512), (−256, 256), or (−128, 128).

In an embodiment, applying the at least one online filter to the one or more spatial neighboring samples associated with the current sample includes: applying multiple online filters to the one or more spatial neighboring samples, wherein the multiple online filters are associated with multiple filter shapes.

In an embodiment, the multiple filter shapes include anyone or any combination of 1×1, 3×3, or 5×5.

In an embodiment, the primary signal includes a prediction signal or a reconstruction signal prior to SAO filtering, and obtaining the filtered sample by applying the at least one online filter to the one or more spatial neighboring samples associated with the current sample includes: obtaining, by the encoder, clipped difference based on the one or more spatial neighboring samples and the current sample; and obtaining, by the encoder, the filtered sample by applying the at least one online filter to the clipped difference.

In an embodiment, the primary signal includes a prediction signal or a reconstruction signal prior to SAO filtering, and obtaining the filtered sample by applying the at least one online filter to the one or more spatial neighboring samples associated with the current sample includes: obtaining, by the encoder, clipped difference based on the one or more spatial neighboring samples and the collocated samples corresponding to the one or more spatial neighboring samples, and clipped difference based on the collocated samples and the current sample; and obtaining, by the encoder, the filtered sample by applying the at least one online filter to the clipped difference. In some embodiments, the one or more spatial neighboring samples may be from the primary signal or the secondary signal. If the one or more spatial neighboring samples are from the primary signal, the collocated samples are from the primary signal; if the spatial neighboring samples are from the secondary signal, the collocated samples are from the secondary signal.

In an embodiment, the primary signal includes a residual signal, and obtaining the filtered sample by applying the at least one online filter to the one or more spatial neighboring samples associated with the current sample includes: obtaining, by the encoder, clipped results based on the one or more spatial neighboring samples; and obtaining, by the encoder, the filtered sample by applying the at least one online filter to the clipped results.

In an embodiment, obtaining the one or more spatial neighboring samples associated with the current sample includes: in response to conducting an All Intra test, determining the one or more spatial neighboring samples from the primary signal; or in response to conducting a Random Access test, determining the one or more spatial neighboring samples from the primary signal and the at least one secondary signal.

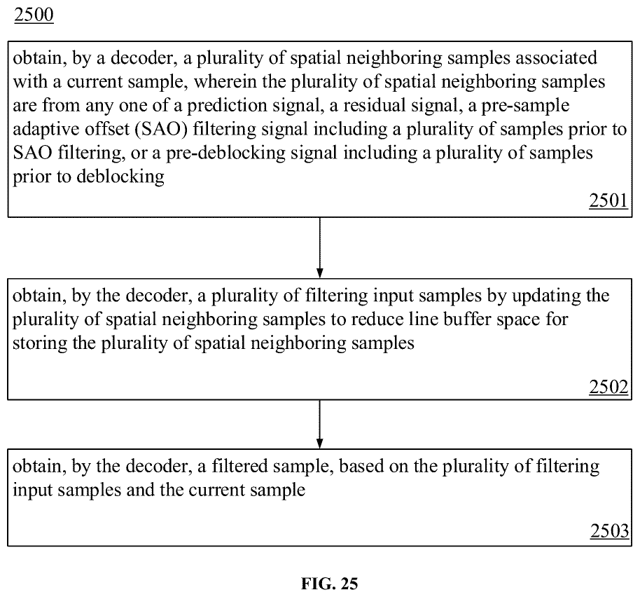

FIG. 25 is a flowchart illustrating a method for video decoding in accordance with some examples of the present disclosure. At step 2501, the method 2500 includes: obtaining, by a decoder, a plurality of spatial neighboring samples associated with a current sample, wherein the plurality of spatial neighboring samples are from any one of a prediction signal, a residual signal, a pre-sample adaptive offset (SAO) filtering signal including a plurality of samples prior to SAO filtering, or a pre-deblocking signal including a plurality of samples prior to deblocking. At step 2502, the method 2500 includes: obtaining, by the decoder, a plurality of filtering input samples by updating the plurality of spatial neighboring samples to reduce line buffer space for storing the plurality of spatial neighboring samples. At step 2503, the method 2500 includes: obtaining, by the decoder, a filtered sample, based on the plurality of filtering input samples and the current sample.

In an embodiment, obtaining the plurality of filtering input samples by updating the plurality of spatial neighboring samples to reduce line buffer space for storing the plurality of spatial neighboring samples includes: updating a plurality of luma samples above a horizontal boundary of a coding tree unit, and a plurality of chroma samples above the horizontal boundary.

In an embodiment, the plurality of luma samples include 4 rows of luma samples above the horizontal boundary and 2 rows of chroma samples above the horizontal boundary.

In an embodiment, the plurality of spatial neighboring samples are from the residual signal, and updating the plurality of luma samples and the plurality of chroma samples includes: updating the plurality of luma samples and the plurality of chroma samples to zero values.

In an embodiment, the plurality of spatial neighboring samples are from any one of the prediction signal, the pre-SAO filtering signal, or the pre-deblocking signal, and updating the plurality of luma samples and the plurality of chroma samples includes: updating the plurality of luma samples and the plurality of chroma to collocated sample values of samples after SAO.

In an embodiment, updating the plurality of luma samples and the plurality of chroma samples includes: updating the plurality of luma samples and the plurality of chroma samples by respectively duplicating corresponding rows of luma samples and corresponding rows of chroma samples, wherein both corresponding rows of luma samples and corresponding rows of chroma samples are at the horizontal boundary in the coding tree unit.

In an embodiment, updating the plurality of luma samples and the plurality of chroma samples includes: updating the plurality of luma samples and the plurality of chroma samples by respectively mirroring corresponding rows of luma samples and corresponding rows of chroma samples, wherein both corresponding rows of luma samples and corresponding rows of chroma samples are at or below the horizontal boundary in the coding tree unit.

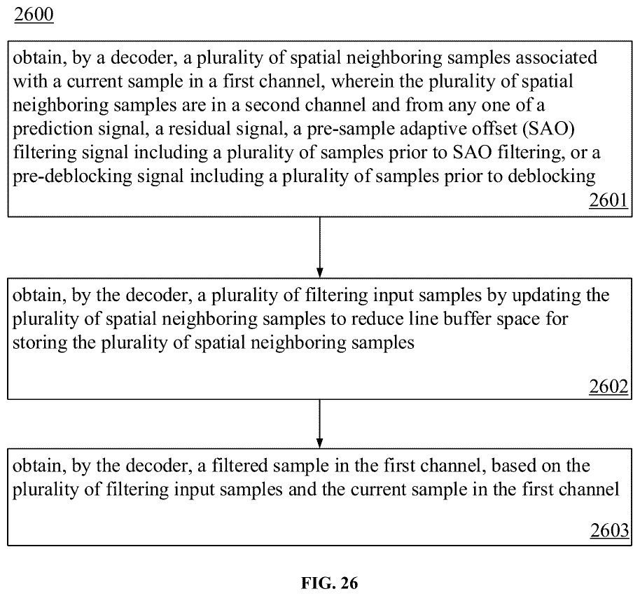

FIG. 26 is a flowchart illustrating a method for video decoding in accordance with some examples of the present disclosure. At step 2601, the method 2600 includes: obtaining, by a decoder, a plurality of spatial neighboring samples associated with a current sample in a first channel, wherein the plurality of spatial neighboring samples are in a second channel and from any one of a prediction signal, a residual signal, a pre-sample adaptive offset (SAO) filtering signal including a plurality of samples prior to SAO filtering, or a pre-deblocking signal including a plurality of samples prior to deblocking. At step 2602, the method 2600 includes: obtaining, by the decoder, a plurality of filtering input samples by updating the plurality of spatial neighboring samples to reduce line buffer space for storing the plurality of spatial neighboring samples. At step 2603, the method 2600 includes: obtaining, by the decoder, a filtered sample in the first channel, based on the plurality of filtering input samples and the current sample in the first channel.

In an embodiment, the first channel is a chroma channel, and the second channel is a luma channel.

In an embodiment, obtaining the plurality of filtering input samples by updating the plurality of spatial neighboring samples to reduce line buffer space for storing the plurality of spatial neighboring samples includes: updating a plurality of samples in the second channel above a horizontal boundary of a coding tree unit.

In an embodiment, the plurality of samples in the second channel include 4 rows of samples in the second channel above the horizontal boundary.

In an embodiment, the plurality of spatial neighboring samples are from the residual signal, and updating the plurality of samples in the second channel includes: updating the plurality of samples in the second channel to zero values.

In an embodiment, the plurality of spatial neighboring samples are from any one of the prediction signal, the pre-SAO filtering signal, or the pre-deblocking signal, and updating the plurality of samples in the second channel includes: updating the plurality of samples in the second channel to collocated sample values of samples after SAO.

In an embodiment, updating the plurality of samples in the second channel includes: updating the plurality of samples in the second channel by duplicating corresponding rows of samples in the second channel at the horizontal boundary in the coding tree unit.

In an embodiment, updating the plurality of samples in the second channel includes: updating the plurality of samples in the second channel by mirroring corresponding rows of samples in the second channel at or below the horizontal boundary in the coding tree unit.

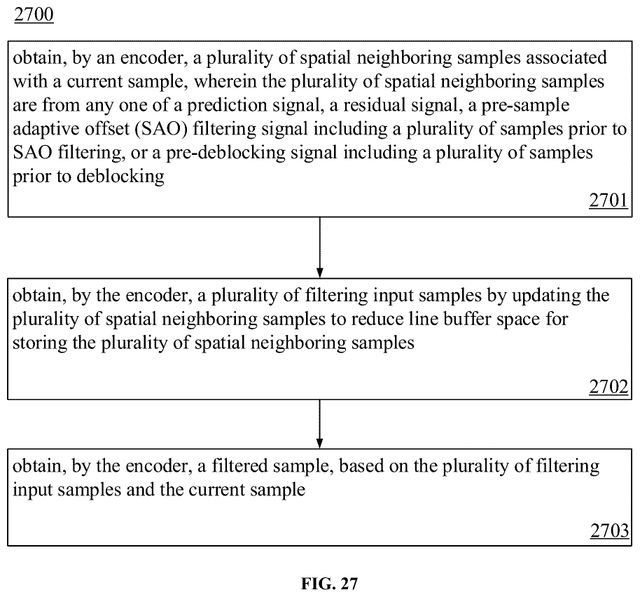

FIG. 27 is a flowchart illustrating a method for video encoding in accordance with some examples of the present disclosure. At step 2701, the method 2700 includes: obtaining, by an encoder, a plurality of spatial neighboring samples associated with a current sample, wherein the plurality of spatial neighboring samples are from any one of a prediction signal, a residual signal, a pre-sample adaptive offset (SAO) filtering signal including a plurality of samples prior to SAO filtering, or a pre-deblocking signal including a plurality of samples prior to deblocking. At step 2702, the method 2700 includes: obtaining, by the encoder, a plurality of filtering input samples by updating the plurality of spatial neighboring samples to reduce line buffer space for storing the plurality of spatial neighboring samples. At step 2703, the method 2700 includes: obtaining, by the encoder, a filtered sample, based on the plurality of filtering input samples and the current sample.

In an embodiment, obtaining the plurality of filtering input samples by updating the plurality of spatial neighboring samples to reduce line buffer space for storing the plurality of spatial neighboring samples includes: updating a plurality of luma samples above a horizontal boundary of a coding tree unit, and a plurality of chroma samples above the horizontal boundary.

In an embodiment, the plurality of luma samples include 4 rows of luma samples above the horizontal boundary and 2 rows of chroma samples above the horizontal boundary.

In an embodiment, the plurality of spatial neighboring samples are from the residual signal, and updating the plurality of luma samples and the plurality of chroma samples includes: updating the plurality of luma samples and the plurality of chroma samples to zero values.

In an embodiment, the plurality of spatial neighboring samples are from any one of the prediction signal, the pre-SAO filtering signal, or the pre-deblocking signal, and updating the plurality of luma samples and the plurality of chroma samples includes: updating the plurality of luma samples and the plurality of chroma to collocated sample values of samples after SAO.

In an embodiment, updating the plurality of luma samples and the plurality of chroma samples includes: updating the plurality of luma samples and the plurality of chroma samples by respectively duplicating corresponding rows of luma samples and corresponding rows of chroma samples, wherein both corresponding rows of luma samples and corresponding rows of chroma samples are at the horizontal boundary in the coding tree unit.

In an embodiment, updating the plurality of luma samples and the plurality of chroma samples includes: updating the plurality of luma samples and the plurality of chroma samples by respectively mirroring corresponding rows of luma samples and corresponding rows of chroma samples, wherein both corresponding rows of luma samples and corresponding rows of chroma samples are at or below the horizontal boundary in the coding tree unit.

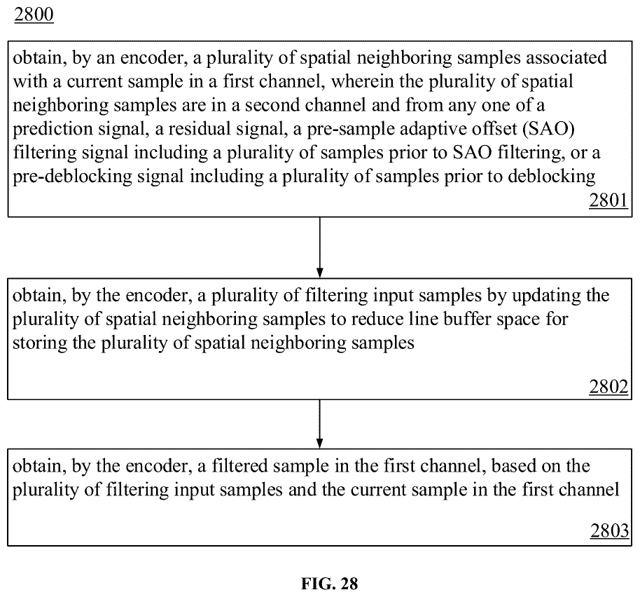

FIG. 28 is a flowchart illustrating a method for video encoding in accordance with some examples of the present disclosure. At step 2801, the method 2800 includes: obtaining, by an encoder, a plurality of spatial neighboring samples associated with a current sample in a first channel, wherein the plurality of spatial neighboring samples are in a second channel and from any one of a prediction signal, a residual signal, a pre-sample adaptive offset (SAO) filtering signal including a plurality of samples prior to SAO filtering, or a pre-deblocking signal including a plurality of samples prior to deblocking. At step 2802, the method 2800 includes: obtaining, by the encoder, a plurality of filtering input samples by updating the plurality of spatial neighboring samples to reduce line buffer space for storing the plurality of spatial neighboring samples. At step 2803, the method 2800 includes: obtaining, by the encoder, a filtered sample in the first channel, based on the plurality of filtering input samples and the current sample in the first channel.

In an embodiment, the first channel is a chroma channel, and the second channel is a luma channel.

In an embodiment, obtaining the plurality of filtering input samples by updating the plurality of spatial neighboring samples to reduce line buffer space for storing the plurality of spatial neighboring samples includes: updating a plurality of samples in the second channel above a horizontal boundary of a coding tree unit.

In an embodiment, the plurality of samples in the second channel include 4 rows of samples in the second channel above the horizontal boundary.

In an embodiment, the plurality of spatial neighboring samples are from the residual signal, and updating the plurality of samples in the second channel includes: updating the plurality of samples in the second channel to zero values.

In an embodiment, the plurality of spatial neighboring samples are from any one of the prediction signal, the pre-SAO filtering signal, or the pre-deblocking signal, and updating the plurality of samples in the second channel includes: updating the plurality of samples in the second channel to collocated sample values of samples after SAO.

In an embodiment, updating the plurality of samples in the second channel includes: updating the plurality of samples in the second channel by duplicating corresponding rows of samples in the second channel at the horizontal boundary in the coding tree unit.

In an embodiment, updating the plurality of samples in the second channel includes: updating the plurality of samples in the second channel by mirroring corresponding rows of samples in the second channel at or below the horizontal boundary in the coding tree unit.

FIG. 29 is a flowchart illustrating a method for video decoding in accordance with some examples of the present disclosure. At step 2901, the method 2900 includes: obtaining, by a decoder, one or more spatial neighboring samples associated with a current sample, wherein the one or more spatial neighboring samples are from a residual signal. At step 2902, the method 2900 includes: deriving, by the decoder, an adaptive loop filter (ALF) classifier for an online ALF process, the ALF classifier utilizing sample values from the residual signal.

In an embodiment, deriving the ALF classifier for the online ALF process includes: computing, by the decoder, a sum of absolute values of sample values of a sub-block in the residual signal; mapping, by the decoder, the sum of absolute values of sample values of the sub-block to an absolute value of a first residual index; computing, by the decoder, a sum of sample values of the sub-block in the residual signal; mapping, by the decoder, the sum of sample values of the sub-block to a sign value of a second residual index; obtaining a class index of the sub-block based on the absolute value of a first residual index and the sign value of a second residual index; and deriving, by the decoder, the ALF classifier based on the class index of the sub-block.

In an embodiment, deriving the ALF classifier for the online ALF process comprises: computing, by the decoder, an index of a sub-block in the residual signal based on sample values in the residual signal, the index referring to an edge based classifier; and deriving, by the decoder, the ALF classifier based on the index of the sub-block.

In an embodiment, deriving the ALF classifier for the online ALF process comprises: computing, by the decoder, an index of a sub-block in the residual signal based on absolute values of sample values in the residual signal, the index referring to an edge based classifier; and deriving, by the decoder, the ALF classifier based on the index of the sub-block.

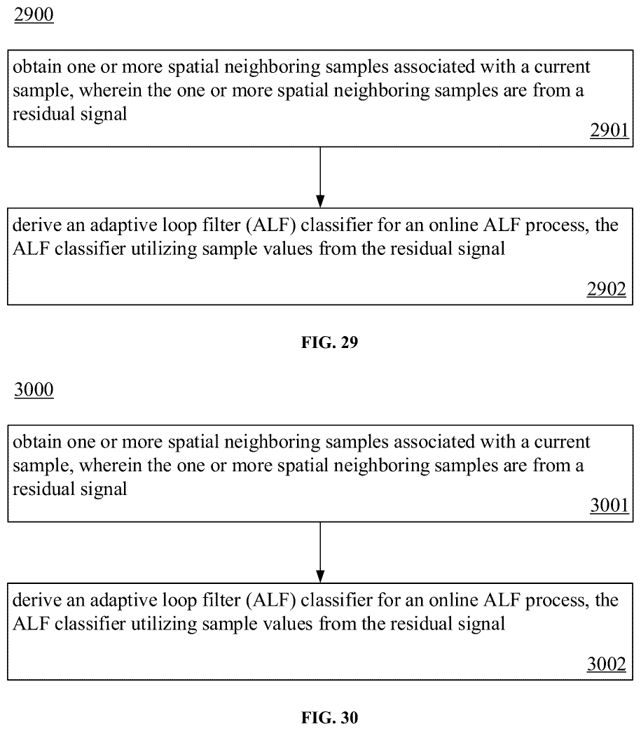

FIG. 30 is a flowchart illustrating a method for video encoding in accordance with some examples of the present disclosure. At step 3001, the method 3000 includes: obtaining, by an encoder, one or more spatial neighboring samples associated with a current sample, wherein the one or more spatial neighboring samples are from a residual signal. At step 3002, the method 3000 includes: deriving, by the encoder, an adaptive loop filter (ALF) classifier for an online ALF process, the ALF classifier utilizing sample values from the residual signal.

In an embodiment, deriving the ALF classifier for the online ALF process includes: computing, by the encoder, a sum of absolute values of sample values of a sub-block in the residual signal; mapping, by the encoder, the sum of absolute values of sample values of the sub-block to an absolute value of a first residual index; computing, by the encoder, a sum of sample values of the sub-block in the residual signal; mapping, by the encoder, the sum of sample values of the sub-block to a sign value of a second residual index; obtaining a class index of the sub-block based on the absolute value of a first residual index and the sign value of a second residual index; and deriving, by the encoder, the ALF classifier based on the class index of the sub-block.

In an embodiment, deriving the ALF classifier for the online ALF process comprises: computing, by the encoder, an index of a sub-block in the residual signal based on sample values in the residual signal, the index referring to an edge based classifier; and deriving, by the encoder, the ALF classifier based on the index of the sub-block.

In an embodiment, deriving the ALF classifier for the online ALF process comprises: computing, by the encoder, an index of a sub-block in the residual signal based on absolute values of sample values in the residual signal, the index referring to an edge based classifier; and deriving, by the encoder, the ALF classifier based on the index of the sub-block.

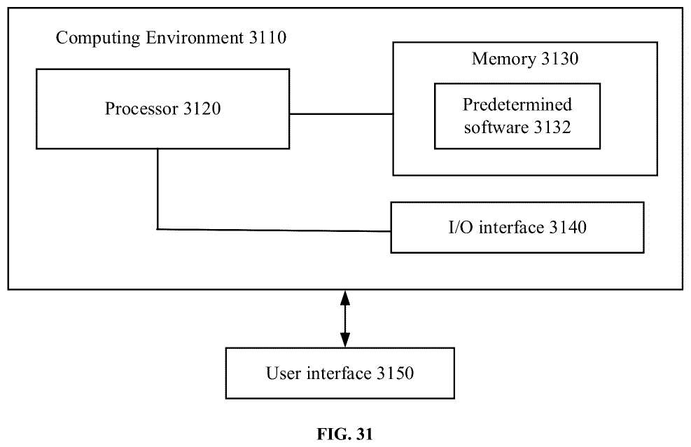

FIG. 31 shows a computing environment 3110 coupled with a user interface 3150. The computing environment 3110 can be part of a data processing server. The computing environment 3110 includes a processor 3120, a memory 3130, and an Input/Output (I/O) interface 3140.

The processor 3120 typically controls overall operations of the computing environment 3110, such as the operations associated with display, data acquisition, data communications, and image processing. The processor 3120 may include one or more processors to execute instructions to perform all or some of the steps in the above-described methods. Moreover, the processor 3120 may include one or more modules that facilitate the interaction between the processor 3120 and other components. The processor may be a Central Processing Unit (CPU), a microprocessor, a single chip machine, a Graphical Processing Unit (GPU), or the like.

The memory 3130 is configured to store various types of data to support the operation of the computing environment 3110. The memory 3130 may include predetermined software 3132. Embodiments of such data includes instructions for any applications or methods operated on the computing environment 3110, video datasets, image data, etc. The memory 3130 may be implemented by using any type of volatile or non-volatile memory devices, or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a magnetic or optical disk.

In one example, the memory 3130 is configured to store instructions executable by the processor; where the processor, upon execution of the instructions, is configured to perform any method as illustrated in FIGS. 11-30.

The I/O interface 3140 provides an interface between the processor 3120 and peripheral interface modules, such as a keyboard, a click wheel, buttons, and the like. The buttons may include but are not limited to, a home button, a start scan button, and a stop scan button. The I/O interface 3140 can be coupled with an encoder and decoder.

In an embodiment, there is also provided a non-transitory computer-readable storage medium comprising a plurality of programs, for example, in the memory 3130, executable by the processor 3120 in the computing environment 3110, for performing the above-described methods and/or storing a bitstream generated by the encoding method described above or a bitstream to be decoded by the decoding method described above. In one example, the plurality of programs may be executed by the processor 3120 in the computing environment 3110 to receive (for example, from the video encoder 20 in FIG. 2A) a bitstream or data stream including encoded video information (for example, video blocks representing encoded video frames, and/or associated one or more syntax elements, etc.), and may also be executed by the processor 3120 in the computing environment 3110 to perform the decoding method described above according to the received bitstream or data stream. In another example, the plurality of programs may be executed by the processor 3120 in the computing environment 3110 to perform the encoding method described above to encode video information (for example, video blocks representing video frames, and/or associated one or more syntax elements, etc.) into a bitstream or data stream, and may also be executed by the processor 3120 in the computing environment 3110 to transmit the bitstream or data stream (for example, to the video decoder 30 in FIG. 3A).

In an embodiment, there is provided a bitstream generated by the encoding method described above or a bitstream to be decoded by the decoding method described above. In an embodiment, there is provided a bitstream comprising encoded video information generated by the encoding method described above or encoded video information to be decoded by the decoding method described above.

Alternatively, the non-transitory computer-readable storage medium may have stored therein a bitstream or a data stream comprising encoded video information (for example, video information comprising one or more syntax elements, video blocks representing encoded video frames, and/or associated one or more syntax elements, etc.) generated by an encoder (for example, the video encoder 20 in FIG. 2A) using, for example, the encoding method described above for use by a decoder (for example, the video decoder 30 in FIG. 3A) in decoding video data. The non-transitory computer-readable storage medium may be, for example, a ROM, a Random Access Memory (RAM), a CD-ROM, a magnetic tape, a floppy disc, an optical data storage device or the like.

In an embodiment, the is also provided a computing device comprising one or more processors (for example, the processor 3120); and the non-transitory computer-readable storage medium or the memory 3130 having stored therein a plurality of programs executable by the one or more processors, wherein the one or more processors, upon execution of the plurality of programs, are configured to perform the above-described methods.

In an embodiment, there is also provided a computer program product having instructions for storage or transmission of a bitstream comprising encoded video information generated by the encoding method described above or encoded video information to be decoded by the decoding method described above. In an embodiment, there is also provided a computer program product comprising a plurality of programs, for example, in the memory 3130, executable by the processor 3120 in the computing environment 3110, for performing the above-described methods. For example, the computer program product may include the non-transitory computer-readable storage medium.

In an embodiment, the computing environment 3110 may be implemented with one or more ASICs, DSPs, Digital Signal Processing Devices (DSPDs), Programmable Logic Devices (PLDs), FPGAs, GPUs, controllers, micro-controllers, microprocessors, or other electronic components, for performing the above methods.

In an embodiment, there is also provided a method of storing a bitstream, comprising storing the bitstream on a digital storage medium, wherein the bitstream comprises encoded video information generated by the encoding method described above or encoded video information to be decoded by the decoding method described above.

In an embodiment, there is also provided a method for transmitting a bitstream generated by the encoder described above. In an embodiment, there is also provided a method for receiving a bitstream to be decoded by the decoder described above.

The description of the present disclosure has been presented for purposes of illustration and is not intended to be exhaustive or limited to the present disclosure. Many modifications, variations, and alternative implementations will be apparent to those of ordinary skill in the art having the benefit of the teachings presented in the foregoing descriptions and the associated drawings.

Unless specifically stated otherwise, an order of steps of the method according to the present disclosure is only intended to be illustrative, and the steps of the method according to the present disclosure are not limited to the order specifically described above, but may be changed according to practical conditions. In addition, at least one of the steps of the method according to the present disclosure may be adjusted, combined or deleted according to practical requirements.

The embodiments were chosen and described in order to explain the principles of the disclosure and to enable others skilled in the art to understand the disclosure for various implementations and to best utilize the underlying principles and various implementations with various modifications as are suited to the particular use contemplated. Therefore, it is to be understood that the scope of the disclosure is not to be limited to the specific embodiments of the implementations disclosed and that modifications and other implementations are intended to be included within the scope of the present disclosure.

The above methods may be implemented using an apparatus that includes one or more circuitries, which include application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components. The apparatus may use the circuitries in combination with the other hardware or software components for performing the above described methods. Each module, sub-module, unit, or sub-unit disclosed above may be implemented at least partially using the one or more circuitries.

Other embodiments of the disclosure will be apparent to those skilled in the art from consideration of the specification and practice of the disclosure disclosed here. This application is intended to cover any variations, uses, or adaptations of the disclosure following the general principles thereof and including such departures from the present disclosure as come within known or customary practice in the art. It is intended that the specification and embodiments be considered as exemplary only. The specification and embodiments are considered as exemplary. The application is intended to cover any variations, uses, or adaptations of the disclosure.

It will be appreciated that the present disclosure is not limited to the exact embodiments described above and illustrated in the accompanying drawings, and that various modifications and changes can be made without departing from the scope thereof.

Various aspects of the present invention may be appreciated from the following Enumerated Example Embodiments (EEEs).

EEE 1_1. A method for video decoding, comprising: obtaining, by a decoder, one or more spatial neighboring samples associated with a current sample, wherein the one or more spatial neighboring samples are from at least one of: (i) a prediction sample, (ii) a residual sample, or (iii) a reconstructed sample, and wherein the reconstructed sample is sample prior to sample adaptive offset (SAO) filtering; and obtaining, by the decoder, a filtered sample, based on the one or more spatial neighboring samples associated with the current sample.

EEE 1_2. The method for video decoding of EEE 1_1, further comprising: obtaining, by the decoder, clipped results based on one or more spatial neighboring samples from the residual sample associated with the current sample; and obtaining, by the decoder, the filtered sample using clipped results based on one or more spatial neighboring samples from the residual sample associated with the current sample and one or more filter coefficients, the one or more filter coefficients associated with different filter shapes.

EEE 1_3. The method for video decoding of EEE 1_2, wherein the clipped results comprise clipped results of one or more surrounding samples, wherein the one or more surrounding samples are from one or more spatial neighboring samples from the residual samples.

EEE 1_4. A method for video encoding, comprising: obtaining, by an encoder, one or more spatial neighboring samples associated with a current sample, wherein the one or more spatial neighboring samples are from at least one of: (i) a prediction sample, (ii) a residual sample, or (iii) a reconstructed sample, and wherein the reconstructed sample is sample prior to sample adaptive offset (SAO) filtering; and obtaining, by the encoder, a filtered sample, based on one or more spatial neighboring samples associated with the current sample.

EEE 1_5. The method for video encoding of EEE 1_4, further comprising: obtaining, by the encoder, clipped results based on one or more spatial neighboring samples from the residual sample associated with the current sample; and obtaining, by the encoder, the filtered sample using clipped results based on one or more spatial neighboring samples from the residual sample associated with the current sample and one or more filter coefficients, the one or more filter coefficients associated with different filter shapes.

EEE 1_6. The method for video encoding of EEE 1_5, wherein the clipped results comprise clipped results of one or more surrounding samples, wherein the one or more surrounding samples are from one or more spatial neighboring samples from the residual sample.

EEE 1_7. A method for video decoding, comprising: obtaining, by a decoder, one or more spatial neighboring samples associated with a current sample; and deriving, by the decoder, an adaptive loop filter (ALF) classifier for an online ALF process, the ALF classifier utilizing one or more spatial neighboring samples before a deblocking filter.

EEE 1_8. The method for video decoding of EEE 1_7, further comprising: obtaining, by the decoder, a first feature by computing directionality of a sub-block of a luma component; obtaining, by the decoder, a second feature by calculating a sum of differences values between a sample after a sample adaptive offset (SAO) process and a collocated sample before a deblocking filter of the sub-block; mapping, by the decoder, the sum to a difference index; and deriving, by the decoder, a combined classifier for the online ALF process based on the first feature and the second feature.

EEE 1_9. The method for video decoding of EEE 1_7, further comprising: obtaining, by the decoder, a first feature by computing an activity value of a sub-block of a luma component; obtaining, by the decoder, a second feature by calculating a sum of difference values between a sample after a sample adaptive offset (SAO) process and a collocated sample before a deblocking filter of the sub-block; mapping, by the decoder, the sum to a difference index; and deriving, by the decoder, a combined classifier for the online ALF process based on the first feature and the second feature.

EEE 1_10. The method for video decoding of EEE 1_7, further comprising: obtaining, by the decoder, a first feature by computing an ALF edge based classifier index of a sub-block of a luma component; obtaining, by the decoder, a second feature by calculating a sum of difference values between a sample after a sample adaptive offset (SAO) process and a collocated sample before a deblocking filter of the sub-block; mapping, by the decoder, the sum to a difference index; and deriving, by the decoder, a combined classifier for the online ALF process based on the first feature and the second feature.

EEE 1_11. The method for video decoding of EEE 1_7, further comprising: obtaining, by the decoder, a first feature based on a band index of a sub-block of a luma component; obtaining, by the decoder, a second feature by calculating a sum of difference values between a sample after a sample adaptive offset (SAO) process and a collocated sample before a deblocking filter; mapping, by the decoder, the sum to a difference index; and deriving, by the decoder, a combined classifier for the online ALF process based on the first feature and the second feature.

EEE 1_12. The method for video decoding of any one of EEEs 1_8 to 1_11, wherein the difference index is used as a class index.

EEE 1_13. The method for video decoding of EEE 1_7, further comprising: deriving, by the decoder, a new classifier for the online ALF process by computing an ALF edge based classifier index based on the samples before a deblocking filter.

EEE 1_14. The method for video decoding of EEE 1_7, further comprising: deriving, by the decoder, a new classifier for the online ALF process by computing a band index based on the samples before a deblocking filter.

EEE 1_15. A method for video encoding, comprising: obtaining, by an encoder, a reconstructed video frame comprising a plurality of pixels; and deriving, by the encoder, an adaptive loop filter (ALF) classifier for an online ALF process, the ALF classifier utilizing pixel values before a deblocking filter.

EEE 1_16. The method for video encoding of EEE 1_15, further comprising: obtaining, by an encoder, a first feature by computing a directionality of a sub-block of a luma component; obtaining, by the encoder, a second feature by calculating a sum of difference values between a sample after a sample adaptive offset (SAO) process and a collocated sample before a deblocking filter of the sub-block; mapping, by the encoder, the sum to a difference index; and deriving, by the encoder, a combined classifier for the online ALF process based on the first feature and the second feature.

EEE 1_17. The method for video encoding of EEE 1_15, further comprising: obtaining, by an encoder, a first feature by computing an activity value of a sub-block of a luma component; obtaining, by the encoder, a second feature by calculating a sum of difference values between a sample after a sample adaptive offset (SAO) process and a collocated sample before a deblocking filter of the sub-block; mapping, by the encoder, the sum to a difference index; and deriving, by the encoder, a combined classifier for the online ALF process based on the first feature and the second feature.

EEE 1_18. The method for video encoding of EEE 1_15, further comprising: obtaining, by the encoder, a first feature by computing an ALF edge based classifier index of a sub-block of a luma component; obtaining, by the encoder, a second feature by calculating a sum of difference values between a sample after a sample adaptive offset (SAO) process and a collocated sample before a deblocking filter of the sub-block; mapping, by the encoder, the sum to a difference index; and deriving, by the encoder, a combined classifier for the online ALF process based on the first feature and the second feature.

EEE 1_19. The method for video encoding of EEE 1_15, further comprising: obtaining, by the encoder, a first feature based on a band index of a sub-block of a luma component; obtaining, by the encoder, a second feature by calculating a sum of difference values between a sample after a sample adaptive offset (SAO) process and a collocated sample before a deblocking filter; mapping, by the encoder, the sum to a difference index; and deriving, by the encoder, a combined classifier for the online ALF process based on the first feature and the second feature.

EEE 1_20. The method for video encoding of any one of EEEs 1_16 to 1_19, wherein the difference index is used as a class index.

EEE 1_21. The method for video encoding of EEE 1_15, further comprising: deriving, by the encoder, a new classifier for the online ALF process by computing an ALF edge based classifier index based on samples before a deblocking filter.

EEE 1_22. The method for video encoding of EEE 1_15, further comprising: deriving, by the encoder, a new classifier for the online ALF process by computing a band index based on samples before a deblocking filter.

EEE 1_23. A method for video decoding, comprising: obtaining, by a decoder, one or more spatial neighboring samples associated with a current sample, wherein the one or more spatial neighboring samples are from a prediction sample; and deriving, by the decoder, an adaptive loop filter (ALF) classifier for an online ALF process, the ALF classifier utilizing sample values from the prediction sample.

EEE 1_24. The method for video decoding of EEE 1_23, further comprising: obtaining, by the decoder, a first feature by computing directionality of a sub-block of a luma component; obtaining, by the decoder, a second feature by calculating a sum of difference between a sample after a sample adaptive offset (SAO) process and a collocated sample in the prediction sample; mapping, by the decoder, the sum of difference values to a difference index; and deriving, by the decoder, a combined classifier for the online ALF process based on the first feature and the second feature.

EEE 1_25. The method for video decoding of EEE 1_23, further comprising: obtaining, by the decoder, a first feature by computing an activity value of a sub-block of a luma component; obtaining, by the decoder, a second feature by calculating a sum of difference values between a sample after a sample adaptive offset (SAO) process and a collocated sample in the prediction sample; mapping, by the decoder, the sum of difference values to a difference index; and deriving, by the decoder, a combined classifier for the online ALF process based on the first feature and the second feature.

EEE 1_26. The method for video decoding of EEE 1_23, further comprising: obtaining, by the decoder, a first feature by computing an ALF edge based classifier index of a sub-block of a luma component; calculating, by the decoder, a second feature by calculating a sum of difference values between a sample after a sample adaptive offset (SAO) process and a collocated sample in the prediction sample; mapping, by the decoder, the sum of difference values to a difference index; and deriving, by the decoder, a combined classifier for the online ALF process based on the first feature and the second feature.

EEE 1_27. The method for video decoding of EEE 1_23, further comprising: obtaining, by the decoder, a first feature by computing a band index of a sub-block of a luma component; calculating, by the decoder, a second feature by calculating a sum of difference values between a sample after a sample adaptive offset (SAO) process and a collocated sample in the prediction sample of the sub-block; mapping, by the decoder, the sum of difference values to a difference index; and deriving, by the decoder, a combined classifier for the online ALF process based on the first feature and the second feature.

EEE 1_28. The method for video decoding of any one of EEEs 1_24 to 1_27, wherein the difference index is used as a class index.

EEE 1_29. The method for video decoding of EEE 1_23, further comprising: deriving, by the decoder, a new classifier for the online ALF process by computing an ALF edge based classifier index based on the samples from the prediction sample.

EEE 1_30. The method for video decoding of EEE 1_23, further comprising: deriving, by the decoder, a new classifier for the online ALF process by computing a band index based on the samples from the prediction sample.

EEE 1_31. A method for video encoding, comprising: obtaining, by the encoder, one or more spatial neighboring samples associated with a current sample, wherein the one or more spatial neighboring samples are from a prediction sample; and deriving, by the encoder, an adaptive loop filter (ALF) classifier for an online ALF process, the ALF classifier utilizing sample values from the prediction sample.

EEE 1_32. The method for video encoding of EEE 1_31, further comprising: obtaining, by the encoder, a first feature by computing directionality of a sub-block of a luma component; obtaining, by the encoder, a second feature by calculating a sum of difference values between a sample after a sample adaptive offset (SAO) process and a collocate sample in the prediction sample; mapping, by the encoder, the sum of the difference values to a difference index; and deriving, by the encoder, a combined classifier for the online ALF process based on the first feature and the second feature.

EEE 1_33. The method for video encoding of EEE 1_31, further comprising: obtaining, by the encoder, a first feature by computing an activity value of a sub-block of a luma component; obtaining, by the encoder, a second feature by calculating a sum of difference values between a sample after a sample adaptive offset (SAO) process and a collocated sample in the prediction sample; mapping, by the encoder, the sum of difference values to a difference index; and deriving, by the encoder, a combined classifier for the online ALF process based on the first feature and the second feature.

EEE 1_34. The method for video encoding of EEE 1_31, further comprising: obtaining, by the encoder, a first feature by computing an ALF edge based classifier index of a sub-block of a luma component; calculating, by the encoder, a second feature by calculating a sum of difference values between a sample after a sample adaptive offset (SAO) process and a collocated sample in the prediction sample; mapping, by the encoder, the sum of difference values to a difference index; and deriving, by the encoder, a combined classifier for the online ALF process based on the first feature and the second feature.

EEE 1_35. The method for video encoding of EEE 1_31, further comprising: obtaining, by the encoder, a first feature by computing a band index of a sub-block of a luma component; calculating, by the encoder, a second feature by calculating a sum of difference values between a sample after a sample adaptive offset (SAO) process and a collocated sample in the prediction sample of the sub-block; mapping, by the encoder, the sum of difference values to a difference index; and deriving, by the encoder, a combined classifier for the online ALF process based on the first feature and the second feature.

EEE 1_36. The method for video encoding of any one of EEEs 1_32 to 1_35, wherein the difference index is used as a class index.

EEE 1_37. The method for video encoding of EEE 1_31, further comprising: deriving, by the encoder, a new classifier for the online ALF process by computing an ALF edge based classifier index based on the samples from the prediction sample.

EEE 1_38. The method for video encoding of EEE 1_31, further comprising: deriving, by the encoder, a new classifier for the online ALF process by computing a band index based on the samples from the prediction sample.

EEE 1_39. A method for video decoding, comprising: obtaining, by the decoder, one or more spatial neighboring samples associated with a current sample, wherein the one or more spatial neighboring samples are from a residual sample; and deriving, by the decoder, an adaptive loop filter (ALF) classifier for an online ALF process, the ALF classifier utilizing sample values from the residual sample.

EEE 1_40. The method for video decoding of EEE 1_39, further comprising: obtaining, by the decoder, a first feature by computing directionality of a sub-block of a luma component; obtaining, by the decoder, a second feature by calculating a sum of sample values in the residual sample; mapping, by the decoder, the sum of sample values to a residual index; and deriving, by the decoder, a combined classifier for the online ALF process based on the first feature and the second feature.

EEE 1_41. The method for video decoding of EEE 1_39, further comprising: obtaining, by the decoder, a first feature by computing an activity value of a sub-block of a luma component; obtaining, by the decoder, a second feature by calculating a sum of sample values in the residual sample; mapping, by the decoder, the sum of sample values to a residual index; and deriving, by the decoder, a combined classifier for the online ALF process based on the first feature and the second feature.

EEE 1_42. The method for video decoding of EEE 1_39, further comprising: obtaining, by the decoder, a first feature by computing an ALF edge based classifier index of a sub-block of a luma component; calculating, by the decoder, a second feature by calculating a sum of sample values in the residual sample; mapping, by the decoder, the sum of sample values to a residual index; and deriving, by the decoder, a combined classifier for the online ALF process based on the first feature and the second feature.

EEE 1_43. The method for video decoding of EEE 1_39, further comprising: obtaining, by the decoder, a first feature by computing a band index of a sub-block of a luma component; calculating, by the decoder, a second feature by calculating a sum of sample values in the residual sample; mapping, by the decoder, the sum of sample values to a residual index; and deriving, by the decoder, a combined classifier for the online ALF process based on the first feature and the second feature.

EEE 1_44. The method for video decoding of any one of EEEs 1_40 to 1_43, wherein the residual index is used as a class index.

EEE 1_45. A method for video encoding, comprising: obtaining, by the encoder, one or more spatial neighboring samples associated with a current sample, wherein the one or more spatial neighboring samples are from a residual sample; and deriving, by the encoder, an adaptive loop filter (ALF) classifier for an online ALF process, the ALF classifier utilizing sample values from the residual sample.

EEE 1_46. The method for video encoding of EEE 1_45, further comprising: obtaining, by the encoder, a first feature by computing directionality of a sub-block of a luma component; obtaining, by the encoder, a second feature by calculating a sum of sample values in the residual sample; mapping, by the encoder, the sum of sample values to a residual index; and deriving, by the encoder, a combined classifier for the online ALF process based on the first feature and the second feature.

EEE 1_47. The method for video encoding of EEE 1_45, further comprising: obtaining, by the encoder, a first feature by computing an activity value of a sub-block of a luma component; obtaining, by the encoder, a second feature by calculating a sum of sample values in the residual sample; mapping, by the encoder, the sum of sample values to a residual index; and deriving, by the encoder, a combined classifier for the online ALF process based on the first feature and the second feature.

EEE 1_48. The method for video encoding of EEE 1_45, further comprising: obtaining, by the encoder, a first feature by computing an ALF edge based classifier index of a sub-block of a luma component; calculating, by the encoder, a second feature by calculating a sum of sample values in the residual sample; mapping, by the encoder, the sum of sample values to a residual index; and deriving, by the encoder, a combined classifier for the online ALF process based on the first feature and the second feature.

EEE 1_49. The method for video encoding of EEE 1_45, further comprising: obtaining, by the encoder, a first feature by computing a band index of a sub-block of a luma component; calculating, by the encoder, a second feature by calculating a sum of sample values in the residual sample; mapping, by the encoder, the sum of sample values to a residual index; and deriving, by the encoder, a combined classifier for the online ALF process based on the first feature and the second feature.

EEE 1_50. The method for video encoding of any one of EEEs 1_46 to 1_49, wherein the residual index is used as a class index.

EEE 1_51. A method for video decoding, comprising: obtaining, by a decoder, one or more spatial neighboring samples associated with a current sample; and deriving, by the decoder, an adaptive loop filter (ALF) classifier for an online ALF process, the ALF classifier utilizing one or more spatial neighboring samples before a sample adaptive offset (SAO) process.

EEE 1_52. The method for video decoding of EEE 1_51, further comprising: obtaining, by the decoder, a first feature by computing directionality of a sub-block of a luma component; obtaining, by the decoder, a second feature by calculating a sum of differences values between a sample after a sample adaptive offset (SAO) process and a collocated sample before a sample adaptive offset (SAO) process of the sub-block; mapping, by the decoder, the sum to a difference index; and deriving, by the decoder, a combined classifier for the online ALF process based on the first feature and the second feature.

EEE 1_53. The method for video decoding of EEE 1_51, further comprising: obtaining, by the decoder, a first feature by computing an activity value of a sub-block of a luma component; obtaining, by the decoder, a second feature by calculating a sum of difference values between a sample after a sample adaptive offset (SAO) process and a collocated sample before a sample adaptive offset (SAO) process of the sub-block; mapping, by the decoder, the sum to a difference index; and deriving, by the decoder, a combined classifier for the online ALF process based on the first feature and the second feature.

EEE 1_54. The method for video decoding of EEE 1_51, further comprising: obtaining, by the decoder, a first feature by computing an ALF edge based classifier index of a sub-block of a luma component; obtaining, by the decoder, a second feature by calculating a sum of difference values between a sample after a sample adaptive offset (SAO) process and a collocated sample before a sample adaptive offset (SAO) process of the sub-block; mapping, by the decoder, the sum to a difference index; and deriving, by the decoder, a combined classifier for the online ALF process based on the first feature and the second feature.

EEE 1_55. The method for video decoding of EEE 1_51, further comprising: obtaining, by the decoder, a first feature based on a band index of a sub-block of a luma component; obtaining, by the decoder, a second feature by calculating a sum of difference values between a sample after a sample adaptive offset (SAO) process and a collocated sample before a sample adaptive offset (SAO) process; mapping, by the decoder, the sum to a difference index; and deriving, by the decoder, a combined classifier for the online ALF process based on the first feature and the second feature.

EEE 1_56. The method for video decoding of any one of EEEs 1_52 to 1_55, wherein the difference index is used as a class index.

EEE 1_57. The method for video decoding of EEE 1_51, further comprising:

deriving, by the decoder, a new classifier for the online ALF process by computing an ALF edge based classifier index based on the samples before a sample adaptive offset (SAO) process.

EEE 1_58. The method for video decoding of EEE 1_51, further comprising: deriving, by the decoder, a new classifier for the online ALF process by computing a band index based on the samples before a sample adaptive offset (SAO) process.

EEE 1_59. A method for video encoding, comprising: obtaining, by an encoder, a reconstructed video frame comprising a plurality of pixels; and deriving, by the encoder, an adaptive loop filter (ALF) classifier for an online ALF process, the ALF classifier utilizing pixel values before a sample adaptive offset (SAO) process.

EEE 1_60. The method for video encoding of EEE 1_59, further comprising: obtaining, by an encoder, a first feature by computing a directionality of a sub-block of a luma component; obtaining, by the encoder, a second feature by calculating a sum of difference values between a sample after a sample adaptive offset (SAO) process and a collocated sample before a sample adaptive offset (SAO) process of the sub-block; mapping, by the encoder, the sum to a difference index; and deriving, by the encoder, a combined classifier for the online ALF process based on the first feature and the second feature.

EEE 1_61. The method for video encoding of EEE 1_59, further comprising: obtaining, by an encoder, a first feature by computing an activity value of a sub-block of a luma component; obtaining, by the encoder, a second feature by calculating a sum of difference values between a sample after a sample adaptive offset (SAO) process and a collocated sample before a sample adaptive offset (SAO) process of the sub-block; mapping, by the encoder, the sum to a difference index; and deriving, by the encoder, a combined classifier for the online ALF process based on the first feature and the second feature.

EEE 1_62. The method for video encoding of EEE 1_59, further comprising: obtaining, by the encoder, a first feature by computing an ALF edge based classifier index of a sub-block of a luma component; obtaining, by the encoder, a second feature by calculating a sum of difference values between a sample after a sample adaptive offset (SAO) process and a collocated sample before a sample adaptive offset (SAO) process of the sub-block; mapping, by the encoder, the sum to a difference index; and deriving, by the encoder, a combined classifier for the online ALF process based on the first feature and the second feature.

EEE 1_63. The method for video encoding of EEE 1_59, further comprising: obtaining, by the encoder, a first feature based on a band index of a sub-block of a luma component; obtaining, by the encoder, a second feature by calculating a sum of difference values between a sample after a sample adaptive offset (SAO) process and a collocated sample before a sample adaptive offset (SAO) process; mapping, by the encoder, the sum to a difference index; and deriving, by the encoder, a combined classifier for the online ALF process based on the first feature and the second feature.

EEE 1_64. The method for video encoding of any one of EEEs 1_60-1_63, wherein the difference index is used as a class index.

EEE 1_65. The method for video encoding of EEE 1_59, further comprising: deriving, by the encoder, a new classifier for the online ALF process by computing an ALF edge based classifier index based on the samples before a sample adaptive offset (SAO) process.

EEE 1_66. The method for video encoding of EEE 1_59, further comprising: deriving, by the encoder, a new classifier for the online ALF process by computing a band index based on the samples before a sample adaptive offset (SAO) process.

EEE 1_67. A method for video decoding, comprising: obtaining, by a decoder, one or more spatial neighboring samples associated with a current sample, wherein the one or more spatial neighboring samples are from a chroma sample; and deriving, by the decoder, an adaptive loop filter (ALF) classifier for an online ALF process, the ALF classifier utilizing sample values from the chroma sample.

EEE 1_68. The method for video decoding of EEE 1_67, further comprising: obtaining, by the decoder, a first feature based on a band index of a sub-block of a luma component; obtaining, by the decoder, a second feature based on a band index of a sub-block of a Cb chroma component; obtaining, by the decoder, a third feature based on a band index of a sub-block of a Cr chroma component; and deriving, by the decoder, a combined classifier for the online ALF process based on the first feature, the second and the third feature.

EEE 1_69. A method for video encoding, comprising: obtaining, by a encoder, one or more spatial neighboring samples associated with a current sample, wherein the one or more spatial neighboring samples are from a chroma sample; and deriving, by the encoder, an adaptive loop filter (ALF) classifier for an online ALF process, the ALF classifier utilizing sample values from the chroma sample.

EEE 1_70. The method for video encoding of EEE 1_69, further comprising: obtaining, by the encoder, a first feature based on a band index of a sub-block of a luma component; obtaining, by the encoder, a second feature based on a band index of a sub-block of a Cb chroma component; obtaining, by the encoder, a third feature based on a band index of a sub-block of a Cr chroma component; and deriving, by the encoder, a combined classifier for the online ALF process based on the first feature, the second and the third feature.

EEE 1_71. An apparatus for video decoding, comprising: one or more processors; and a memory coupled to the one or more processors and configured to store instructions executable by the one or more processors, wherein the one or more processors, upon execution of the instructions are configured to perform the method in any one of EEEs 1_1-1_3, 1_7-1_14, 1_23-1_30, 1_39-1_44, 1_51-1_58, and 1_67-1_68.

EEE 1_72. An apparatus for video encoding, comprising: one or more processors; and a memory coupled to the one or more processors and configured to store instructions executable by the one or more processors, wherein the one or more processors, upon execution of the instructions are configured to perform the method in any one of EEEs 1_4-1_6, 1_15-1_22, 1_31-1_38, 1_45-1_50, 1_59-1_66, and 1_69-1_70.

EEE 1_73. A non-transitory computer readable storage medium for storing computer-executable instructions that, when executed by one or more computer processors, cause the one or more computer processors to perform the method in any one of EEEs 1_1-1_3, 1_7-1_14, 1_23-1_30, 1_39-1_44, 1_51-1_58, and 1_67-1_68.

EEE 1_74. A non-transitory computer readable storage medium for storing computer-executable instructions that, when executed by one or more computer processors, cause the one or more computer processors to perform the method in any one of EEEs 1_4-1_6, 1_15-1_22, 1_31-1_38, 1_45-1_50, 1_59-1_66, and 1_69-1_70.

EEE 2_1. A method for video decoding, comprising: obtaining, by a decoder, at least one secondary signal by applying at least one fixed filter to a primary signal, wherein the at least one fixed filter is trained offline; obtaining, by the decoder, one or more spatial neighboring samples associated with a current sample, wherein the one or more spatial neighboring samples are from at least one of the primary signal or the at least one secondary signal; and obtaining, by the decoder, a filtered sample by applying at least one online filter to the one or more spatial neighboring samples associated with the current sample.

EEE 2_2. The method of EEE 2_1, wherein the primary signal comprises any one of a prediction signal, a residual signal, or a reconstructed signal, and the reconstructed signal comprises at least one sample prior to sample adaptive offset (SAO) filtering.

EEE 2_3. The method of EEE 2_1, wherein applying the at least one fixed filter to the primary signal comprises: utilizing, by the decoder, first block level classification results, which are calculated for a signal comprising at least one sample after SAO filtering, to determine the at least one fixed filter; or calculating, by the decoder, second block level classification results based on the primary signal.

EEE 2_4. The method of EEE 2_1, wherein obtaining the at least one secondary signal by applying the at least one fixed filter to the primary signal comprises: obtaining multiple secondary signals by applying multiple fixed filters to the primary signal, wherein the multiple fixed filters are trained based on different block level classifiers.

EEE 2_5. The method of EEE 2_1, wherein multiple fixed filter groups are provided, and applying the at least one fixed filter to the primary signal comprises: determining, by the decoder, the at least one fixed filter by selecting a fixed filter group indicated by a first group index, wherein the first group index is same to a second group index utilized for an after SAO filtering signal; or determining, by the decoder, the at least one fixed filter by selecting a fixed filter group indicated by a first group index, where the first group index is different from a second group index utilized for an after SAO filtering signal based on a predefined criterion; or in response to receiving, by the decoder, a group index from an encoder, determining the at least one fixed filter by selecting a fixed filter group indicated by the group index.

EEE 2_6. The method of EEE 2_5, wherein two fixed filter groups are provided and a first group index utilized for the primary signal is different from a second group index utilized for an after SAO filtering signal based on a predefined criterion; wherein the method further comprises: in response to that the second group index utilized for the after SAO filtering signal is 0, determining the first group index utilized for the primary signal as 1; or, in response to that the second group index utilized for the after SAO filtering signal is 1, determining the first group index utilized for the primary signal as 0.

EEE 2_7. The method of EEE 2_5, wherein one filter group of the multiple fixed filter groups comprises two 13×13 diamond shape fixed filters.

EEE 2_8. The method of EEE 2_1, wherein the primary signal comprises a residual signal, and the method further comprises: clipping, by the decoder, the at least one secondary signal into at least one updated range.

EEE 2_9. The method of EEE 2_8, wherein the at least one updated range comprises at least one of (−1024, 1024), (−512, 512), (−256, 256), or (−128, 128).

EEE 2_10. The method of EEE 2_1, wherein applying the at least one online filter to the one or more spatial neighboring samples associated with the current sample comprises: applying multiple online filters to the one or more spatial neighboring samples, wherein the multiple online filters are associated with multiple filter shapes.

EEE 2_11. The method of EEE 2_1, wherein the multiple filter shapes comprise anyone or any combination of 1×1, 3×3, or 5×5.

EEE 2_12. The method of EEE 2_1, wherein the primary signal comprises a prediction signal or a reconstruction signal prior to SAO filtering and obtaining the filtered sample by applying the at least one online filter to the one or more spatial neighboring samples associated with the current sample comprises: obtaining, by the decoder, clipped difference based on the one or more spatial neighboring samples and the current sample; and obtaining, by the decoder, the filtered sample by applying the at least one online filter to the clipped difference.

EEE 2_13. The method of EEE 2_1, wherein the primary signal comprises a prediction signal or a reconstruction signal prior to SAO filtering and obtaining the filtered sample by applying the at least one online filter to the one or more spatial neighboring samples associated with the current sample comprises: obtaining, by the decoder, clipped difference based on the one or more spatial neighboring samples and collocated samples corresponding to the one or more spatial neighboring samples, and clipped difference based on the collocated samples and the current sample; and obtaining, by the decoder, the filtered sample by applying the at least one online filter to the clipped difference.

EEE 2_14. The method of EEE 2_1, wherein the primary signal comprises a residual signal and obtaining the filtered sample by applying the at least one online filter to the one or more spatial neighboring samples associated with the current sample comprises: obtaining, by the decoder, clipped results based on the one or more spatial neighboring samples; and obtaining, by the decoder, the filtered sample by applying the at least one online filter to the clipped results.

EEE 2_15. The method of EEE 2_1, wherein obtaining the one or more spatial neighboring samples associated with the current sample comprises: in response to conducting an All Intra test, determining the one or more spatial neighboring samples from the primary signal; or in response to conducting a Random Access test, determining the one or more spatial neighboring samples from the primary signal and the at least one secondary signal.

EEE 2_16. A method for video encoding, comprising: obtaining, by an encoder, at least one secondary signal by applying at least one fixed filter to a primary signal, wherein the at least one fixed filter is trained offline; obtaining, by the encoder, one or more spatial neighboring samples associated with a current sample, wherein the one or more spatial neighboring samples are from at least one of the primary signal or the at least one secondary signal; and obtaining, by the encoder, a filtered sample by applying at least one online filter to the one or more spatial neighboring samples associated with the current sample.

EEE 2_17. The method of EEE 2_16, wherein the primary signal comprises any one of a prediction signal, a residual signal, or a reconstructed signal, and the reconstructed signal comprises at least one sample prior to sample adaptive offset (SAO) filtering.

EEE 2_18. The method of EEE 2_16, wherein applying the at least one fixed filter to the primary signal comprises: utilizing, by the encoder, first block level classification results, which are calculated for a signal comprising at least one sample after SAO filtering, to determine the at least one fixed filter; or calculating, by the encoder, second block level classification results based on the primary signal.

EEE 2_19. The method of EEE 2_16, wherein obtaining the at least one secondary signal by applying the at least one fixed filter to the primary signal comprises: obtaining multiple secondary signals by applying multiple fixed filters to the primary signal, wherein the multiple fixed filters are trained based on different block level classifiers.

EEE 2_20. The method of EEE 2_16, wherein multiple fixed filter groups are provided, and applying the at least one fixed filter to the primary signal comprises: determining, by the encoder, the at least one fixed filter by selecting a fixed filter group indicated by a first group index, where the first group index is same to a second group index utilized for an after SAO filtering signal; or determining, by the encoder, the at least one fixed filter by selecting a fixed filter group indicated by a first group index, where the first group index is different from a second group index utilized for an after SAO filtering signal based on a predefined criterion; or sending, by the encoder, a group index to a decoder to indicate a selection of a fixed filter group of the multiple fixed filter groups, where the group index is determined through a rate distortion optimization process.

EEE 2_21. The method of EEE 2_20, wherein two fixed filter groups are provided and a first group index utilized for the primary signal is different from a second group index utilized for the after SAO filtering signal based on a predefined criterion; wherein the method further comprises: in response to that the second group index utilized for the after SAO filtering signal is 0, determining the first group index utilized for the primary signal as 1; or, in response to that the second group index utilized for the after SAO filtering signal is 1, determining the first group index utilized for the primary signal as 0.

EEE 2_22. The method of EEE 2_20, wherein one filter group of the multiple fixed filter groups comprises two 13×13 diamond shape fixed filters.

EEE 2_23. The method of EEE 2_16, wherein the primary signal comprises a residual signal, and the method further comprises: clipping, by the encoder, the at least one secondary signal into at least one updated range.

EEE 2_24. The method of EEE 2_16, wherein the at least one updated range comprises at least one of (−1024, 1024), (−512, 512), (−256, 256), or (−128, 128).

EEE 2_25. The method of EEE 2_16, wherein applying the at least one online filter to the one or more spatial neighboring samples associated with the current sample comprises: applying multiple online filters to the one or more spatial neighboring samples, wherein the multiple online filters are associated with multiple filter shapes.

EEE 2_26. The method of EEE 2_16, wherein the multiple filter shapes comprise anyone or any combination of 1×1, 3×3, or 5×5.

EEE 2_27. The method of EEE 2_16, wherein the primary signal comprises a prediction signal or a reconstruction signal prior to SAO filtering and obtaining the filtered sample by applying the at least one online filter to the one or more spatial neighboring samples associated with the current sample comprises: obtaining, by the encoder, clipped difference based on the one or more spatial neighboring samples and the current sample; and obtaining, by the encoder, the filtered sample by applying the at least one online filter to the clipped difference.

EEE 2_28. The method of EEE 2_16, wherein the primary signal comprises a prediction signal or a reconstruction signal prior to SAO filtering and obtaining the filtered sample by applying the at least one online filter to the one or more spatial neighboring samples associated with the current sample comprises: obtaining, by the encoder, clipped difference based on the one or more spatial neighboring samples and collocated samples corresponding to the one or more spatial neighboring samples, and clipped difference based on the collocated samples and the current sample; and obtaining, by the encoder, the filtered sample by applying the at least one online filter to the clipped difference.

EEE 2_29. The method of EEE 2_16, wherein the primary signal comprises a residual signal and obtaining the filtered sample by applying the at least one online filter to the one or more spatial neighboring samples associated with the current sample comprises: obtaining, by the encoder, clipped results based on the one or more spatial neighboring samples; and obtaining, by the encoder, the filtered sample by applying the at least one online filter to the clipped results.

EEE 2_30. The method of EEE 2_16, wherein obtaining the one or more spatial neighboring samples associated with the current sample comprises: in response to conducting an All Intra test, determining the one or more spatial neighboring samples from the primary signal; or in response to conducting a Random Access test, determining the one or more spatial neighboring samples from the primary signal and the at least one secondary signal.

EEE 2_31. An apparatus for video decoding, comprising: one or more processors; and a memory coupled to the one or more processors and configured to store instructions executable by the one or more processors, wherein the one or more processors, upon execution of the instructions are configured to perform the method in any one of EEEs 2_1-2_15.

EEE 2_32. An apparatus for video encoding, comprising: one or more processors; and a memory coupled to the one or more processors and configured to store instructions executable by the one or more processors, wherein the one or more processors, upon execution of the instructions are configured to perform the method in any one of EEEs 2_16-2_30.

EEE 2_33. A non-transitory computer readable storage medium for storing computer-executable instructions that, when executed by one or more computer processors, cause the one or more computer processors to perform the method in any one of EEEs 2_1-2_15.

EEE 2_34. A non-transitory computer readable storage medium for storing computer-executable instructions that, when executed by one or more computer processors, cause the one or more computer processors to perform the method in any one of EEEs 2_16-2_30.

EEE 2_35. A non-transitory computer-readable storage medium for storing a bitstream to be decoded by the method in any of EEEs 2_1-2_15.

EEE 2_36. A non-transitory computer-readable storage medium for storing a bitstream generated by the method in any of EEEs 2_16-2_30.

EEE 2_37 A method for video decoding, comprising: obtaining, by a decoder, a plurality of spatial neighboring samples associated with a current sample, wherein the plurality of spatial neighboring samples are from any one of a prediction signal, a residual signal, a pre-sample adaptive offset (SAO) filtering signal comprising a plurality of samples prior to SAO filtering, or a pre-deblocking signal comprising a plurality of samples prior to deblocking; obtaining, by the decoder, a plurality of filtering input samples by updating the plurality of spatial neighboring samples to reduce line buffer space for storing the plurality of spatial neighboring samples; and obtaining, by the decoder, a filtered sample, based on the plurality of filtering input samples and the current sample.

EEE 2_38. The method of EEE 2_37, wherein obtaining the plurality of filtering input samples by updating the plurality of spatial neighboring samples to reduce line buffer space for storing the plurality of spatial neighboring samples comprises: updating a plurality of luma samples above a horizontal boundary of a coding tree unit, and a plurality of chroma samples above the horizontal boundary.

EEE 2_39. The method of EEE 2_38, wherein the plurality of luma samples comprise 4 rows of luma samples above the horizontal boundary and 2 rows of chroma samples above the horizontal boundary.

EEE 2_40. The method of EEE 2_38, wherein the plurality of spatial neighboring samples are from the residual signal, and updating the plurality of luma samples and the plurality of chroma samples comprises: updating the plurality of luma samples and the plurality of chroma samples to zero values.

EEE 2_41. The method of EEE 2_38, wherein the plurality of spatial neighboring samples are from any one of the prediction signal, the pre-SAO filtering signal, or the pre-deblocking signal, and updating the plurality of luma samples and the plurality of chroma samples comprises: updating the plurality of luma samples and the plurality of chroma to collocated sample values of samples after SAO.

EEE 2_42. The method of EEE 2_38, wherein updating the plurality of luma samples and the plurality of chroma samples comprises: updating the plurality of luma samples and the plurality of chroma samples by respectively duplicating corresponding rows of luma samples and corresponding rows of chroma samples, wherein both corresponding rows of luma samples and corresponding rows of chroma samples are at the horizontal boundary in the coding tree unit.

EEE 2_43. The method of EEE 2_38, wherein updating the plurality of luma samples and the plurality of chroma samples comprises: updating the plurality of luma samples and the plurality of chroma samples by respectively mirroring corresponding rows of luma samples and corresponding rows of chroma samples, wherein both corresponding rows of luma samples and corresponding rows of chroma samples are at or below the horizontal boundary in the coding tree unit.

EEE 2_44. A method for video decoding, comprising: obtaining, by a decoder, a plurality of spatial neighboring samples associated with a current sample in a first channel, wherein the plurality of spatial neighboring samples are in a second channel and from any one of a prediction signal, a residual signal, a pre-sample adaptive offset (SAO) filtering signal comprising a plurality of samples prior to SAO filtering, or a pre-deblocking signal comprising a plurality of samples prior to deblocking; obtaining, by the decoder, a plurality of filtering input samples by updating the plurality of spatial neighboring samples to reduce line buffer space for storing the plurality of spatial neighboring samples; and obtaining, by the decoder, a filtered sample in the first channel, based on the plurality of filtering input samples and the current sample in the first channel.

EEE 2_45. The method of EEE 2_44, wherein the first channel is a chroma channel, and the second channel is a luma channel.

EEE 2_46. The method of EEE 2_44, wherein obtaining the plurality of filtering input samples by updating the plurality of spatial neighboring samples to reduce line buffer space for storing the plurality of spatial neighboring samples comprises: updating a plurality of samples in the second channel above a horizontal boundary of a coding tree unit.

EEE 2_47. The method of EEE 2_46, wherein the plurality of samples in the second channel comprise 4 rows of samples in the second channel above the horizontal boundary.

EEE 2_48. The method of EEE 2_46, wherein the plurality of spatial neighboring samples are from the residual signal, and updating the plurality of samples in the second channel comprises: updating the plurality of samples in the second channel to zero values.

EEE 2_49. The method of EEE 2_46, wherein the plurality of spatial neighboring samples are from any one of the prediction signal, the pre-SAO filtering signal, or the pre-deblocking signal, and updating the plurality of samples in the second channel comprises: updating the plurality of samples in the second channel to collocated sample values of samples after SAO.

EEE 2_50. The method of EEE 2_46, wherein updating the plurality of samples in the second channel comprises: updating the plurality of samples in the second channel by duplicating corresponding rows of samples in the second channel at the horizontal boundary in the coding tree unit.

EEE 2_51. The method of EEE 2_46, wherein updating the plurality of samples in the second channel comprises: updating the plurality of samples in the second channel by mirroring corresponding rows of samples in the second channel at or below the horizontal boundary in the coding tree unit.

EEE 2_52. A method for video encoding, comprising: obtaining, by an encoder, a plurality of spatial neighboring samples associated with a current sample, wherein the plurality of spatial neighboring samples are from any one of a prediction signal, a residual signal, a pre-sample adaptive offset (SAO) filtering signal comprising a plurality of samples prior to SAO filtering, or a pre-deblocking signal comprising a plurality of samples prior to deblocking; obtaining, by the encoder, a plurality of filtering input samples by updating the plurality of spatial neighboring samples to reduce line buffer space for storing the plurality of spatial neighboring samples; and obtaining, by the encoder, a filtered sample, based on the plurality of filtering input samples and the current sample.

EEE 2_53. The method of EEE 2_52, wherein obtaining the plurality of filtering input samples by updating the plurality of spatial neighboring samples to reduce line buffer space for storing the plurality of spatial neighboring samples comprises: updating a plurality of luma samples above a horizontal boundary of a coding tree unit, and a plurality of chroma samples above the horizontal boundary.

EEE 2_54. The method of EEE 2_53, wherein the plurality of luma samples comprise 4 rows of luma samples above the horizontal boundary and 2 rows of chroma samples above the horizontal boundary.

EEE 2_55. The method of EEE 2_53, wherein the plurality of spatial neighboring samples are from the residual signal, and updating the plurality of luma samples and the plurality of chroma samples comprises: updating the plurality of luma samples and the plurality of chroma samples to zero values.

EEE 2_56. The method of EEE 2_53, wherein the plurality of spatial neighboring samples are from any one of the prediction signal, the pre-SAO filtering signal, or the pre-deblocking signal, and updating the plurality of luma samples and the plurality of chroma samples comprises: updating the plurality of luma samples and the plurality of chroma to collocated sample values of samples after SAO.

EEE 2_57. The method of EEE 2_53, wherein updating the plurality of luma samples and the plurality of chroma samples comprises: updating the plurality of luma samples and the plurality of chroma samples by respectively duplicating corresponding rows of luma samples and corresponding rows of chroma samples, wherein both corresponding rows of luma samples and corresponding rows of chroma samples are at the horizontal boundary in the coding tree unit.

EEE 2_58. The method of EEE 2_53, wherein updating the plurality of luma samples and the plurality of chroma samples comprises: updating the plurality of luma samples and the plurality of chroma samples by respectively mirroring corresponding rows of luma samples and corresponding rows of chroma samples, wherein both corresponding rows of luma samples and corresponding rows of chroma samples are at or below the horizontal boundary in the coding tree unit.

EEE 2_59. A method for video encoding, comprising: obtaining, by an encoder, a plurality of spatial neighboring samples associated with a current sample in a first channel, wherein the plurality of spatial neighboring samples are in a second channel and from any one of a prediction signal, a residual signal, a pre-sample adaptive offset (SAO) filtering signal comprising a plurality of samples prior to SAO filtering, or a pre-deblocking signal comprising a plurality of samples prior to deblocking; obtaining, by the encoder, a plurality of filtering input samples by updating the plurality of spatial neighboring samples to reduce line buffer space for storing the plurality of spatial neighboring samples; and obtaining, by the encoder, a filtered sample in the first channel, based on the plurality of filtering input samples and the current sample in the first channel.

EEE 2_60. The method of EEE 2_59, wherein the first channel is a chroma channel, and the second channel is a luma channel.

EEE 2_61. The method of EEE 2_59, wherein obtaining the plurality of filtering input samples by updating the plurality of spatial neighboring samples to reduce line buffer space for storing the plurality of spatial neighboring samples comprises: updating a plurality of samples in the second channel above a horizontal boundary of a coding tree unit.

EEE 2_62. The method of EEE 2_61, wherein the plurality of samples in the second channel comprise 4 rows of samples in the second channel above the horizontal boundary.

EEE 2_63. The method of EEE 2_61, wherein the plurality of spatial neighboring samples are from the residual signal, and updating the plurality of samples in the second channel comprises: updating the plurality of samples in the second channel to zero values.

EEE 2_64. The method of EEE 2_61, wherein the plurality of spatial neighboring samples are from any one of the prediction signal, the pre-SAO filtering signal, or the pre-deblocking signal, and updating the plurality of samples in the second channel comprises: updating the plurality of samples in the second channel to collocated sample values of samples after SAO.

EEE 2_65. The method of EEE 2_61, wherein updating the plurality of samples in the second channel comprises: updating the plurality of samples in the second channel by duplicating corresponding rows of samples in the second channel at the horizontal boundary in the coding tree unit.

EEE 2_66. The method of EEE 2_61, wherein updating the plurality of samples in the second channel comprises: updating the plurality of samples in the second channel by mirroring corresponding rows of samples in the second channel at or below the horizontal boundary in the coding tree unit.

EEE 2_67. An apparatus for video decoding, comprising: one or more processors; and a memory coupled to the one or more processors and configured to store instructions executable by the one or more processors, wherein the one or more processors, upon execution of the instructions are configured to perform the method in any one of EEEs 2_37-2_43.

EEE 2_68. An apparatus for video encoding, comprising: one or more processors; and a memory coupled to the one or more processors and configured to store instructions executable by the one or more processors, wherein the one or more processors, upon execution of the instructions are configured to perform the method in any one of EEEs 2_52-2_58.

EEE 2_69. An apparatus for video decoding, comprising: one or more processors; and a memory coupled to the one or more processors and configured to store instructions executable by the one or more processors, wherein the one or more processors, upon execution of the instructions are configured to perform the method in any one of EEEs 2_44-2_51.

EEE 2_70. An apparatus for video encoding, comprising: one or more processors; and a memory coupled to the one or more processors and configured to store instructions executable by the one or more processors, wherein the one or more processors, upon execution of the instructions are configured to perform the method in any one of EEEs 2_59-2_66.

EEE 2_71. A non-transitory computer readable storage medium for storing computer-executable instructions that, when executed by one or more computer processors, cause the one or more computer processors to perform the method in any one of EEEs 2_37-2_43.

EEE 2_72. A non-transitory computer readable storage medium for storing computer-executable instructions that, when executed by one or more computer processors, cause the one or more computer processors to perform the method in any one of EEEs 2_44-2_51.

EEE 2_73. A non-transitory computer-readable storage medium for storing a bitstream to be decoded by the method in any of EEEs 2_37-2_43.

EEE 2_74. A non-transitory computer-readable storage medium for storing a bitstream generated by the method in any of EEEs 2_44-2_51.

EEE 2_75. A non-transitory computer readable storage medium for storing computer-executable instructions that, when executed by one or more computer processors, cause the one or more computer processors to perform the method in any one of EEEs 2_52-2_58.

EEE 2_76. A non-transitory computer readable storage medium for storing computer-executable instructions that, when executed by one or more computer processors, cause the one or more computer processors to perform the method in any one of EEEs 2_59-2_66.

EEE 2_77. A non-transitory computer-readable storage medium for storing a bitstream to be decoded by the method in any of EEEs 2_52-2_58.

EEE 2_78. A non-transitory computer-readable storage medium for storing a bitstream generated by the method in any of EEEs 2_59-2_66.

EEE 3_1. A method for video decoding, comprising: obtaining, by a decoder, one or more spatial neighboring samples associated with a current sample, wherein the one or more spatial neighboring samples are from a residual signal; and deriving, by the decoder, an adaptive loop filter (ALF) classifier for an online ALF process, the ALF classifier utilizing sample values from the residual signal.

EEE 3_2. The method for video decoding of EEE 3_1, wherein deriving the ALF classifier for the online ALF process comprises: computing, by the decoder, a sum of absolute values of sample values of a sub-block in the residual signal; mapping, by the decoder, the sum of absolute values of sample values of the sub-block to an absolute value of a first residual index; computing, by the decoder, a sum of sample values of the sub-block in the residual signal; mapping, by the decoder, the sum of sample values of the sub-block to a sign value of a second residual index; obtaining a class index of the sub-block based on the absolute value of a first residual index and the sign value of a second residual index; and deriving, by the decoder, the ALF classifier based on the class index of the sub-block.

EEE 3_3. The method for video decoding of EEE 3_1, wherein deriving the ALF classifier for the online ALF process comprises: computing, by the decoder, an index of a sub-block in the residual signal based on sample values in the residual signal, the index referring to an edge based classifier; and deriving, by the decoder, the ALF classifier based on the index of the sub-block.

EEE 3_4. The method for video decoding of EEE 3_1, wherein deriving the ALF classifier for the online ALF process comprises: computing, by the decoder, an index of a sub-block in the residual signal based on absolute values of sample values in the residual signal, the index referring to an edge based classifier; and deriving, by the decoder, the ALF classifier based on the index of the sub-block.

EEE 3_5. A method for video encoding, comprising: obtaining, by an encoder, one or more spatial neighboring samples associated with a current sample, wherein the one or more spatial neighboring samples are from a residual signal; and deriving, by the encoder, an adaptive loop filter (ALF) classifier for an online ALF process, the ALF classifier utilizing sample values from the residual signal.

EEE 3_6. The method for video encoding of EEE 3_5, wherein deriving the ALF classifier for the online ALF process comprises: computing, by the encoder, a sum of absolute values of sample values of a sub-block in the residual signal; mapping, by the encoder, the sum of absolute values of sample values of the sub-block to an absolute value of a first residual index; computing, by the encoder, a sum of sample values of the sub-block in the residual signal; mapping, by the encoder, the sum of sample values of the sub-block to a sign value of a second residual index; obtaining a class index of the sub-block based on the absolute value of a first residual index and the sign value of a second residual index; and deriving, by the encoder, the ALF classifier based on the class index of the sub-block.

EEE 3_7. The method for video encoding of EEE 3_5, wherein deriving the ALF classifier for the online ALF process comprises: computing, by the encoder, an index of a sub-block in the residual signal based on sample values in the residual signal, the index referring to an edge based classifier; and deriving, by the encoder, the ALF classifier based on the index of the sub-block.

EEE 3_8. The method for video encoding of EEE 3_5, wherein deriving the ALF classifier for the online ALF process comprises: computing, by the encoder, an index of a sub-block in the residual signal based on absolute values of sample values in the residual signal, the index referring to an edge based classifier; and deriving, by the encoder, the ALF classifier based on the index of the sub-block.

EEE 3_9. An apparatus for video decoding, comprising: one or more processors; and a memory coupled to the one or more processors and configured to store instructions executable by the one or more processors, wherein the one or more processors, upon execution of the instructions, are configured to perform the method in any one of EEEs 3_1-3_4.

EEE 3_10. A non-transitory computer-readable storage medium for storing computer-executable instructions that, when executed by one or more computer processors, cause the one or more computer processors to perform the method in any of EEEs 3_1-3_4.

EEE 3_11. An apparatus for video encoding, comprising: one or more processors; and a memory coupled to the one or more processors and configured to store instructions executable by the one or more processors, wherein the one or more processors, upon execution of the instructions, are configured to perform the method in any one of EEEs 3_5-3_8.

EEE 3_12. A non-transitory computer-readable storage medium for storing computer-executable instructions that, when executed by one or more computer processors, cause the one or more computer processors to perform the method in any of EEEs 3_5-3_8.

EEE 3_13. A non-transitory computer-readable storage medium for storing a bitstream to be decoded by the method in any of EEEs 3_1-3_4.

EEE 3_14. A non-transitory computer-readable storage medium for storing a bitstream generated by the method in any of EEEs 3_5-3_8.

What is claimed is:

1. A method for video decoding, comprising:
obtaining, by a decoder, one or more spatial neighboring samples associated with a current sample; and
obtaining, by the decoder, a filtered sample, based on the one or more spatial neighboring samples associated with the current sample.

2. The method for video decoding of claim 1, wherein the one or more spatial neighboring samples are from at least one of: (i) a prediction sample, (ii) a residual sample, or (iii) a reconstructed sample, and wherein the reconstructed sample is sampled prior to sample adaptive offset (SAO) filtering.

3. The method for video decoding of claim 2, further comprising:
obtaining, by the decoder, clipped results based on one or more spatial neighboring samples from the residual sample associated with the current sample; and
obtaining, by the decoder, the filtered sample using clipped results based on one or more spatial neighboring samples from the residual sample associated with the current sample and one or more filter coefficients, the one or more filter coefficients associated with different filter shapes.

4. The method for video decoding of claim 3, wherein the clipped results comprise clipped results of one or more surrounding samples, wherein the one or more surrounding samples are from one or more spatial neighboring samples from the residual samples.

5. The method for video decoding of claim 1, wherein obtaining, by the decoder, the filtered sample comprises:
deriving, by the decoder, an adaptive loop filter (ALF) classifier for an online ALF process, the ALF classifier utilizing one or more spatial neighboring samples before a deblocking filter.

6. The method for video decoding of claim 5, further comprising:
obtaining, by the decoder, a first feature by computing directionality of a sub-block of a luma component;
obtaining, by the decoder, a second feature by calculating a sum of differences values between a sample after a sample adaptive offset (SAO) process and a collocated sample before a deblocking filter of the sub-block;
mapping, by the decoder, the sum to a difference index; and
deriving, by the decoder, a combined classifier for the online ALF process based on the first feature and the second feature.

7. The method for video decoding of claim 5, further comprising:
obtaining, by the decoder, a first feature by computing an activity value of a sub-block of a luma component;
obtaining, by the decoder, a second feature by calculating a sum of difference values between a sample after a sample adaptive offset (SAO) process and a collocated sample before a deblocking filter of the sub-block;
mapping, by the decoder, the sum to a difference index; and
deriving, by the decoder, a combined classifier for the online ALF process based on the first feature and the second feature.

8. The method for video decoding of claim 5, further comprising:
obtaining, by the decoder, a first feature by computing an ALF edge based classifier index of a sub-block of a luma component;
obtaining, by the decoder, a second feature by calculating a sum of difference values between a sample after a sample adaptive offset (SAO) process and a collocated sample before a deblocking filter of the sub-block;
mapping, by the decoder, the sum to a difference index; and
deriving, by the decoder, a combined classifier for the online ALF process based on the first feature and the second feature.

9. The method for video decoding of claim 5, further comprising:
obtaining, by the decoder, a first feature based on a band index of a sub-block of a luma component;
obtaining, by the decoder, a second feature by calculating a sum of difference values between a sample after a sample adaptive offset (SAO) process and a collocated sample before a deblocking filter;
mapping, by the decoder, the sum to a difference index; and
deriving, by the decoder, a combined classifier for the online ALF process based on the first feature and the second feature.

10. The method for video decoding of claim 9, wherein the difference index is used as a class index.

11. The method for video decoding of claim 5, further comprising:
deriving, by the decoder, a new classifier for the online ALF process by computing an ALF edge based classifier index based on the samples before a deblocking filter; or
deriving, by the decoder, a new classifier for the online ALF process by computing a band index based on the samples before a deblocking filter.

12. The method for video decoding of claim 1, wherein the one or more spatial neighboring samples are from a prediction sample, and wherein obtaining, by the decoder, the filtered sample comprises:
deriving, by the decoder, an adaptive loop filter (ALF) classifier for an online ALF process, the ALF classifier utilizing sample values from the prediction sample.

13. The method for video decoding of claim 1, wherein the one or more spatial neighboring samples are from a residual sample, and wherein obtaining, by the decoder, the filtered sample comprises:
deriving, by the decoder, an adaptive loop filter (ALF) classifier for an online ALF process, the ALF classifier utilizing sample values from the residual sample.

14. The method for video decoding of claim 1, wherein obtaining, by the decoder, the filtered sample comprises:
deriving, by the decoder, an adaptive loop filter (ALF) classifier for an online ALF process, the ALF classifier utilizing one or more spatial neighboring samples before a sample adaptive offset (SAO) process.

15. The method for video decoding of claim 1, wherein the one or more spatial neighboring samples are from a chroma sample, and wherein obtaining, by the decoder, the filtered sample comprises:
deriving, by the decoder, an adaptive loop filter (ALF) classifier for an online ALF process, the ALF classifier utilizing sample values from the chroma sample.

16. The method for video decoding of claim 1, further comprising:
obtaining, by the decoder, at least one secondary signal by applying at least one fixed filter to a primary signal, wherein the at least one fixed filter is trained offline,
wherein the one or more spatial neighboring samples are from at least one of the primary signal or the at least one secondary signal, and wherein the obtaining the filtered sample comprises:
obtaining, by the decoder, the filtered sample by applying at least one online filter to the one or more spatial neighboring samples associated with the current sample.

17. The method for video decoding of claim 1, wherein obtaining, by the decoder, the one or more spatial neighboring samples with the current sample comprises:
obtaining, by the decoder, a plurality of spatial neighboring samples associated with the current sample, wherein the plurality of spatial neighboring samples are from any one of a prediction signal, a residual signal, a pre-sample adaptive offset (SAO) filtering signal comprising a plurality of samples prior to SAO filtering, or a pre-deblocking signal comprising a plurality of samples prior to deblocking;
and wherein obtaining, by the decoder, the filtered sample comprises:
obtaining, by the decoder, a plurality of filtering input samples by updating the plurality of spatial neighboring samples to reduce line buffer space for storing the plurality of spatial neighboring samples; and
obtaining, by the decoder, the filtered sample, based on the plurality of filtering input samples and the current sample.

18. The method for video decoding of claim 1, wherein obtaining, by the decoder, the one or more spatial neighboring samples with the current sample comprises:
obtaining, by the decoder, a plurality of spatial neighboring samples associated with the current sample in a first channel, wherein the plurality of spatial neighboring samples are in a second channel and from any one of a prediction signal, a residual signal, a pre-sample adaptive offset (SAO) filtering signal comprising a plurality of samples prior to SAO filtering, or a pre-deblocking signal comprising a plurality of samples prior to deblocking;
and wherein obtaining, by the decoder, the filtered sample comprises:
obtaining, by the decoder, a plurality of filtering input samples by updating the plurality of spatial neighboring samples to reduce line buffer space for storing the plurality of spatial neighboring samples; and
obtaining, by the decoder, the filtered sample in the first channel, based on the plurality of filtering input samples and the current sample in the first channel.

19. An apparatus for video decoding, comprising:
one or more processors; and
a memory coupled to the one or more processors and configured to store instructions executable by the one or more processors,
wherein the one or more processors, upon execution of the instructions, are configured to, individually or collectively, perform operations comprising:
obtaining, by a decoder, one or more spatial neighboring samples associated with a current sample; and
obtaining, by the decoder, a filtered sample, based on the one or more spatial neighboring samples associated with the current sample.

20. A non-transitory computer-readable storage medium for video decoding storing a bitstream to be decoded by operations comprising:
obtaining, by a decoder, one or more spatial neighboring samples associated with a current sample; and
obtaining, by the decoder, a filtered sample, based on the one or more spatial neighboring samples associated with the current sample.
